(19) United States
(12) Patent Application Publication
(10) Pub. No.: US 2025/0384200 A1
(43) Pub. Date: Dec. 18, 2025

(54) SMART INTERFACE WITH FACILITATED INPUT AND MISTAKE RECOVERY

(71) Applicant: I.Q. JOE, LLC, Torrance, CA (US)

(72) Inventor: Jeffrey James Hatch, Wilmington, CA (US)

(21) Appl. No.: 19/013,275

(22) Filed: Jan. 8, 2025

Related U.S. Application Data
(63) Continuation of application No. 18/390,617, filed on Dec. 20, 2023, now Pat. No. 12,204,848.
Application No. 18/390,617 is a continuation of application No. 17/811,813, filed on Jul. 11, 2022, now Pat. No. 11,861,297.
Application No. 17/811,813 is a continuation of application No. 17/302,672, filed on May 10, 2021, now Pat. No. 11,386,260.
Application No. 17/302,672 is a continuation of application No. 15/965,619, filed on Apr. 27, 2018, now Pat. No. 11,003,839.
(60) Provisional application No. 62/492,005, filed on Apr. 28, 2017.

(51) Int. Cl. G06F 40/166; G06F 3/04886; G10L 15/22

(52) U.S. Cl. CPC G06F 40/166; G06F 3/04886; G10L 15/22; G10L 2015/221

(57) ABSTRACT

Systems, methods, and devices including smart interfaces with facilitated input and mistake recovery are described. For example, a smart interface system can identify one or more portions of user input as alterable decisions, and, for each of the one or more alterable decisions, store, in a memory, information about one or more alternative options for the alterable decision. The system can also identify one of the alterable decisions as the currently alterable decision, and upon receiving an input indicative of an actuation of the alteration key, alter the currently alterable decision to another of the one or more alternative options based on the stored information.

### INCORPORATION BY REFERENCE TO ANY PRIORITY APPLICATIONS

This application is a continuation of U.S. application Ser. No. 18/390,617, filed Dec. 20, 2024, which is a continuation of U.S. application Ser. No. 17/811,813, filed Jul. 11, 2022, which is a continuation of U.S. application Ser. No. 17/302,672, filed May 10, 2021, and issued as U.S. Pat. No. 11,386,260, on Jul. 12, 2022, which is a continuation of U.S. application Ser. No. 15/965,619, filed Apr. 27, 2018, issued as U.S. Pat. No. 11,003,839, on May 11, 2021, which claims priority to U.S. Provisional Application No. 62/492,005, filed Apr. 28, 2017, each of which is incorporated herein by reference. Any and all applications for which a foreign or domestic priority claim is identified in the Application Data Sheet as filed with the present application are hereby incorporated by reference under 37 CFR 1.57. U.S. application Ser. No. 11/925,560, filed Oct. 26, 2007, now U.S. Pat. No. 8,788,548, and U.S. application Ser. No. 12/363,590, filed Jan. 30, 2009, now U.S. Pat. No. 8,504,600, are also incorporated herein by reference.

### BACKGROUND

### Field

This application relates to interfaces for electronic devices such as desktop computers, laptops, tablet computers, smartphones, or voice computers, among others. In particular, this application relates to smart interfaces with facilitated input and mistake recovery.

### Description

Electronic devices commonly include interfaces that allow users to interact with the devices. Such interfaces often allow users to enter information into the devices and allow the devices to display information to the users. Commonly, interfaces include one or more input devices, for example, keyboards, touchscreens, etc., and a display device, such as a screen. The devices may also include a software component for controlling the interfaces.

### SUMMARY

This application relates to systems, methods, and devices including smart interfaces with facilitated input and mistake recovery. For example, in an embodiment, a system having a smart interface can include an input device configured to receive user input from a user. The input device can include an alteration key, which can be implemented as a physical key or on a touchscreen. The system can also include a display for displaying information to the user. The system also includes at least one non-transitory computer readable medium having stored thereon executable instructions, and at least one processor in communication with the at least one non-transitory computer readable medium and configured to execute the instructions. When executed by the processor, the instructions cause the system to provide one or more of the interface functions described throughout this application. For example, the instructions can cause the system to: identify one or more portions of user input as one or more alterable decisions; for each of the one or more alterable decisions, store, in a memory, information about one or more alternative options for the alterable decision; identify one of the one or more alterable decisions as the currently alterable decision; upon receiving an input indicative of an actuation of the alteration key, alter the currently alterable decision to another of the one or more alternative options based on the stored information; and display, on the display, the altered currently alterable decision to the user. Other implementations and interface functionality are described in greater detail below.

For purposes of summarizing the invention and the advantages achieved over the prior art, certain objects and advantages are described herein. Of course, it is to be understood that not necessarily all such objects or advantages need to be achieved in accordance with any particular embodiment. Thus, for example, those skilled in the art will recognize that the invention may be embodied or carried out in a manner that can achieve or optimize one advantage or a group of advantages without necessarily achieving other objects or advantages.

### BRIEF DESCRIPTION OF THE DRAWINGS

The features of the present disclosure will become more fully apparent from the following description, taken in conjunction with the accompanying drawings. Understanding that these drawings depict only some embodiments in accordance with the disclosure and are, therefore, not to be considered limiting of its scope, the disclosure will be described with additional specificity and detail through use of the accompanying drawings.

FIG. 1A is a block diagram of an embodiment of a device including an interface as described herein.

FIG. 1B illustrates an embodiment of a keyboard including an alteration key.

FIG. 1C illustrates an embodiment of a calculator including an alteration key.

FIG. 2A is a flowchart illustrating repeated consecutive actuations of an alteration key, according to one embodiment.

FIGS. 2B and 2C are flowcharts illustrating an embodiment of a method for a smart interface.

FIG. 3 is a flowchart that illustrates in detail how the currently alterable decision is determined, according to one embodiment.

FIGS. 4A and 4B illustrate an embodiment of a method for determining what to highlight after each user action.

FIG. 5 is a flowchart that illustrates, according to one embodiment, how an interface will react when an Undo key is pressed, with particular attention to how the interface will attempt to make undo changes visible for the user.

FIG. 6A is a flowchart that illustrates the behavior of an embodiment of an interface that has a touch alteration feature.

FIG. 6B illustrates an example of touch cancellation.

FIG. 7A illustrates an example of an alteration control panel.

FIG. 7B illustrates an example of an undo control panel.

FIG. 8A is a flowchart that illustrates an example method for undo functionality.

FIG. 8B is a flowchart that illustrates an example decision-making process for determining whether an interface intervention is significant.

FIG. 9A illustrates a side-view of an interface user who is looking at a display device.

FIG. 9B is a front-facing view of the display device, including the target region and the focal zone centered on the focal location, according to one embodiment.

FIG. 10 is a flowchart that illustrates an example method for determining whether an interface remains in revision mode, beginning with the assumption that the interface is in revision mode

FIG. 11A is a flowchart that illustrates an example decision-making process for determining whether to display a remote alteration control.

FIG. 11B illustrates an example remote alteration control.

FIG. 12A is a flowchart that illustrates a method for deciding whether the interface enters a final review mode in response to a completion command, according to one embodiment.

FIG. 12B is a flowchart that illustrates an example method for interface operation while in a final review mode.

FIG. 13 is a flowchart that illustrates an example method for interface operation while in an option definition mode.

FIG. 14A is a flowchart that illustrates an example method for determining whether or not an action was a destructive action, and what characters it destroyed.

FIG. 14B is a flowchart that illustrates a simplified version of an automatic decision variation feature, according to one embodiment.

FIG. 14C is a flowchart that illustrates an example method for varying a decision that is identical to a monitored alterable decision.

FIGS. 15A and 15B are flowcharts illustrating example methods for a manual alteration detection feature.

FIG. 16 is a flowchart that illustrates a simple case of an adaptive decision that may affect interface settings, according to one embodiment.

FIG. 17 is a flowchart that illustrates an example process by which an interface decides whether to generate an efficiency tip.

FIG. 18 is a flowchart that illustrates a distinction between denotative and contextual data, and also shows how contextual data is associated with alterable decisions, according to an embodiment.

FIGS. 19A and 19B are flowcharts depicting example scenarios where alterable command recognition decisions may facilitate mistake correction.

FIG. 19C is a flowchart depicting an example scenario for applying corrective alteration functionality to a mistake that may occur when speech recognition software is in sleep mode.

FIGS. 20A and 20B are flowcharts that illustrate an example method that occurs when an enhanced typo-correcting candidate word algorithm is invoked, according to one embodiment.

FIG. 21A illustrates features of an alterable capitalization decision.

FIG. 21B is a flowchart that illustrates what happens when a user backspaces a capital letter, according to one embodiment.

FIG. 22 illustrates an example of a word entry mode menu.

FIG. 23A illustrates a diagram identifying and deconstructing the pertinent format elements distinguishing visually ambiguous from visually distinct blank blocks, according to one embodiment.

FIGS. 23B and 23C illustrate features related to positional formatting.

FIG. 23D is a flowchart demonstrating interface use of contextual data to inform pasted text format determinations as alterable format decisions, according to an embodiment.

FIG. 24 illustrates alterable format expression decisions in action, according to an embodiment.

FIG. 25A illustrates a directed input cursor jumping feature in action, according to an embodiment.

FIG. 25B illustrates advantages associated with some embodiments of a directed mouse cursor jumping feature.

FIG. 26A is a flowchart that illustrates the process of evaluating a structure modification, according to an embodiment.

FIGS. 26B and 26C are flowcharts that together illustrate evaluating a structure modification's validity, according to an embodiment.

FIG. 27 is a flowchart that illustrates the results that occur when the user presses the fraction initialization key, in an embodiment that has a relatively simple version of the fraction initialization key, according to an embodiment.

FIG. 28A is a flowchart that illustrates various features that may be invoked when a user double-clicks the plus key, according to an embodiment.

FIG. 28B is a flowchart that illustrates an example process that occurs in an ambiguous case where a previously typed plus sign is both the last character within a mathematical structure and the first character after a mathematical structure.

FIG. 29A is a flowchart that illustrates an example method for making smart adaptive angle measure mode decisions.

FIG. 29B illustrates an example classification system.

FIG. 29C is a flowchart that illustrates an algorithm that determines, for a mathematical expression, an angle factor, which may be either a primary angle factor or a secondary angle factor, according to an embodiment.

### DETAILED DESCRIPTION

This detailed description discusses features and advantages of systems and methods related to smart interfaces with facilitated input and mistake recovery in relation to certain described embodiments, some of which are illustrated in the figures. Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

### Chapter 1: Introduction

### Example Device or System

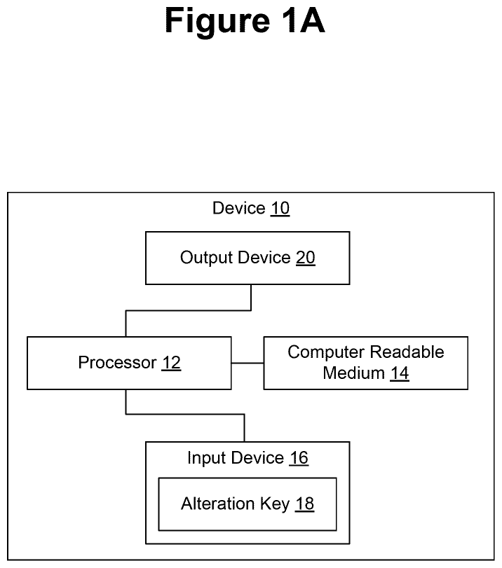

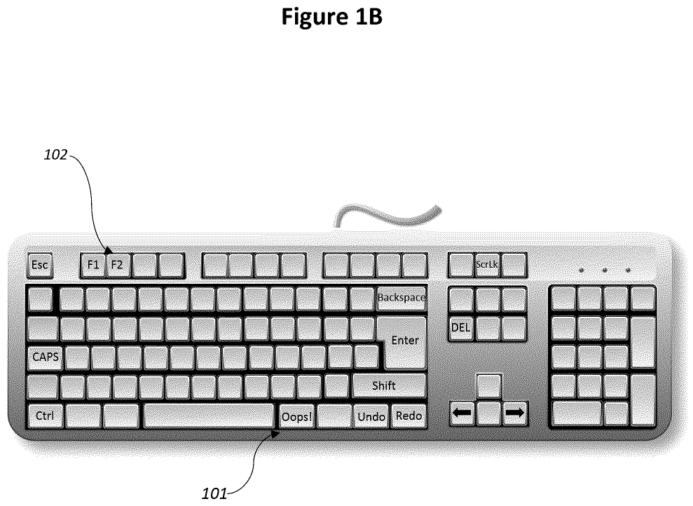

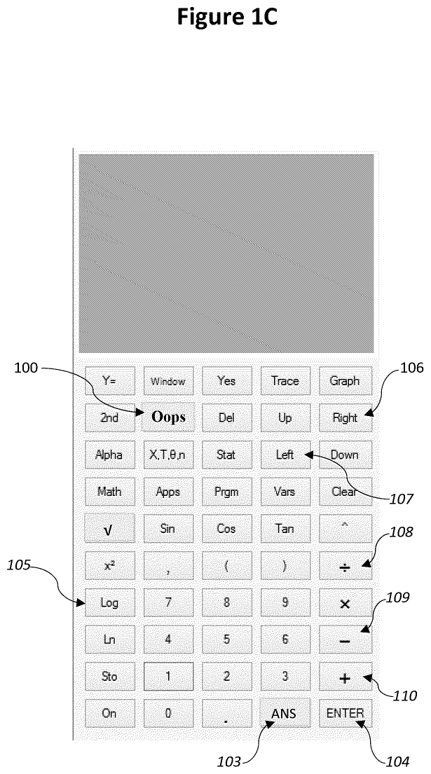

FIG. 1A is a block diagram of an embodiment of a device 10 including an interface as described herein. The device 10 can be any type of electronic or computing device including, for example, a desktop computer, a laptop, a tablet, a smartphone, a voice computer, or a calculator, among others. The interface allows a user to interact with the device 10. For example, the interface allows a user to input information into the device 10 and view or receive information from the device 10.

In the illustrated embodiment, the device 10 includes a processor 12 and a computer readable medium 14. The computer readable medium 14 can include instructions that, when executed by the processor 12, cause the device 10 to implement one or more of the many interface functions described herein. The computer readable medium 14 can also be used to store information, as necessary, for use by the interface.

As shown, the device 10 includes an input device 16. The input device 16 allows the user to input information into and interact with the device 10. Many types of input devices 16 are possible, including keyboards, mice, touchscreens, microphones (for voice commands), etc. The input device 16 can include an alteration key 18. The alteration key 18 can be used, for example, to alter an alterable decision made by the interface as described below, as well as for additional functionality as described throughout this application. In some embodiments, the alteration key 18 is a dedicated key or button. In some embodiments, the alteration key 18 is a soft-key implanted on a touch screen. In some embodiments, the alteration key 18 can be implemented by having a user click or press on an alterable decision to alter it. In some embodiments, the alteration key 18 can be a voice command. Additional examples of the alteration key 18 are found throughout this application.

The device 10 also includes an output device 20. The output device 20 can be configured to display or otherwise communicate information to a user. For example, the output device 20 can be a monitor or screen. In some embodiments, the output device 20 can comprise a speaker for audibly communicating information to the user.

As noted previously, the interface of the device 10 can be configured to implement one or more of the various interface functions described herein.

### Chapter 2: Alterable Decisions and the Alteration Key

### About Part I

Part I of the present specification includes Chapters 2 to 15. Part I explains various features that may facilitate mistake recovery, including features that pertain to “alterable decisions” as described below, and also including features that pertain to undo functionality and autocorrection functionality.

Farther below, Part II explains features that may tend to prevent the interface from repeating mistakes and features that may tend to prevent users from wasting time. Part III explains for various situations interface improvements that may make it easier for a user to achieve desired results quickly; in particular, Part III explains for various situations various specific circumstances in which the interface may make alterable decisions.

### Alterable Decisions

Various embodiments include various features that pertain to “alterable decisions.” As used in the present specification, an “alterable decision” or “alterable interface decision” can be an interface decision such that the interface either saves sufficient information to subsequently identify the portion of input that the decision pertained to, or sufficient information to later determine what the user's input would then be if the outcome of the earlier decision had been different, or both. For example, in an embodiment, when the interface decides to autocorrect a word that a user typed, the decision to autocorrect the word will be an alterable decision, which means that the interface will either save sufficient information to subsequently identify the word that was autocorrected as the portion of input that this alterable decision pertained to, or sufficient information to later determine what the user's input would be if the word's uncorrected spelling were retroactively restored, or both.

However, the term “alterable decision” may be a misnomer in some embodiments because not all embodiments will necessarily facilitate altering such decisions: some embodiments may, and others may not. For example, an embodiment is described in Chapter 5 in which the interface highlights the outcomes of “alterable decisions” in order to call attention to possible mistakes, and such an embodiment may yield significant advantages over prior art even if it does not also facilitate the correction of such mistakes. Also, the term “alterable decision” may be a misnomer for certain types of alterable decisions because when a user performs an action that causes the interface to “make an alterable decision,” the interface will not necessarily have any real choice as to how it initially responds to the user's action. For example, an embodiment is described in Chapter 33 such that if a user pauses for a long time while the interface is in Caps Lock mode, the interface may “alterably decide to remain in Caps Lock mode.” In such an embodiment, even though the interface makes a so-called “alterable decision” in such circumstances, it has no real choice: arguably, a long pause is not a sufficient reason for the interface to automatically exit Caps Lock mode. Thus, the term “alterable decision” should be understood in light of the entirety of the present specification, and should not be strictly construed.

Above, and in various other places, the present specification mentions the “portion of input” that an interface decision pertains to. However, in some embodiments, the interface functionality that is specified herein may also interact with software output or interact with something else that is not input. Throughout the present specification, where appropriate, the word “input” should be understood to also refer to software output or to anything else that interface functionality may display and modify. For example, in an embodiment where the interface makes a decision whether to display the output of a calculation as a fraction or as a decimal, the so-called “portion of input” that this interface decision pertains to is actually the output of the calculation.

### Alterable Decisions in Perspective

In the present specification, alterable decisions are often associated with potential user mistakes: in some embodiments, if an interface decision has an outcome that a user does not expect and does not desire, then in many cases the user will be able to correct the mistake by altering the decision. However, even though alteration functionality is often associated with mistake recovery herein, it is to be understood that alteration functionality need not be exclusively used for mistake recovery. For example, in some cases, a user who is familiar with alteration technology may deliberately make a “mistake” and then alter an interface decision because this is an efficient way to achieve a desired outcome.

The most common mistakes that a typical user of a computing device will encounter are word entry mistakes, which are typographical errors or spelling mistakes that are the user's fault. In some interfaces autocorrection functionality will often, but not always, correct word entry mistakes. Arguably, the most frustrating mistakes that a typical user of a computing device will commonly encounter are “undesired interface interventions,” which are the mistakes that occur when the computing device performs an autocorrection or automatic formatting action that the user does not desire.

An interface decision regarding whether or not to autocorrect a word is a familiar example of an interface decision that is reasonably likely to have an outcome that a user regrets, and for that reason, autocorrection decisions are frequently used herein as convenient examples of alterable decisions. However, autocorrection decisions are not the only possible type of alterable decision: in Part III the present specification explains many other types of interface decisions that are alterable decisions in some embodiments.

Where prior art interfaces include specialized mistake recovery features (other than generic undo functionality), those features typically only facilitate recovery from word entry mistakes or undesired interface interventions. For that reason, when the present specification compares new mistake recovery features to prior art mistake recovery features, the present specification will generally emphasize how new mistake recovery features may do better at facilitating recovery from word entry mistakes or undesired interface interventions. Despite this emphasis on word entry mistakes and undesired interface interventions, it is to be understood that the new mistake recovery features described herein may also do better than prior art at facilitating recovery from various other types of mistakes, since prior art interfaces generally lack functionality that especially facilitates recovery from the other types of mistakes that are described herein.

An embodiment that has even just one feature that interacts with alterable decisions and has just one type of alterable decision may have significant advantages. For example, in a very early prototype, the only feature that interacted with alterable decisions was a simple alteration key, and the only alterable decisions that the alteration key could interact with were alterable structure exiting decisions; even in that relatively simple embodiment, the alteration key was useful.

However, the more interface decisions are alterable decisions, the more useful it will be to add functionality pertaining to such decisions, and conversely, the more functionality an embodiment has pertaining to alterable interface decisions, the more useful it will be to make interface decisions be alterable decisions. Alterable decisions may thus be at the core of a synergistic virtuous cycle.

Much of the present specification is devoted to explaining features that interact with alterable decisions in certain circumstances and features that cause the interface to make alterable decisions in certain circumstances. Other features are explained herein that do not directly pertain to alterable decisions, but may be more advantageous in an embodiment that has alterable decision functionality. For example, if a particular feature usually facilitates faster input, but careless users occasionally tend to make a certain type of mistake when using that feature, then such a feature may be advantageous on its own, but may be more advantageous in an embodiment that has alterable decision functionality that is specifically configured to facilitate correcting that type of mistake.

### An Alteration Key Example

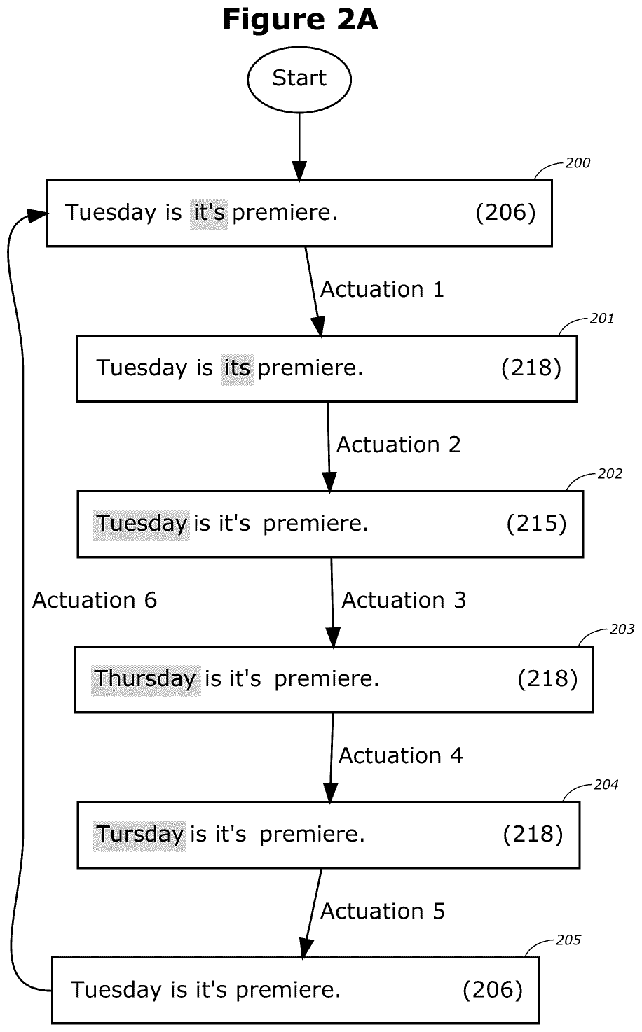

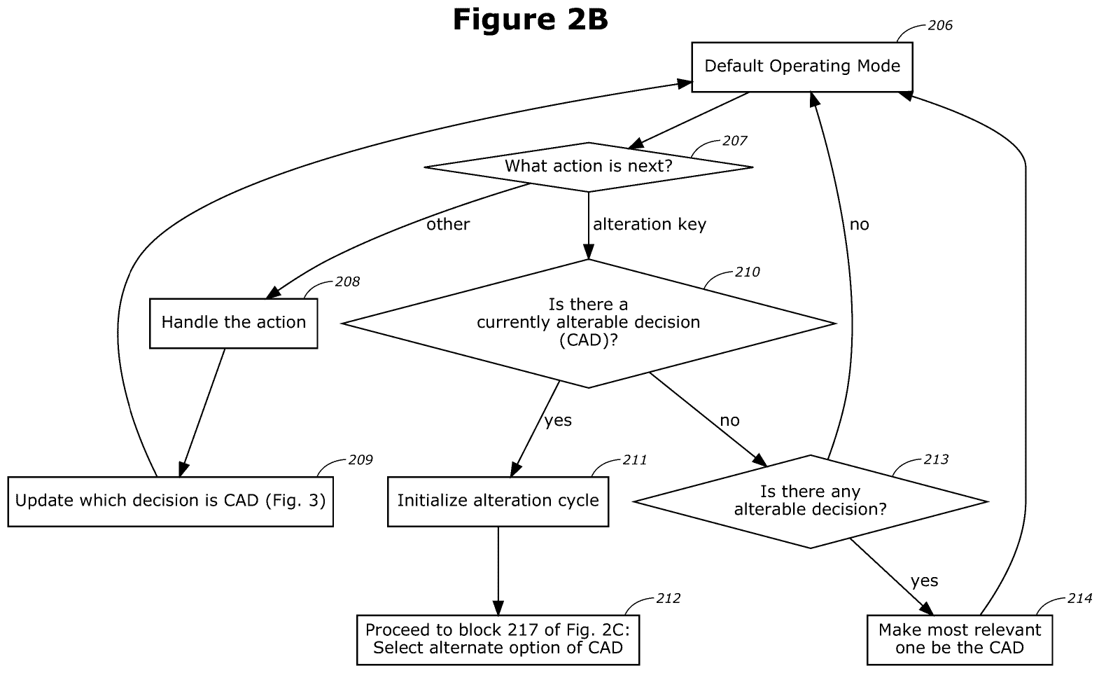

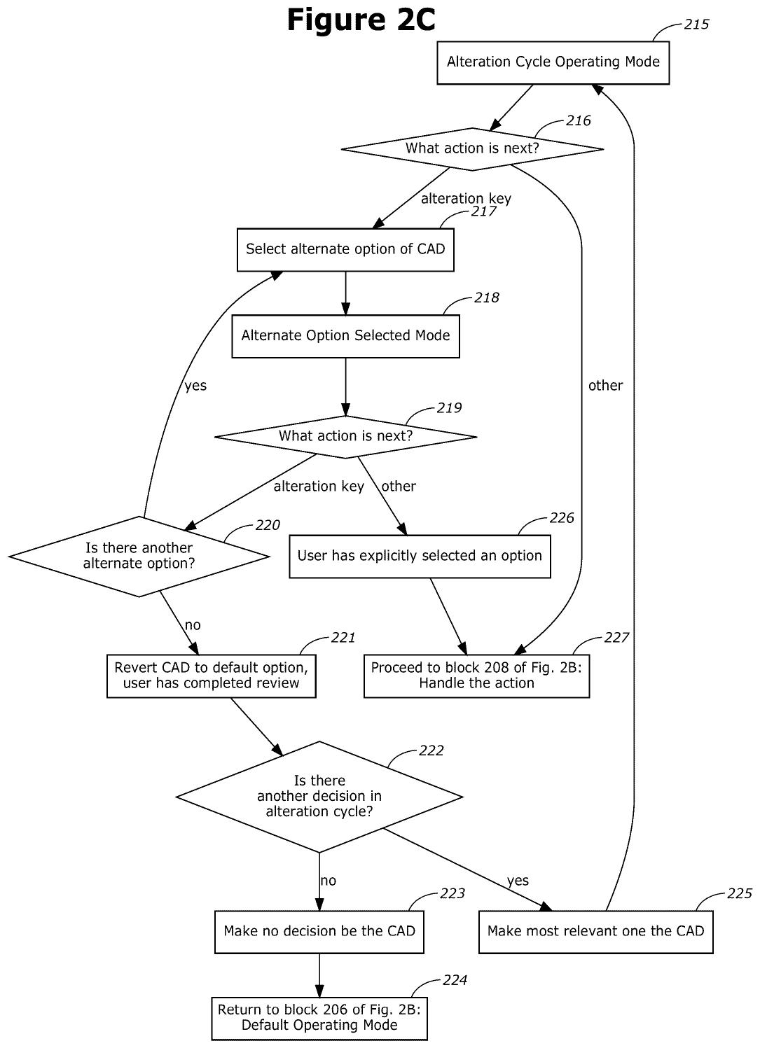

FIG. 2A illustrates what may happen as a result of repeated consecutive actuations of the alteration key in an embodiment that has an alteration key as described below and in which additional consecutive actuations of the alteration key may have additional effects as described below. Each block of the figure illustrates what the user's input will be after a certain number of consecutive actuations of the alteration key. In each block, the text that the currently alterable decision pertains to is highlighted (if there is a currently alterable decision). In each block, the number in parentheses corresponds to an interface state from FIG. 2B, and thus indicates what state the interface is in at that point. The effect of each actuation can be seen by comparing the block above that actuation's arrow to the block below it.

At the beginning of the example in FIG. 2A, the user has typed “Tursday is its premiere” but the interface has made an alterable decision to autocorrect “Tursday” to read “Tuesday” and an alterable decision to autocorrect “its” to read “it's.” The text thus reads “Tuesday is it's premiere,” as shown in Block 200. The alterable decision pertaining to the word “it's” is the currently alterable decision. The interface is in default operating mode as shown in FIG. 2B, Block 206.

The user then actuates the alteration key a first time. The interface alters the currently alterable decision, yielding “Tuesday is its premiere,” as shown in Block 201. The alterable decision pertaining to the word “its” is still the currently alterable decision. The interface is now in alternate option selected mode as shown in FIG. 2C, Block 218.

The user then actuates the alteration key a second consecutive time. The interface alters the currently alterable decision again and thus reverts it to its default option, yielding “Tuesday is it's premiere,” as shown in Block 202. The interface then causes the alterable decision pertaining to the word “Tuesday” to become the currently alterable decision, as indicated by the highlighting of that word in Block 202. The interface is now in alteration cycle operating mode as shown in FIG. 2C, Block 215.

The user then actuates the alteration key a third consecutive time and a fourth consecutive time. This yields “Thursday is it's premiere” as shown in Block 203 and then “Tursday is it's premiere” as shown in Block 204. After these actuations, the alterable decision pertaining to the word “Thursday” or “Tursday” is the currently alterable decision, and the interface is in alternate option selected mode as shown in FIG. 2C, Block 218.

The user then actuates the alteration key a fifth consecutive time. The interface reverts the currently alterable decision to its default option, yielding “Tuesday is it's premiere” as shown in Block 205. There is now no currently alterable decision, as indicated by the lack of highlighting in Block 205. The interface has returned to default operating mode as shown in FIG. 2B, Block 206.

The user then actuates the alteration key a sixth consecutive time. Because there is no currently alterable decision, this actuation of the alteration key does not affect the user's input; instead, it causes the alterable decision pertaining to the word “it's” to become the currently alterable decision again. The arrow labeled “Actuation 6” that points from Block 205 to Block 200 indicates that this sixth consecutive actuation of the alteration key causes the interface to return to the same state it was in prior to the first of these consecutive actuations of the alteration key. Subsequently, a seventh consecutive actuation of the alteration key would again yield the result shown in Block 201, and an eighth consecutive actuation would again yield the result shown in Block 202, and so on.

### An Alteration Key Algorithm

FIGS. 2B and 2C are flowcharts that illustrate one possible algorithm for an embodiment that has an alteration key as described below, and in which additional consecutive actuations of the alteration key may have additional effects as described below. This algorithm yields the interface behavior that is illustrated in FIG. 2A.

In an embodiment that behaves as indicated by these flowcharts, whenever the user's most recent action was not an actuation of the alteration key (and in certain other circumstances), the interface is in a “default operating mode” as shown in FIG. 2B, Block 206. While the interface is in default operating mode, each time the user performs an editing action (Block 207) other than an actuation of the alteration key, the interface will handle that action (Block 208) and remain in default operating mode. Whenever the interface handles an editing action other than an actuation of the alteration key, this may cause the interface to update which decision is the currently alterable decision or “CAD” (Block 209): in particular, if the interface makes an alterable decision in response to an editing action, then in certain circumstances this new alterable decision will become the currently alterable decision.

While the interface is in default operating mode (Block 206), if a user actuates the alteration key (Block 210) when there is no currently alterable decision (Block 213), this actuation of the alteration key will cause the most relevant alterable decision to become the currently alterable decision (Block 214) if there is any alterable decision, or will have no effect if there are no alterable decisions; in either case, the interface will remain in default operating mode and return to Block 206.

While the interface is in default operating mode (Block 206), if the user actuates the alteration key when there is a currently alterable decision (Block 210), then the interface will add the other alterable decisions to the alteration cycle (Block 211). The interface will then select an alternate option of the currently alterable decision (Block 212, leading to FIG. 2C, Block 217) and enter an “alternate option selected mode” (Block 218). While the interface is in alternate option selected mode, each time the user actuates the alteration key (Block 220), if the currently alterable decision is a multi-alternative decision and there is an alternate option that has not yet been selected, then the interface will select such an option (Block 217) and remain in alternate option selected mode (Block 218).

While the interface is in alternate option selected mode (Block 218), if the user performs an action other than an actuation of the alteration key, then the user has explicitly selected an alternate option of the currently alterable decision (Block 226), which has effects that are described in Chapter 3. The interface will handle the action (Block 227) and revert to default operating mode (Block 206).

While the interface is in alternate option selected mode (Block 218), if the user actuates the alteration key (Block 219) when there is no alternate option (Block 220) for the currently alterable decision that has not yet been selected, the interface will revert the currently alterable decision to its default option (Block 221). The user has completed review of the currently alterable decision, which has effects that are described in Chapter 3. The interface will then move on to the next decision in the alteration cycle (Block 222), as described in the following paragraphs.

When the interface moves on to the next decision in the alteration cycle, if any alterable decisions are remaining in the alteration cycle, then the most relevant such decision will be removed from the alteration cycle and will become the new currently alterable decision (Block 225). The interface will then enter an “alteration cycle operating mode” (Block 215). The alteration cycle operating mode (Block 215) and the default operating mode (Block 206) are quite similar, but when the interface is in the alteration cycle operating mode (Block 215) it already has an alteration cycle in mind, so if the user's next action is an actuation of the alteration key (Block 216) then the interface will not need to initialize the alteration cycle before proceeding to alter the currently alterable decision (Block 217) and enter alternate option selected mode (Block 218). When the interface is in the alteration cycle operating mode (Block 215), if the user's next action is not an actuation of the alteration key, the interface will handle the action (Block 227, leading to Block 208), update which decision is the CAD (Block 209), and revert to default operating mode (Block 206).

When the interface moves on to the next decision in the alteration cycle, if no alterable decisions are remaining in the alteration cycle, there will then be no currently alterable decision (Block 223) and the interface will revert to default operating mode (Block 224, leading to Block 206).

Other algorithms that implement the same interface behavior or similar behavior will be evident to those of ordinary skill in the art.

### Altering Decisions

In the present specification, the “default option” of an alterable interface decision can be the actual initial outcome of that decision, and an “alternate option” can be some other outcome that the user might prefer for that decision, except as otherwise specified. For example, in an embodiment, if the interface has automatically corrected the spelling of a word that a user typed, and the interface's decision to correct this word's spelling is an alterable interface decision, then the corrected spelling is the default option and the user's original uncorrected spelling is an alternate option.

In an embodiment, when the interface makes an alterable decision, in addition to saving enough information for the interface to subsequently identify the portion of input that the decision pertained to, the interface will also save enough information about the alternate options of that decision that the interface can later determine what the user's input would then be if an alternate option were chosen instead of the default option. For example, in an embodiment, when the interface makes an alterable decision to automatically correct a word that a user typed, the interface will save enough information to later be able to determine what the user's input would then be if the user's original uncorrected spelling were restored retroactively.

Below, various embodiments are specified in which the interface will “alter an alterable interface decision” in certain circumstances. Except as otherwise specified, when the interface alters an alterable interface decision, it replaces that decision's default option with an alternate option, without prompting the user for any additional confirmation or clarification; however, various other ways that the interface may alter an alterable interface decision in certain circumstances are specified below. In an embodiment, when the interface alters an alterable interface decision, it will retain enough information to be able to subsequently revert that decision to its default option.

In an embodiment, after a user has caused the interface to alter a decision so that an alternate option of that decision is selected, if the user then performs some action that does not cause the interface to alter that decision, this constitutes “explicitly selecting an option” of that alterable interface decision. Unless otherwise specified, when the user's most recent action caused the interface to alter a decision, the user has not yet explicitly selected an option of that alterable interface decision—not until the user performs some other action.

In an embodiment, once a user has explicitly selected an alternate option of an alterable interface decision, if the decision is still alterable, then for purposes of the alteration functionality described herein, the interface will subsequently treat the option the user explicitly selected as the default option of that particular alterable decision and will treat the former default option of that decision as an alternate option. For example, in an embodiment, after the interface makes an alterable decision to automatically replace the word “goof” with the word “good” but then the user explicitly selects the alternate option “goof,” if the decision is still alterable, then “goof”′ will subsequently be treated as the default option of that particular decision for purposes of alteration functionality and “good” will be treated as an alternate option. (This does not mean that explicitly selecting the alternate option “goof” necessarily has any effect on future interface decisions regarding whether or not to automatically replace the word “goof”: it only means that “goof” will subsequently be treated as the default option of the alterable decision the interface already made.)

In the present specification, any mention of “alteration features” or “alteration functionality” may refer to features that are disclosed herein that are specifically designed to interact with alterable interface decisions. Any mention of “altering” an alterable interface decision generally refers only to altering such a decision by means of such alteration features, and generally does not refer to manual editing of the portion of the user's input that an alterable interface decision pertains to, unless otherwise specified. For example, if the interface has made an alterable decision to automatically insert an apostrophe in the word “its,” then if the user manually deletes the apostrophe, the user will not be considered to have “altered” an alterable interface decision.

### The Alteration Key

In an embodiment, in certain circumstances an alterable interface decision is the “currently alterable decision” for purposes of alteration functionality. In Chapter 3, methods and systems are described for determining which alterable interface decision, if any, is the currently alterable decision at any given time. (In an embodiment, the currently alterable decision is often, but not always, the most recent alterable decision, as is explained in Chapter 3. In an embodiment, it may be possible to alter an alterable decision by various means even when it is not the so-called currently alterable decision.)

In an embodiment, the computing device has an alteration key such that when the alteration key is actuated, if there is a currently alterable decision, then the interface will immediately alter that decision. For example, if the interface has made an alterable decision to automatically insert an apostrophe in the word “its” and that decision is the currently alterable decision, then actuating the alteration key will cause that apostrophe to be deleted, regardless of the input cursor's current location, without prompting the user for any additional confirmation or clarification. Such an alteration key will often enable a user to correct an undesired outcome of an interface decision with a single keystroke, without the need to go back and manually correct the interface decision.

In an embodiment, when the alteration key is actuated, if there is then no currently alterable decision but at least one alterable decision exists, then in response to that actuation of the alteration key the interface will cause the “most relevant decision” as defined in Chapter 3 to become the currently alterable decision, and no other effect will occur. (In such an embodiment, it may be particularly advantageous for the interface to then highlight the currently alterable decision, as is described in Chapter 5, so that the user can see the effect of such an actuation of the alteration key.) This behavior is illustrated by Actuation 6 of FIG. 2A.

As is discussed in Chapter 1, the alteration “key” need not necessarily be an individual key on a hardware keyboard, but may be any means of invoking the function that is specified above in the description of the alteration key. For example, in various embodiments, a key labeled “Oops” on a hardware keyboard may be the alteration key, or the F12 key may be the alteration key, or the key combination Ctrl-T may be the alteration key, or a specific virtual key on a virtual keyboard may be the alteration key, and so forth.

### Deleting Alterable Decisions

In the present specification, when an alterable interface decision is said to “cease to exist,” this means that subsequently none of the functionality disclosed herein that pertains to alterable interface decisions will treat that decision as an alterable interface decision, unless otherwise specified. For example, if an alterable interface decision has “ceased to exist,” then that alterable interface decision cannot be the currently alterable decision and actuating the alteration key will not alter that decision. This does not mean that the portion of input that the decision pertained to ceases to exist. After an alterable interface decision has ceased to exist, information about the alterable interface decision may still be retained in the memory of the computing device for various purposes, such as for purposes of the automatic decision variation feature described in Chapter 17 and the manual alteration detection feature described in Chapter 18. In the present specification, if an alterable interface decision is said to be “deleted,” this means that the alterable interface decision ceases to exist.

In an embodiment, if an action that causes an alterable interface decision to cease to exist is subsequently undone by means of the Undo key, then the alterable interface decision will be made to exist once again.

In an embodiment, an alterable interface decision will immediately cease to exist if the portion of input that it pertains to is deleted, because that alterable interface decision is no longer applicable. For example, when the interface has made an alterable decision to automatically convert the word “friday” to “Friday,” that alterable interface decision will cease to exist if the entire sentence containing the word “Friday” is deleted.

In an embodiment, an alterable interface decision will immediately cease to exist if the portion of input that it pertains to is modified in some way other than by means of altering that particular interface decision, if the modification is sufficiently relevant to the nature of the alterable decision. For example, in an embodiment, when the interface has made an alterable decision to automatically convert the word “friday” to “Friday,” that alterable interface decision will cease to exist if the user manually changes the word to “Friendly,” but not if the user italicizes the word. In such an embodiment, in certain circumstances, the interface may make more than one alterable decision that pertains to the same portion of input, and altering one such decision need not necessarily cause all the other decisions that pertain to the same portion of input to cease to exist. For example, in an embodiment, if the interface makes an alterable decision to convert the word “friday” to “Friday,” and the interface also makes an alterable decision whether or not to italicize this word, then the user can alter either, both, or neither of these two decisions.

In an alternative embodiment, an alterable interface decision will immediately cease to exist if the portion of input that it pertains to is modified in some way other than by means of altering that particular interface decision, regardless of whether or not the modification is relevant to the nature of the alterable decision.

In an alternative embodiment, an alterable interface decision will not necessarily cease to exist immediately as soon as the portion of input that it pertains to is deleted or modified: instead, as soon as it becomes relevant whether or not a particular alterable interface decision still exists, the interface will determine whether the portion of input that alterable decision pertains to appears to have been deleted or modified. For example, in such an embodiment, if a certain portion of input that an alterable interface decision pertains to is deleted and is then retyped exactly as before, the interface may not notice that such activity occurred and may not delete the alterable decision in response to such activity.

In an embodiment, when an alterable interface decision is altered, no other alterable interface decision will be deleted in response to the alteration of that alterable interface decision until the user has explicitly selected an option of that decision, and then only if deletion of the other decision is appropriate based on the option the user selected. In other words, in such an embodiment, if for example a user cycles past various options of an alterable interface decision by repeatedly actuating the alteration key as is described below, then no option that is only temporarily selected will cause any other alterable interface decision to permanently cease to exist.

In implementing an embodiment, a programmer should ensure by some means that if the interface makes an alterable decision and saves information regarding that alterable decision, subsequent editing actions do not cause that information to become inaccurate while it is still possible for the user to cause the interface to alter the decision. For example, if the interface alterably decides to capitalize the word “friday” and saves the information that it alterably chose to capitalize the 100th character in the document the user was editing, then this is sufficient information for the interface to be able to alter that decision by locating that letter F and converting it back to lowercase, but if subsequently the user moves the input cursor to the beginning of the document and inserts additional text there, then that letter F is no longer the 100th character of the document, so the interface should either update its information or delete the alterable decision. Those of ordinary skill in the art will understand how to implement an embodiment that updates location data for alterable decisions when appropriate. However, in an alternative embodiment, the interface deletes every alterable decision whenever a user either performs an action that directly affects input that precedes the current input cursor location or performs an action that moves the input cursor to an earlier location; in such an alternative embodiment, it is thus impossible to edit a portion of the document that is prior to the location of any alterable decision without deleting the alterable decision, and so it may never be necessary to update location data for alterable decisions. Such an alternative embodiment may be somewhat less advantageous, but may still have advantages over prior art, and may take less effort to implement.

### The Alteration Key in Perspective

The alteration key as described herein is an unusually efficient means of recovering from a mistake. Generally, prior art mistake recovery features require a user to perform at least two gestures: one gesture to indicate the location of the mistake and cause the interface to display one or more possible corrections, and another gesture to select the desired correction. A single actuation of the alteration key is faster than that two-step process; in fact, for a user who has become accustomed to the alteration key, a single actuation of the alteration key will probably be faster than the first step of that process in most cases.

In many prior art interfaces, a user can fully recover from an undesired interface intervention by means of a single actuation of the Undo key in most cases provided that the user has not performed any other action since the undesired interface intervention occurred. However, if a user performs even one action before noticing an undesired interface intervention, then fully recovering from the mistake by means of the Undo key will require a three-step process: the user must undo everything he did after the undesired interface intervention occurred, and then must actuate the Undo key once more to undo the undesired interface intervention, and then must repeat everything he did after the undesired interface intervention occurred. It is quite common to not notice an undesired interface intervention right away, so in many cases the alteration key will be more efficient than prior art, even for correcting undesired interface interventions.

The present specification includes many illustrative examples of altering decisions, and many of these examples refer to the alteration key. In particular, in various places, in order to show that it may be advantageous to make some particular type of interface decision be an alterable interface decision, the present specification provides an example scenario in which a user who makes a particular type of mistake can easily correct the mistake with just a single actuation of the alteration key. Such examples are not intended to imply that an embodiment must necessarily have an alteration key in order for it to be possible to alter decisions; on the contrary, other means of altering decisions are described below, including means that may be more convenient than the alteration key in certain circumstances. It is to be understood that it may be useful to make various types of interface decisions be alterable decisions even in an embodiment that does not have an alteration key. For that reason, the behavior that constitutes “altering a decision” is defined herein in terms that do not explicitly refer to the alteration key.

### Multi-Alternative Decisions

In an embodiment, in certain circumstances, when the interface makes an alterable decision in which the interface selects among more than two relevant available options, the interface will save enough information to later replace the option that was selected with any of the plurality of options that were not selected. In such a case, the alterable decision will have more than one alternate option. In the present specification, an alterable interface decision that has more than one alternate option will be referred to as a “multi-alternative decision”; an alterable interface decision that has only one alternate option will be referred to as a “single-alternative decision.” (These terms thus refer to the number of alternate options of an alterable decision, not counting the default option.)

In an embodiment, after the interface has made an alterable interface decision, in certain circumstances, the interface may later add more alternate options to that alterable interface decision or may later remove alternate options from that alterable interface decision. In such an embodiment, it may be possible for a single-alternative decision to later become a multi-alternative decision, or vice versa.

In an embodiment, when the interface first alters a multi-alternative decision, in addition to selecting an alternate option of the decision, the interface will create a list of alternate options of that decision that have been selected. In an embodiment, when the interface alters a multi-alternative decision that the interface has previously altered, if an alternate option currently exists that has not been selected, then interface will replace the selected alternate option with an alternate option that has not yet been selected and will then add the newly selected alternate option to the list of alternate options that have been selected. For example, in a certain embodiment, when a user types the word “Tursday” and presses the space bar key the interface may make a decision between three options: leaving the word as “Tursday,” correcting the word to read “Tuesday,” or correcting the word to read “Thursday”; if the interface initially decides to correct the word to read “Tuesday,” such a correction may be a multi-alternative decision such that if the user then actuates the alteration key once the word will be changed to “Thursday” and if the user then actuates the alteration key a second consecutive time the word will be changed to “Tursday.” This example corresponds to Actuations 3 and 4 of FIG. 2A. Thus, in such an embodiment, if the interface responds to a first actuation of the alteration key by selecting an alternate option that is not the particular alternate option a user desired, then the user can simply continue to actuate the alteration key repeatedly until the desired alternate option becomes selected.

### Reverting Alterable Decisions

In an embodiment, when the interface alters a single-alternative decision, if the decision already has its alternate option selected, then the interface reverts that decision to its default option. For example, if the currently alterable decision is the interface's decision to insert an apostrophe in the word “it's,” and if this decision is a single-alternative decision, then after the user actuates the alteration key once and thus causes the apostrophe to be deleted, actuating the alteration key a second consecutive time will cause the apostrophe to be inserted again, as is illustrated by Actuation 2 of FIG. 2A. Similarly, in an embodiment, when the interface alters a multi-alternative decision, if the decision has already been altered sufficiently many times that it is no longer possible for the interface to again replace the selected alternate option with a different alternate option that has not been selected yet, then the interface will instead revert that decision to its default option, as is illustrated by Actuation 5 of FIG. 2A. Thus, in such an embodiment, if in response to an actuation of the alteration key the interface actually introduces a new mistake by changing a decision that the user did not want to change, then the user can correct this mistake by continuing to actuate the alteration key repeatedly until the decision reverts to its default option.

In an embodiment, once a user causes the interface to alter an alterable decision sufficiently many times that the decision reverts to its default option, the user has “completed review” of that alterable interface decision. When a user causes the interface to alter an alterable decision sufficiently many times that every alternate option of that decision has been selected at some point, the user still has not “completed review” of that decision until the user causes that decision to revert to its default option.

In an embodiment, after the interface reverts a multi-alternative alterable decision to its default option, the interface will discard or empty its list of alternate options of that decision that have been selected, which means that the interface will subsequently regard each alternate option as though it had not been selected yet, and so continuing to repeatedly alter that particular decision will cause the interface to cycle through the various alternate options again.

### The Alteration Cycle

In an embodiment, for purposes of the interface behaviors described in the following paragraphs, the alteration key is an “alteration-cycle-related key.” Other alteration-cycle-related keys are described in Chapter 9.

In an embodiment, except as otherwise specified, whenever the user's most recent action was not an actuation of an alteration-cycle-related key, the currently alterable decision is the “most relevant” alterable interface decision as defined below. (In an embodiment, the most relevant alterable decision is often, but not always, the most recent alterable decision, as is explained in Chapter 3.)

In an embodiment, when a user actuates the alteration key or some other alteration-cycle-related key, if the user's most recent previous action was not an actuation of an alteration-cycle-related key, then the interface will determine an “alteration cycle” that initially includes every alterable decision other than the currently alterable decision. The interface will continue to remember this alteration cycle until the user performs an action that is not an actuation of an alteration-cycle-related key, except as otherwise specified below. (Once the user performs an action that is not an actuation of an alteration-cycle-related key this alteration cycle is no longer relevant, so after that, the next time the user actuates an alteration-cycle-related key, the interface will determine a new, updated alteration cycle.)

In an embodiment, when a user performs an actuation of the alteration key that causes the currently alterable decision to revert to its default option, the interface will “move on to the next decision in the alteration cycle.” When the interface moves on to the next decision in the alteration cycle, this means that if any decisions remain in the alteration cycle, then the most relevant decision that is in the alteration cycle will be removed from the alteration cycle and will become the new currently alterable decision. This is illustrated by Actuation 2 of FIG. 2A, which not only causes an alterable decision to revert to its default option but also causes a different alterable decision to become the new currently alterable decision. Thus, in an embodiment, if a user does not notice that a particular alterable decision had an undesired outcome until after the interface has made other alterable decisions, then as long as that particular decision is still alterable, it is still possible for the user to correct the mistake by means of the alteration key: the user can repeatedly press the alteration key sufficiently many times to cycle past any more relevant alterable decisions (which are, in most cases, the more recent alterable decisions) and then press the alteration key again to alter the decision that had the undesired outcome.

In an alternative embodiment, when a user performs an actuation of the alteration key that causes the currently alterable decision to revert to its default option, if any decisions remain in the alteration cycle, then the interface will move on to the next decision in the alteration cycle as described in the preceding paragraph, and will also alter the new currently alterable decision (if any). (In such an embodiment, it may be particularly advantageous to have a No key or Escape key that can revert the currently alterable decision to its default option without affecting any other alterable decision, as is described in Chapter 9.)

In an embodiment, if no decisions are in the alteration cycle when the interface moves on to the next decision in the alteration cycle, then there will cease to be a currently alterable decision and this alteration cycle will no longer be relevant, as is illustrated by Actuation 5 in FIG. 2A. In an embodiment, after this happens, if the user's next action is an actuation of the alteration key, then that actuation of the alteration key will have the same effect as though it were a nonconsecutive actuation of the alteration key: the most relevant alterable decision will become the currently alterable decision, and the interface will determine a new, updated alteration cycle. This behavior is illustrated by Actuation 6 in FIG. 2A, which returns the user's input to its initial state so that a seventh consecutive actuation of the alteration key would have the same effect that Actuation 1 had. Thus, in such an embodiment, by continuing to actuate the alteration key consecutively, a user may repeatedly cycle through alterable interface decisions.

In an alternative embodiment, if no decisions are in the alteration cycle when the interface moves on to the next decision in the alteration cycle, then there will cease to be a currently alterable decision, and any further consecutive actuations of the alteration key will have no effect: there will be no currently alterable decision until after the user performs an action that is not an actuation of an alteration-cycle-related key.

In another alternative embodiment, if no decisions are in the alteration cycle when the interface moves on to the next decision in the alteration cycle, then the most relevant alterable decision will become the new currently alterable decision (even if it was the previous currently alterable decision) and the interface will add every alterable decision other than that decision to the alteration cycle. In such an embodiment, by continuing to actuate the alteration key consecutively, a user may repeatedly cycle through alterable interface decisions without arriving at any intermediate state in which there is no currently alterable decision.

In an embodiment that behaves as described in the preceding paragraphs, when a user is actuating the alteration key repeatedly, the alteration cycle contains all the alterable decisions that have not yet become the currently alterable decision. It will be evident to those of ordinary skill in the art that alternative embodiments can be constructed where the interface behaves the same way as an embodiment that has an alteration cycle as described above, but where this interface behavior is achieved by a slightly different means. For example, in one alternative embodiment, instead of keeping track of an alteration cycle that contains all the alterable decisions that have not yet become the currently alterable decision, the interface keeps track of a “used decision list” of all the alterable decisions that have already become the currently alterable decision, and when the interface “moves on to the next decision in the alteration cycle,” this means that first the currently alterable decision is added to the used decision list, and then if there are any remaining alterable decisions that are not in the used decision list then the most relevant remaining alterable decision becomes the new currently alterable decision.

### Specialized Alteration Cycles

Farther below, certain user actions are described such that when a user performs the action, the interface will alter an alterable interface decision that fits certain criteria, in some embodiments. Unless otherwise specified, when performing an action is said to cause the interface to alter an alterable interface decision that fits certain criteria, this means that the action serves the purpose of an alteration key that affects only alterable decisions that fit the criteria, in an embodiment (regardless of whether the embodiment has an alteration key).

In other words, if performing an action is said to cause the interface to alter an alterable interface decision that fits certain criteria, this means that in an embodiment, when the user performs such an action, if the user's previous action was not the exact same action, then the interface will alter the most relevant alterable decision that fits the criteria, and will determine and remember a specialized alteration cycle that includes any other alterable decisions that fit the same criteria. If the user then performs the exact same action several more times consecutively, then after the interface reverts the most relevant decision that fits the criteria to its default option, the interface will begin to cycle through the options of the other alterable decisions in the specialized alteration cycle.

For example, in an embodiment that is described in Chapter 25, a spoken alteration command exists such that if a user says “Alter 'its” then the interface will alter an alterable interface decision pertaining to an occurrence of the word “its,” if any such alterable decision exists. Where that interface behavior is explained, it is not explicitly specified what will happen if a user says “Alter 'its” when more than one alterable decision exists that pertains to an occurrence of the word “its”; nevertheless, even though it is not explicitly specified below, in light of the above paragraphs it is to be understood that, in an embodiment, in such circumstances the interface will alter the most relevant alterable decision that pertains to an occurrence of the word “its,” and then if the user repeats the same spoken command sufficiently many times consecutively, the interface will eventually cycle through every alterable decision that pertains to an occurrence of the word “its.”

### Repeated Alteration Features in Perspective

In some embodiments, a user may be able to correct a wide variety of mistakes with just a single actuation of the alteration key, with no need to explicitly specify what mistake to correct or what correction is desired, because in many cases the currently alterable decision will be the mistake the user wishes to correct and the first alternate option will be the desired correction. The alteration key may therefore be advantageous even in an embodiment where only a first actuation of the alteration key has any effect.

However, the alteration key may be significantly more advantageous in an embodiment where additional consecutive actuations of the alteration key have additional effects as described above. In such an embodiment, when a first actuation of the alteration key makes a different change than the one a user desires, additional consecutive actuations of the alteration key may revert the undesired change and/or make the desired change. It is usually possible to actuate a single key multiple consecutive times relatively quickly, so actuating the alteration key several consecutive times in order to achieve a desired result may still be a fairly efficient way to achieve that result. Likewise, for similar reasons, various other means of alteration that are described below may be more advantageous in an embodiment where additional consecutive alterations may have additional effects.

### Chapter 3: Alteration Probability

### Alteration Probability

In an embodiment, when the interface makes an alterable decision, the interface will assign to that decision a “probability of alteration” that reflects the approximate ratio of the mathematical probability that a user will wish to select the single most desirable alternate option of the decision to the mathematical probability that the user will wish the default option to remain selected, insofar as the interface is able to determine such a ratio. Such an embodiment will be said to have “the alteration probability feature.”

(For most purposes, the probability of alteration of an alterable decision may be thought of as reflecting the approximate probability that a user will wish to alter that decision, insofar as the interface is able to determine such a probability. This is a simpler explanation of the probability of alteration than the one given in the preceding paragraph, and works out to be essentially the same thing except when there is a reasonably high probability that a user will wish to select an alternate option of the decision other than the most desirable alternate option of the decision.)

In an embodiment, the “most relevant” alterable interface decision is the alterable decision that has the highest probability of alteration; if more than one alterable decision is tied for the highest probability of alteration, the “most relevant” alterable interface decision is the most recent decision among the decisions that have the highest probability of alteration. In such an embodiment, an alterable decision is “more relevant” than another decision if it has a higher probability of alteration or if it has an equal probability of alteration and is more recent. Thus, in such an embodiment, if the embodiment has an alteration key, then a first actuation of the alteration key will alter the most recent alterable interface decision unless some other alterable interface decision currently has a higher probability of alteration.

In an alternative embodiment, the “most relevant” alterable interface decision is simply the most recent alterable decision, and an alterable decision is “more relevant” than another decision if it is more recent.

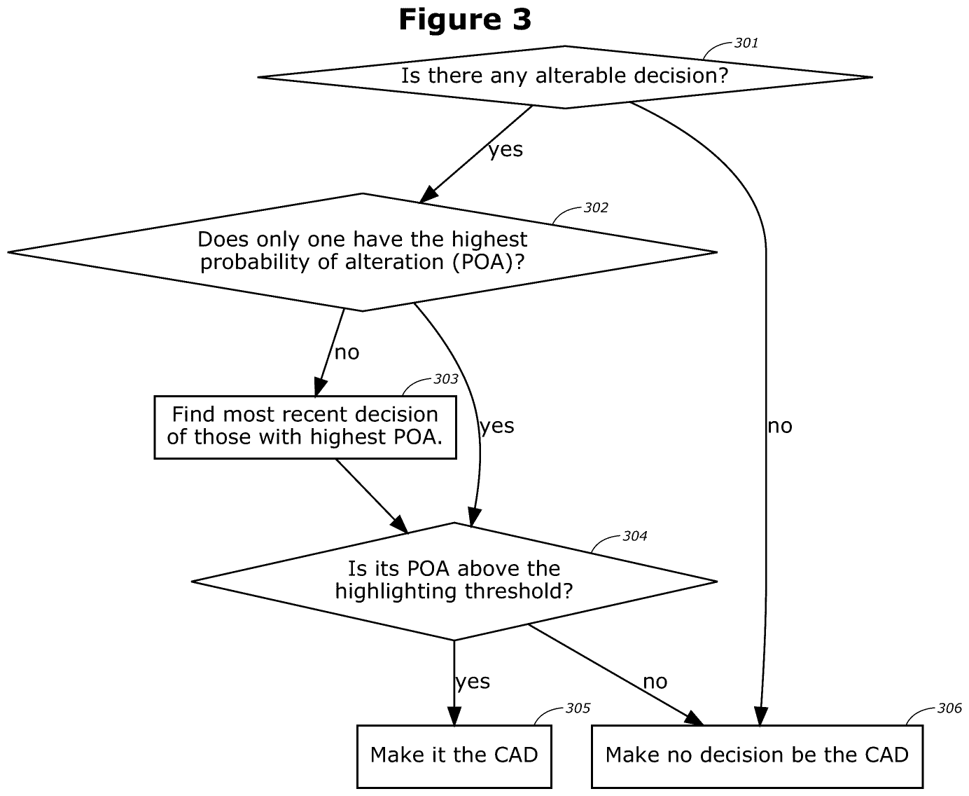

FIG. 3 is a flowchart that illustrates in detail how the currently alterable decision is determined, in an embodiment. Block 301 asks, “Is there any alterable decision?” If the answer is yes, then the algorithm proceeds to Block 302, which asks, “Does only one have the highest probability of alteration (POA)?” If more than one alterable decision is tied for the highest probability of alternation, then the answer is no, and the algorithm proceeds to Block 303, which states “Find most recent decision of those with highest POA.” The most recent decision is then evaluated using the question in Block 304, “Is its POA above the highlight threshold?” If only one alterable decision has the highest probability of alteration, the answer to the question in Block 302 is yes, and that alterable decision is evaluated using the question in Block 304. If the answer to the question in Block 304 is yes, the alterable decision being considered becomes the currently alterable decision (Block 305). If the answer is no, then no decision will be the currently alterable decision (Block 306). Similarly, if there is no alterable decision initially, then the answer to the question in Block 301 is no and the algorithm proceeds directly to Block 306, which states, “Make no decision be the CAD.”

### Alteration Probability in Perspective

Generally, if there is a high probability that an interface decision had an undesirable outcome, then it is desirable for the interface to make it as easy as possible for the user to notice the outcome and to alter the outcome if necessary. If there is a moderately low probability that an interface decision had an undesirable outcome, then it is still desirable for the interface to make it easy for the user to alter the outcome if necessary, but it is not as high a priority: for such a decision, it may be more important for the interface to ensure that alteration functionality pertaining to such a decision does not inconvenience the user in any way. It may thus be advantageous to treat alterable decisions somewhat differently depending on their probabilities of alteration.

In various places, the present specification will explain features that treat alterable decisions differently depending on their probabilities of alteration. For example, in an embodiment that has various features that are described in Chapter 13, if, say, the interface has made an alterable autocorrection decision pertaining to a text message, and at the moment when the user attempts to send the message the interface estimates that there is still about a 40% chance that the user wishes to alter that decision, then the interface will prominently highlight the outcome of the decision and will delay sending the message so as to give the user ample opportunity to alter the decision if desired. If the interface estimates that there is only a 4% chance that the user wishes to alter a decision, then it will highlight the outcome of the decision more subtly and will not delay sending a message on account of the decision. If the interface estimates that there is only a 0.4% chance that the user wishes to alter a decision, then it will not even highlight the decision unless the user enters a special alterable decision review mode. In an embodiment that has such functionality, it may be quite advantageous for probabilities of alteration to be roughly accurate in the aggregate, so that it will be quite common for users to wish to alter decisions that have very high probabilities of alteration and not at all common for users to wish to alter decisions that have very low probabilities of alteration.

However, even though it may be advantageous for probabilities of alteration to be roughly accurate in the aggregate, it may not be necessary for probabilities of alteration to be especially fine-tuned. As is mentioned in the preceding paragraph, in an embodiment, there may be an easily noticeable distinction in the way the interface treats an alterable decision depending on whether the interface estimates that there is a 40% chance or a 4% chance or a 0.4% chance that the user wishes to alter the decision; however, there need not be much distinction between the way the interface treats an alterable decision when the interface estimates that there is, say, a 10% chance that the user wishes to alter the decision versus the way it treats a decision when it estimates there is a 20% chance. For that reason, probabilities of alteration may be quite serviceable even if they are only roughly accurate. Besides, even if the probability of alteration that is assigned to a particular alterable decision is wildly unrealistic, this will not directly cause a mistake: at worst, a probability of alteration that is far too high will cause the interface to unnecessarily distract and delay the user; and at worst, a probability of alteration that is far too low will prevent the interface from calling the user's attention to a potential mistake, or may make it slightly less convenient for the user to correct the mistake by means of alteration functionality if it is indeed a mistake, but generally will not present any disadvantages compared to prior art interfaces that do not have alteration functionality at all.

Generally, in discussing functionality that pertains to probabilities of alteration, the present specification will describe quite precisely what the factors are that affect probabilities of alteration in some embodiments, but will not necessarily quantify the degree to which these factors affect probabilities of alteration with especial precision. It is to be understood that such functionality generally need not necessarily be calibrated carefully in order to yield significant advantages over prior art; however, those of ordinary skill in the art will understand how to calibrate such functionality carefully if desired. For example, an interface behavior is described below such that each time time a user inputs a character or otherwise performs an editing action that does not pertain to alteration functionality or undo functionality, the interface will slightly decrease all probabilities of alteration. In an embodiment that has such functionality, if an alterable decision is highlighted because its probability of alteration is above a certain highlighting threshold (as is described in Chapter 5), and a user sees that the alterable decision is highlighted but ignores it and keeps on typing, after a while the alterable decision will no longer be highlighted. Whether the relevant functionality is calibrated in such a way that an alterable decision that originally has a very high probability of alteration remains highlighted for five keystrokes, or whether it is calibrated in such a way that the decision remains highlighted for 50 keystrokes, such functionality may be advantageous in that it may call a user's attention to potential mistakes yet will not continue to distract the user indefinitely. Those of ordinary skill in the art will understand how to ask users their preferences and how to calibrate such highlighting functionality so as to suit the preferences of an average user of a particular computing device, but such careful calibration may not be necessary in order to yield significant advantages.

In various places throughout the present specification, descriptions of various features include explanations of how the features interact with the probabilities of alteration of alterable decisions, under the implicit assumption that such features will be included in an embodiment that also has the alteration probability feature. Such features may be especially advantageous in an embodiment that has the alteration probability feature, but many of these features may still be advantageous even in an embodiment that does not have the alteration probability feature. Where the description of a feature in the present specification implicitly assumes that alterable decisions have probabilities of alteration, it will be obvious to those of ordinary skill in the art how such a feature can be simplified for inclusion in an embodiment that does not have the alteration probability feature. Generally, in an embodiment that does not have the alteration probability feature, every alterable decision can always be treated as though it had, say, a medium probability of alteration, even though alterable decisions do not actually have individual probabilities of alteration in such an embodiment. In such an embodiment, any circumstances that are said herein to cause the interface to substantially reduce a decision's probability of alteration may instead cause the interface to delete the decision outright (which means that the decision will no longer be alterable). In such an embodiment, any interface decision that is described herein as an alterable decision with a very low probability of alteration may instead be implemented as an interface decision that is not alterable. For example, features are described below such that in an embodiment, an alterable decision is highlighted only when its probability of alteration exceeds a certain threshold, and probabilities of alteration tend to gradually decrease over time; in an alternative embodiment that does not have the alteration probability feature, such features can be simplified so that in an embodiment, every alterable decision is always highlighted, and each alterable decision ceases to be alterable after, say, 10 seconds.

### Option Probability

In an embodiment, when an alterable interface decision is a multi-alternative decision, the interface may assign individual probabilities of alteration to the various alternate options of that multi-alternative decision, where each such probability of alteration reflects the approximate ratio of how probable it is that a user will wish to select that alternate option to how probable it is that the user will wish the default option to remain selected, insofar as the interface is able to determine such a ratio. Such an embodiment will be said to have “the individual option probability feature.” For example, if the interface makes a decision among five options and determines that the five options are approximately equally desirable, then regardless of which option becomes the default option, all four of the alternate options will be assigned very high probabilities of alteration. In an embodiment, the probability of alteration that is assigned to a multi-alternative decision will equal the probability of alteration of its alternate option that has the greatest probability of alteration.

In an embodiment, for some or all multi-alternative decisions, the sequence in which the various alternate options of a multi-alternative decision will be selected if the interface repeatedly alters the decision is determined by the probability of alteration of the various alternate options: each time the interface alters the decision, it will replace the currently selected option with the alternate option that has the highest probability of alteration among the options that have not been selected yet, or select an alternate option that is tied for the highest probability of alteration among the options that have not been selected yet, until every option has been selected. Such an embodiment may more frequently enable a user to achieve a desired outcome with fewer keystrokes.

In various places, the present specification will explain how to assign appropriate probabilities of alteration to the alternate options of various multi-alternative decisions. It is to be understood that whenever the present specification explains how to assign appropriate probabilities of alteration to alternate options, such explanations may alternatively be interpreted as explanations of how to arrange alternate options in an appropriate sequence, and so these explanations may also be applicable (with appropriate modifications) even in an embodiment that does not have the individual option probability feature.

In an embodiment that has the alteration probability feature but does not have the individual option probability feature, every alternate option of any particular alterable interface decision may be treated as having the same probability of alteration that is assigned to the decision itself. Thus, whenever the present specification explains interface behaviors that take into account the probabilities of alteration of individual options of alterable interface decisions, it is to be understood that in an alternative embodiment that has the alteration probability feature but does not have the individual option probability feature, each reference in the present specification to the probability of alteration of an individual option of an alterable interface decision may instead be interpreted as a reference to the probability of alteration of the decision itself. For example, for such an embodiment, where the present specification refers to “each alternate option that has a probability of alteration that is above the alteration hint threshold,” this may be understood to mean “each alternate option that is an option of an alterable interface decision that has a probability of alteration that is above the alteration hint threshold.”

### Representing Probabilities of Alteration

In order to implement the alteration probability feature, it is not necessary to represent a probability of alteration in terms of an actual mathematical probability between 0% and 100%; it is necessary only to represent a probability of alteration in a form such that it is possible to distinguish between relatively high probabilities and relatively low probabilities. For example, in an embodiment, the probability of alteration of each alterable interface decision is initially an integer value between 1 and 5 inclusive, where 1 represents a very low probability of alteration and 5 represents a very high probability of alteration.

For certain purposes that are described below, it may occasionally be advantageous for the interface to be able to determine an approximate mathematical probability that corresponds to a particular probability of alteration. Therefore, in an embodiment, the interface will have a conversion table or some other conversion algorithm for converting a probability of alteration from its usual representation to a representation in terms of the mathematical percentage chance that a user who desires either that particular alternate option or the default option will prefer that particular alternate option over the default option. For example, in an embodiment, the interface will determine that a probability of alteration of 5 or more corresponds to approximately a 50% chance that a user will prefer that particular alternate option over the default option (provided that the user does not prefer some other alternate option over the both of them), a probability of alteration of at least 4 but less than 5 corresponds to approximately a 25% chance that a user will prefer that particular alternate option over the default option, a probability of alteration of at least 3 but less than 4 corresponds to approximately a 10% chance, and so forth.

Conversely, in an embodiment, the interface will have a conversion table or some other conversion algorithm for converting a mathematical percentage chance back to a probability of alteration represented in its usual form. For example, in an embodiment, if the interface has somehow determined that there is at least a 20% chance but less than a 40% chance that a user will prefer a particular alternate option over the default option, then the interface will assign that alternate option a probability of alteration of 4.

Those of ordinary skill in the art will understand that any such conversion algorithms can be made more accurate by collecting usage data. For example, an interface designer may initially estimate that for any single-alternative interface decision that has a probability of alteration equal to 3.0 there is approximately a 10% chance that a user will select the alternate outcome of that decision, but may later collect usage data that indicates that users actually select alternate outcomes of such decisions only 2.4% of the time. However, many features described herein were designed with the expectation that probabilities of alteration will be approximate, so conversion algorithms may be quite serviceable even if the interface designer does not go to great lengths to maximize their accuracy.

In an embodiment, for a multi-alternative alterable decision, in certain circumstances, the interface will determine the overall percentage chance that a user will prefer each particular option over all the other options of the decision (as opposed to just the percentage chance the user will prefer that option over the default option provided that the user does not prefer some other option over the both of them). These overall percentage chances may be derived from the mathematical percentage chance that the user will prefer each particular option over the default option; for example, if an alterable decision has two alternate options, and for one of the alternate options there is a 10% chance that a user who desires either that option or the default option will desire that option (and thus a 90% chance that the user will prefer the default option), and for the other there is a 20% chance that the user will prefer that option over the default option (and thus an 80% chance that the user will prefer the default option), then the ratio of the first option's overall percentage chance to the default option's overall percentage chance equals the ratio 10%:90%, and the ratio of the second option's overall percentage chance to the default option's overall percentage chance equals the ratio 20%:80%, and the sum of these three overall percentage chances equals 100%; from this information three equations can be constructed that involve the three overall percentage chances of the three options, and this system of three equations with three variables can be solved by straightforward algebra. Conversely, in an embodiment, for a multi-alternative alterable decision, in certain circumstances, the interface will determine the percentage chance that a user will prefer each particular option over the default option by deriving this from the ratio of the overall percentage chance that the user will prefer that option over all the others to the overall percentage chance that the user will prefer the default option over all the others.

### Probability Reduction

In an embodiment, the interface may change the probability of alteration of an alterable interface decision that was previously created, for various reasons.

In an embodiment, when a user explicitly selects an option of an alterable interface decision, or when a user completes review of an alterable interface decision, the interface will drastically decrease the probability of alteration of that decision (and each of its options) so that decision's probability of alteration will become extremely low. In an embodiment, the interface will decrease the probability of alteration by a sufficient amount in such circumstances that even if a first alterable interface decision initially has a very high probability of alteration and a second alterable interface decision initially has a very low probability of alteration, once a user has explicitly selected an option of the first decision or completed review of the first decision but has not yet thus interacted with the second decision, the first decision will have an even lower probability of alteration than the second decision.

In an embodiment, the amount by which the interface reduces probabilities of alteration when a user explicitly selects an option of an alterable interface decision is substantially more than the amount by which the interface reduces probabilities of alteration when a user completes review of an alterable interface decision.

Whenever the present specification describes an embodiment in which the interface will greatly reduce a decision's probability of alteration in certain circumstances, it is to be understood that in an alternative embodiment, the interface will instead delete a decision in such circumstances. For example, the preceding paragraphs are to be understood to mean that in an alternative embodiment, when a user explicitly selects an option of an alterable interface decision or completes review of an alterable interface decision, the interface will delete the decision.

In Chapter 12, other circumstances are described in which the interface will reduce probabilities of alteration, in some embodiments. For example, in an embodiment, each time the user inputs a character or otherwise performs an editing action that does not pertain to alteration functionality or undo functionality, the interface will slightly decrease all probabilities of alteration. As a result, the interface may sometimes consider a recent alterable decision to be more relevant than an alterable decision that is not very recent even if the recent decision has a lower probability of alteration than the other decision initially had. This behavior and other behaviors that pertain to reducing probabilities of alteration are described in more detail in Chapter 12.

For example, in one possible embodiment, every probability of alteration is represented in the memory of a computing device as a signed numeral that is initially an integer between 1 and 5 inclusive. When a user explicitly selects an option of an alterable interface decision, the probability of alteration of that decision (and each of its options) decreases by 20. When a user completes review of an alterable interface decision, the probability of alteration of that decision (and each of its options) decreases by 10. When a user inputs a character or otherwise performs an editing action that does not pertain to alteration functionality or undo functionality, the probability of alteration of all previously existing alterable decisions (and each of their options) decreases by 0.2.

### Identical Options

In an embodiment, if options of two distinct alterable interface decisions would yield the same result—that is, if selecting a particular option of one alterable interface decision would happen to yield a result that is exactly identical to the result that would be yielded by selecting a particular option of a different alterable interface decision—then whenever the interface changes the probability of alteration of either one of these options, the interface will also make a corresponding change to the probability of alteration of the other. In particular, when the user explicitly selects an option of either decision or completes review of either decision without selecting an option that yields the particular result, the interface will drastically decrease the probability of alteration of both options that would yield that result.

### Deleting Irrelevant Options

In an embodiment, when the probability of alteration of an alterable interface decision becomes lower than a certain “deletion threshold,” the interface will automatically delete the decision. In an embodiment, when the probability of alteration of an option of an alterable interface decision becomes lower than the deletion threshold, the interface will automatically delete that option, and if the alterable decision then has no remaining options other than the one that is currently selected, the interface will automatically delete the decision. Of course, in order for alterable decisions that initially have a “very low” probability of alteration to actually be alterable for a while, the deletion threshold should be even lower than a “very low” probability of alteration. In an embodiment, the deletion threshold will be equal to the probability of alteration that would be assigned to an alterable decision after the user completed review of the decision if the decision's probability of alteration had been very low before the user completed review.

In an embodiment, as an exception, when a user performs an action that pertains to alteration functionality, the interface will not delete any alterable decisions or options of alterable decisions due to their probabilities of alteration becoming lower than the deletion threshold until the user performs an action that does not pertain to alteration functionality.

In an embodiment, as another exception, if in some circumstances the only possible way for a user to achieve a certain result is by means of altering a particular alterable interface decision in order to select a particular option, then the interface will ensure that in such circumstances such an option and such a decision will not be deleted while they may still be relevant, either by ensuring that their probabilities of alteration will not fall below the deletion threshold, or by preventing the option or decision from being deleted even if its probability of alteration falls below the deletion threshold. For example, in an embodiment that is a calculator interface where a user can convert an answer to percentage form only by means of altering a particular alterable interface decision in order to select a particular option of that decision, the interface will prevent that option of that decision from being deleted until the user has moved on to the next problem.

In an alternative embodiment, the interface will instead simply delete an alterable decision after a certain minimum amount of time passes during which the user does not alter the decision (such as, in an embodiment, a minute). In another alternative embodiment, the user will delete an alterable decision after a certain minimum number of user actions occur during which the user does not alter the decision (such as, in an embodiment, 50 actions).

### Automatic Alteration

In the present specification, every reference to “alteration” refers only to alteration of an alterable interface decision that occurs after the decision was made, in response to a subsequent user action; a single user action will not both cause the interface to make an alterable decision and also cause the interface to immediately alter that decision. “Automatic alteration” refers to what happens if a user action causes the interface to make an alterable decision and then a subsequent user action causes the interface to increase the probability of that alterable decision to a level that is so high that the interface decides to automatically alter the decision on its own initiative.

In the present specification, the “implicit default option probability” is the probability of alteration that would be assigned to an alternate option of an alterable interface decision if the interface determined that the alternate option was exactly as desirable an outcome as the default option. Ordinarily, a decision's probability of alteration will not exceed the implicit default option probability, because that would mean that the interface considered an alternate option to be more desirable than the default option, and that is not usually possible because the interface usually chooses the most desirable option to be the default option. However, in an embodiment, in some cases, after the interface makes an alterable interface decision, subsequent user actions may cause the interface to reevaluate the probability of alteration of the decision in light of new circumstances, which in some cases may cause a probability of alteration to exceed the implicit default option probability.

In an embodiment, after an alterable interface decision is made, if the probability of alteration of any alternate option of the decision subsequently becomes higher than a certain automatic alteration probability threshold, then the interface will automatically alter the decision so that the alternate option that had the highest probability of alteration becomes selected. (In case of a tie, the interface will alter the decision so that any such alternate option becomes selected.) Such an embodiment will be said to have “the automatic alteration feature.”

In an embodiment, the automatic alteration probability threshold will be extremely high, so that it is very rare for an undesired automatic alteration to occur. In particular, in an embodiment, the automatic alteration probability threshold will be somewhat higher than the implicit default option probability, so that even if the interface comes to believe there is slightly above a 50% chance that a user desires for the alternate option of a previously made single-alternative alterable decision to become selected, the interface will not take the initiative to automatically alter the decision until it becomes even more confident that the user desires the alternate option. For example, in an embodiment, the implicit default option probability is 5.0, and no alterable interface decision will have a probability of alteration that initially exceeds 5.0, and the automatic alteration probability threshold is 6.0.

In most cases, after an interface has made an alterable interface decision, it will not be possible for subsequent user actions to cause the interface to increase the probability of alteration of that decision or any of its options very much. Furthermore, in an embodiment, the interface will generally tend to gradually decrease probabilities of alteration, as is described in Chapter 12. Therefore, in an embodiment where the probability threshold for the automatic alteration feature is very high, it may be very unusual for the interface to automatically alter a decision after the user has entered much more input-which may be advantageous: a very belated automatic alteration is very likely to be quite unexpected.

In an embodiment, after the interface automatically alters a decision, the option that becomes selected will subsequently be treated as the default option of that decision, and the former default option of that decision will be treated as an alternate option. However, when the interface automatically alters a decision, this does not mean that the user has “explicitly selected an option” of that decision, and so the interface will not drastically decrease the probability of alteration of that decision; on the contrary, such a decision will typically have a high probability of alteration after it is automatically altered, as is explained in the following paragraph.

In an embodiment, after the interface automatically alters a decision, the alternate option that had been the default option before the automatic alteration occurred will be assigned a probability of alteration that equals a very high probability of alteration minus the amount by which the decision's probability of alteration exceeded the automatic alteration probability threshold. Because a decision's probability of alteration will rarely exceed the automatic alteration probability threshold by much, after the interface automatically alters a decision, the option that had been the default option before the automatic alteration occurred will usually have a very high probability of alteration. (Of course, its probability of alteration will not be so high that a second automatic alteration will occur immediately and thus undo the first automatic alteration.) A very high probability of alteration may be desirable in such circumstances, not because it is especially likely that the user will wish to select that previously selected option—on the contrary, if it were likely, then automatic alteration would not have occurred—but because in the event that the user does wish to select that option, the user may be especially frustrated that the interface belatedly introduced a mistake, and so it may be especially desirable to facilitate noticing and correcting any such mistake.

Where the present specification recommends that an alterable interface decision be assigned a probability of alteration that is “very high,” this should not be taken to mean that the interface might automatically alter that decision at any point—not unless the present specification explicitly mentions such a possibility.

The automatic alteration feature may generally be advantageous in an embodiment that has certain specific types of alterable decisions such that immediately subsequent user input can make it obvious that the original outcome of the alterable decision was the wrong outcome. For example, after the interface makes an alterable autocorrection decision, it is possible that the next word a user types could make it obvious to an autocorrection algorithm that the interface probably made the wrong decision, if the autocorrection algorithm makes use of data regarding how common certain word combinations are.

### Score-Based Decisions

In an embodiment, in some cases, in order for the interface to decide between two or more possible outcomes, the interface will calculate for each outcome a value that is based on circumstances, and then the interface will select the outcome that has the highest such calculated value. Each such calculated value will be referred to herein as a “decision score,” and such a decision will be referred to as a “score-based decision.” The “score gap” of an option of such a decision equals the decision score of the default option minus the decision score of that option; the score gap of the default option thus equals zero.

In an embodiment, when the interface makes a score-based decision that is an alterable decision, the probability of alteration that is assigned to an alternate option of that decision will be high when the score gap of that alternate option is relatively low, and will be low when the score gap of that alternate option is relatively high; that is, if an option's decision score is almost as high as the decision score of the default option, then that option will be assigned a high probability of alteration, or if an option's decision score is much lower than the decision score of the default option, then that option will be assigned a low probability of alteration.

In an embodiment, for some or all score-based decisions, when such a decision is made, for each outcome that does not have the highest option score, that outcome will become an alternate option of the decision only if its option score is within a certain amount of the highest option score; in other words, if an outcome's score gap is more than a certain amount, then that outcome will not become an alternate option. Such a score-based decision will be an alterable decision if and only if it has at least one alternate option. Such a score-based decision will be referred to herein as a “conditionally alterable score-based decision.”

In an embodiment, the exact details of the calibration of probabilities of alteration of score-based decisions are different for some types of score-based decisions than for others. For example, for one type of decision it may be common for decision scores to vary by hundreds of points, so when the decision score of an option of such a decision is just 20 points less than the default option's decision score, that option will be assigned a very high probability of alteration; for another type of decision, when the decision score of an option of such a decision is 20 points less than the default option's decision score, that option will be assigned a very low probability of alteration or eliminated altogether.

In an embodiment, in certain circumstances the interface may recalculate the decision scores of the options of a score-based decision after the user has performed additional actions. If the interface does so, then the interface will accordingly recalculate the probabilities of alteration of the alternate options of that decision. If an alternate option then comes to have a decision score that is higher than the decision score of the default option, then its score gap will be negative, and that alternate option will be assigned an extremely high probability of alteration. In an embodiment that has the automatic alteration feature, if an alternate option comes to have a decision score that exceeds the decision score of the default option by more than a certain amount, then that alternate option may be assigned such a high probability of alteration that the interface will automatically alter the decision, in which case the interface will recalculate the probabilities of alteration of the new alternate options of that decision based on how their decision scores compare to the decision score of the new default option. In an embodiment, after the interface automatically alters a score-based decision, it will add a bonus to the probability of alteration of the alternate option that had been the default option before the automatic alteration occurred (but not such a large bonus that a second automatic alteration will occur immediately).

### Threshold Decisions

In an embodiment, in some cases, in order for the interface to decide between exactly two possible outcomes, the interface will calculate a value that is based on circumstances, and then the interface will select one outcome if that value exceeds a certain threshold value or the other outcome if it does not. Such a calculated value will be referred to herein as a “decision score,” and such a decision will be referred to as a “threshold decision.” For example, in an embodiment, if a user actuates the space bar twice consecutively, the interface will determine the amount of time that elapsed between the two consecutive actuations and will make a threshold decision whether to replace the first space character with a period character: the interface will replace the first space character with a period character if and only if the amount of time that elapsed is below a certain threshold value.

A threshold decision is essentially just a score-based decision that has exactly two possible outcomes where one outcome's decision score is based on circumstances and the other outcome's decision score serves as the threshold value. In the present specification, the term “decision score” in reference to a threshold decision will refer to the particular decision score that is based on circumstances and will not refer to the threshold value, unless otherwise specified.

Whenever a score-based decision is a decision between exactly two possible outcomes, any circumstances that increase the interface's tendency to choose one outcome will necessarily decrease the interface's tendency to choose the other outcome; increasing the decision score of one of the outcomes has essentially the same effect as decreasing the decision score of the other outcome. Any score-based decision between exactly two possible outcomes can therefore be implemented as a threshold decision: one outcome's decision score may be held constant and may thus serve as the threshold value, and the other outcome's decision score may be increased or decreased according to circumstances.

Because a threshold decision is a score-based decision, various interface behaviors pertaining to score-based decisions that are described above are applicable to threshold decisions. In particular, in an embodiment, when the interface makes a threshold decision that is an alterable decision, the score gap is the magnitude of the difference between the decision score and the threshold value, and so the probability of alteration that is assigned to that decision will be high if the decision score is very close to the threshold value, or low if the decision score is much lower or much higher than the threshold value. In an embodiment, for certain threshold decisions, if the score gap is extremely high, then the decision will not be alterable; any such threshold decision will be referred to herein as a “conditionally alterable threshold decision.” In an embodiment, in certain circumstances the interface may recalculate the decision score of a threshold decision after the user has performed additional actions, and if the decision score crosses the threshold value then the decision may be assigned an extremely high probability of alteration. In an embodiment that has the automatic alteration feature, if a recalculated decision score moves far enough across the threshold value, then the interface will automatically alter the decision. In an embodiment, after the interface automatically alters a threshold decision, it will add a bonus to the probability of alteration of the decision (but not such a large bonus that a second automatic alteration will occur immediately).

Various types of alterable decisions that are described farther below are explicitly said to be threshold decisions or otherwise score-based decisions. Adaptation functionality that is described in Part II may work quite well with threshold decisions: after a threshold decision has a non-beneficial outcome, such adaptation functionality may adjust the threshold value so as to potentially yield better results in the future.

### Chapter 4: Rearranging Options

### Contingent Decisions

In some cases, depending on the details of a particular embodiment, an interface may make an alterable decision in which at least one possible outcome of the decision has the consequence that the interface makes another alterable decision, and at least one other possible outcome of the decision does not have the consequence that the interface makes that other alterable decision. For example, in an embodiment that has an alterable spelling correction feature and also has the feature that whenever a user types a day of the week in lowercase letters the interface makes an alterable decision whether or not to capitalize the day of the week, if a user types “tursday” and the interface makes an alterable decision whether or not to change “tursday” to “tuesday,” then if the interface decides to change “tursday” to “tuesday,” the interface may also immediately make another alterable decision—namely, the decision whether or not to capitalize “tuesday”—but if the interface decides not to change “tursday” to “tuesday,” the interface will not make this other alterable decision. Thus, in some cases the existence or nonexistence of an alterable decision may depend upon the outcome of another alterable decision.

In the present specification, when the outcome of one alterable decision determines whether or not the interface makes another alterable decision, the former alterable decision will be referred to as an “antecedent decision” and the latter will be referred to as a “contingent decision.” When information that is sufficient to alter the outcome of a contingent decision is stored in the memory of the computing device and is marked as pertaining to an alterable decision—in other words, when the contingent decision is currently an actual alterable interface decision—the contingent decision is said to “exist.”

A contingent decision need not occur immediately after its antecedent decision: additional keystrokes may intervene. For example, an embodiment could have a feature such that when a user types “ht” at the beginning of a word the interface immediately makes an alterable decision whether or not to replace those letters with “th” and also have the feature that whenever a user types a day of the week in lowercase letters the interface makes an alterable decision whether or not to capitalize the day of the week; in such an embodiment, if a user types “htursday,” then if the interface immediately decides to replace “ht” with “th,” the interface will later make an alterable decision whether or not to capitalize “thursday.”

In an embodiment, for some or all single-alternative antecedent decisions, altering the antecedent decision will toggle the existence or nonexistence of the corresponding contingent decision. In other words, if the initial outcome of a single-alternative antecedent decision was such that the interface did not make the contingent decision, then altering the antecedent decision will cause the interface to make the contingent decision exist; if the initial outcome of the antecedent decision was such that the interface did make the contingent decision, then altering the antecedent decision will cause the interface to make the contingent decision cease to exist. For example, if the interface initially decides to change “teusday” to “tuesday” and immediately follows this decision with an alterable decision whether or not to capitalize “tuesday,” then altering the first decision so that “tuesday” (or now “Tuesday”) is changed back to “teusday” will also cause the alterable decision about whether or not to capitalize “tuesday” to cease to exist. Conversely, if the interface initially does not change “teusday” to “tuesday,” then altering this decision so that “teusday” is changed to “tuesday” will also cause the alterable decision about whether or not to capitalize “tuesday” to exist.

Likewise, in an embodiment, for some or all multi-alternative antecedent decisions, altering the antecedent decision will toggle the existence or nonexistence of the corresponding contingent decision when appropriate. However, an antecedent decision that is a multi-alternative antecedent decision will necessarily have either a plurality of options in which the corresponding contingent decision should exist or a plurality of options in which the corresponding contingent decision should not exist (or both), so altering such an antecedent decision will not toggle the existence or nonexistence of the corresponding contingent decision if the option that was previously selected and the option that becomes selected are both options in which the corresponding contingent decision should exist, or if they are both options in which the corresponding contingent decision should not exist.

(In Chapter 2, an embodiment is described in which an alterable interface decision will cease to exist if the portion of input that it pertains to is deleted or is modified by some means other than by altering the decision, unless the deletion or modification of that portion of input is subsequently undone by some means. In such an embodiment, altering an antecedent decision will always cause its corresponding contingent decision to cease to exist if appropriate. However, it may require additional effort to ensure that altering an antecedent decision will always cause its corresponding contingent decision to exist if appropriate; depending on the circumstances of implementation, it may instead be preferable to implement such behavior on an ad hoc basis, so that altering an antecedent decision sometimes may not cause its corresponding contingent decision to exist even when it would be theoretically appropriate to do so. For example, in an embodiment, altering an antecedent decision regarding whether to autocorrect the spelling of a word will cause a contingent decision to exist if appropriate regarding whether to automatically capitalize the word, but in other cases altering an antecedent decision will not cause its corresponding contingent decision to exist.)

### Calculating Probability Combinations

In an embodiment, in certain circumstances that are described below, the interface will calculate probabilities of alteration for combinations of options of multiple alterable decisions and these probabilities of alteration will be calculated based on the probabilities of alteration of the individual options of the individual alterable decisions. For example, in an embodiment, if a user types “its” and the interface alterably decides to automatically capitalize the word and this decision has a low probability of alteration, and the interface also alterably decides not to insert an apostrophe and this decision has a high probability of alteration, then four possible combinations of options are possible for these two decisions, corresponding to the outcomes “Its,” “It's,” “its,” and “it's.” If these combinations of options are assigned probabilities of alteration that are relative to the default combined outcome “Its,” then the probability of alteration of “Its” will equal the implicit default option probability (which is very high); the probability of alteration of “It's” will be high, but not as high; the probability of alteration of “its” will be low; and the probability of alteration of “it's” will be lower.

In an embodiment, when options of multiple alterable interface decisions are combined, the interface will convert the probabilities of alteration of the individual alterable decisions to actual mathematical percentages by means of a conversion algorithm, then perform precise calculations, and then convert the resulting percentages back to probabilities of alteration by means of a conversion algorithm. For example, in an embodiment, if two alternate options of two different single-alternative alterable decisions each have a probability of alteration of 3.0, then the interface will calculate that the probability of alteration of 3.0 corresponds to an estimated 10% chance that a user will prefer such an alternate option, and a 90% chance the user will prefer the default option. There is thus a 1% chance the user will desire the combination of those two alternate options (on the assumption that the probabilities are independent probabilities), and an 81% chance the user will desire the combination of the two default options. The ratio of the chance the user will desire the combination of those two alternate options to the chance the user will desire either that combination or the default combination is a ratio of 1%:82%, which equals approximately 1.22%; this is the percentage chance that the user will prefer that combination over the default combination, if the user definitely does not desire any combination other than those two. The interface will calculate that an estimated 1.22% chance corresponds to a probability of alteration of 1.0, and so the combination of those two options will be assigned a probability of alteration that equals 1.0.

In an alternative embodiment, when options of multiple alterable interface decisions are combined, the interface will consult an internal table that determines what probability of alteration to assign to a combination of options based on the probabilities of alteration that are assigned to each of the individual options. For example, in an embodiment, if two individual options each have a probability of alteration that is at least 2.5 but less than 3.5, then the combination of those two options will be assigned a probability of alteration that equals 1.0. Such a table can be constructed in such a way that it will yield results that are generally similar to the results that would be yielded by the approach described in the preceding paragraph, and it may not be necessary for probabilities of alteration to be especially precise, so such an embodiment may yield acceptable results.

In another alternative embodiment, when options of multiple alterable interface decisions are combined, the interface will simply assign the combination a probability of alteration that is slightly less than the lower of the two probabilities of alteration of the two options.

In yet another alternative embodiment, when options of multiple alterable interface decisions are combined, if all the alterable interface decisions happen to be score-based decisions that are on the same point scale or comparable point scales, the interface will calculate the sum of the score gaps of those options, and will assign the combination a probability of alteration that is based on the combined score gap, as though the combined score gap were an ordinary score gap. For example, in an embodiment, if the interface makes an antecedent decision not to display a number in the form of a fraction, and this decision's alternate option has a score gap of 3.5, and had the interface decided to display the number in the form of a fraction then it would have made a contingent decision not to display the number in the form of an improper fraction, and that decision's alternate option would have had a score gap of 0.5, and these decisions are on comparable point scales, then when the options of those decisions are combined, the option corresponding to both displaying the number in the form of a fraction and displaying the number in the form of an improper fraction will be assigned a probability of alteration based on the combined score gap of 4.0, which means that it will have a lower probability of alteration than the antecedent decision (which had a score gap of only 3.5), but not much lower.

### Contingent Duplicate Decisions

In an embodiment, whenever the options of a contingent decision are identical to the options of its antecedent decision, the interface will delete the contingent decision. Such a decision may be referred to as a “contingent duplicate decision.” For example, in an embodiment, if a user types “Smith vs.” and then begins to type a word without explicitly actuating the Shift key, the interface will make a first alterable decision whether to automatically capitalize that word (because it is after the abbreviation “vs.”). If the outcome of that first alterable decision is that the interface does not capitalize the word the user types, and then that word turns out to be “jones,” then the interface will make a second alterable decision whether to capitalize that word (because it appears to be a name). Thus, in such circumstances, the second alterable decision whether or not to capitalize “jones” is a contingent decision that has options that are identical to the options of its antecedent decision; in an embodiment, the interface will delete that second decision.

In an embodiment, when the interface deletes a contingent duplicate decision as described in the preceding paragraph, it will update the probability of alteration of the remaining antecedent decision to reflect the fact that that decision now essentially represents a combination of two consecutive decisions, each of which had its own probability of alteration. For example, if the interface has previously made a first decision not to capitalize a word and currently estimates that there is a 70% chance that that was the correct decision, and now the interface makes a second decision not to capitalize the word and estimates that there is a 70% chance that this too is the correct decision, then there is only an estimated 49% chance that both decisions were correct, so there is actually an estimated 51% chance that the user wants the word to be capitalized, and for that reason, when the contingent duplicate decision is deleted, the antecedent decision will be assigned an extremely high probability of alteration. (Although this example discusses probabilities of alteration in terms of actual mathematical percentages for the sake of clarity, in some embodiments the interface will instead determine a probability of alteration for a combination of outcomes by means that do not involve actual mathematical percentages, as is discussed above.)

In an embodiment, after the interface deletes a contingent duplicate decision, for purposes of analyzing the outcomes of the antecedent decision and the contingent decision as described in Chapter 19, if the outcome that the user selects is an outcome that could have been achieved by means of more than one combination of outcomes of individual decisions, then the interface will make no determination regarding whether or not each individual decision had a beneficial outcome. For example, if the interface makes an antecedent decision whether or not to capitalize “jones,” and makes a contingent decision whether or not to capitalize “jones” only if it did not already capitalize “jones” due to the antecedent decision, then if the outcome the user selects is the lowercase outcome “jones” then each decision's outcome should have been to not capitalize the word and so the interface can determine whether or not each decision had a beneficial outcome, but if the outcome the user selects is the capitalized outcome “Jones” then the interface cannot determine whether it is the case that the first decision's outcome should have been to capitalize the word and the second decision was irrelevant or whether it is the case that the first decision's outcome should have been to not capitalize the word but the second decision's outcome should have been to capitalize the word, and so the interface will make no determination regarding whether or not each decision had a beneficial outcome in such circumstances.

### Combining Decisions

In an embodiment, in certain circumstances alterable decisions will be “combined” for purposes of the behaviors described in the following paragraphs. This means that various combinations of options of the decisions may be presented to the user in such a way that the user does not need to be aware that the decisions are actually distinct decisions (as is described below), but does not necessarily mean that the interface will combine the data pertaining to the decisions in such a way that they actually become a single alterable decision.

Generally, it may be desirable to combine alterable decisions that are sufficiently closely related that a user may not necessarily think of them as distinct decisions. In an embodiment, any alterable decisions that pertain to the exact same portion of input will be combined. In an embodiment, any antecedent decision will be combined with its contingent decision. In an embodiment, any alterable decisions that are triggered by the same user action will be combined.

In an embodiment, if a user explicitly selects an option of an alterable decision without explicitly selecting an option of an alterable decision that it was combined with, then those two decisions will no longer be combined.

In an embodiment, whenever a group of two or more combined alterable decisions exists, the individual decisions will not be directly affected by actuations of the alteration key, and will not be included in the alteration cycle. Instead, the interface will create a “combination decision,” which is a special alterable decision such that every possible combination of options of the individual alterable decisions that are combined is an option of the combination decision. Such a combination decision may be included in the alteration cycle and may become the currently alterable decision as though it were an ordinary alterable decision. The interface may determine probabilities of alteration for the combinations of alternate options by various means, as is discussed in Chapter 3. Thus, for example, in an embodiment, if a user types the word “its” and the interface both alterably decides not to insert an apostrophe and alterably decides not to capitalize the word, and the user wishes to alter both of these decisions, then the user can simply press the alteration key repeatedly: the interface will not only yield the individual alternate options “it's” and “Its” but also will eventually yield the combined alternate option “It's.”

Similarly, in an embodiment, when a user performs an action that causes the interface to alter an alterable interface decision that fits certain criteria, if two or more alterable decisions that fit the criteria are combined with one another, then the interface will create a combination decision and either alter the combination decision or include it in the specialized alteration cycle. However, when a user performs an action that causes the interface to alter an alterable interface decision that fits certain criteria, it may happen that one alterable decision fits the criteria while another alterable decision that it is combined with does not fit the criteria; in that case, for purposes of that particular action, the alterable decisions will not be treated as combined decisions, and if the user then explicitly selects an option of one of those decisions without explicitly selecting an option of the other, then the decisions will no longer be combined at all.

In an embodiment, when a particular alternate option of a combination decision has a probability of alteration that is below a certain threshold, that alternate option will be deleted. For example, in an embodiment, if the interface somehow creates a combination decision that is a combination of four single-alternative decisions that each individually have low probabilities of alteration, then the combination decision will not have all 16 possible combinations of outcomes: any combination option that corresponds to simultaneously altering three or four of the decisions will have such a low probability of alteration that it will be deleted. Such a deletion will not affect the original alterable decisions that the combination decision is derived from; it will merely prevent the interface from including that particular combination of options in the alteration cycle.

In an embodiment, when a user completes review of a combination decision, this counts as completing review of its individual independent decisions. When a user explicitly selects the default option of a combination decision, this counts as explicitly selecting the default option of its individual independent decisions. However, when a user explicitly selects an alternate option of a combination decision, this may not count as explicitly selecting an option of all of its individual independent decisions: it counts as explicitly selecting an option of only those individual independent decisions that are actually altered when the user selects the alternate option of the combination decision, and subsequently, those independent decisions that were actually altered are no longer combined with the decisions that were not actually altered. (If more than one independent decision was simultaneously altered this way, then the ones that were altered are still combined with each other.) For example, if a user types the word “its” and the interface both decides not to insert an apostrophe and decides not to capitalize the word, and the interface combines these two alterable decisions, and the user actuates the alteration key sufficiently many times to yield the result “it's,” and the user then continues typing so that the user has explicitly selected the option “it's” of the combination decision, then this counts as explicitly selecting an option of the individual decision whether or not to insert an apostrophe, but does not count as explicitly selecting an option of the individual decision whether or not to capitalize the word, and the two decisions are no longer combined, so the currently alterable decision may now be the decision to not capitalize the word.

In an embodiment, when the interface determines an alteration cycle, in addition to initially including every alterable decision other than the currently alterable decision, the alteration cycle will also include a special combination decision such that every possible combination of options of the currently alterable decision and the individual alterable decisions in the alteration cycle is an alternate option of the special combination decision, unless either that combination of options has already been included in the alteration cycle, or that combination of options has a probability of alteration that is below a certain threshold. Such a special combination decision will be treated as less relevant than all other alterable decisions, so that repeatedly pressing the alteration key will not cause the interface to alter such a special combination decision until after the interface has cycled through all other alterable decisions. In such an embodiment, the user can eventually reach any combination of options by pressing the alteration key sufficiently many times consecutively, unless the combination of options has too low a probability of alteration. For example, if three single-alternative decisions exist, and none of these decisions are combined, and all of them have very high probabilities of alteration, then if the user begins to actuate the alteration key repeatedly, the first six actuations of the alteration key will cause each of the three individual decisions to be altered and then to revert to its default option, but then the next four actuations of the alteration key will cause the interface to present the user with four new outcomes in some order: one in which the alternate options of both the first and second decisions are simultaneously selected, one in which the alternate options of both the first and third decisions are simultaneously selected, one in which the alternate options of both the second and third decisions are simultaneously selected, and one in which the alternate options of all three decisions are simultaneously selected. After that, if the user actuates the alteration key one more time, the combination decision will revert to its default option and the alteration cycle will be complete.

The interface behavior described in the preceding paragraph has the theoretical potential to cause the alteration cycle to include a combination decision that has an extremely high number of options. For example, if 10 single-alternative decisions exist, then a combination decision that included every possible combination of options of those 10 decisions would include over 1000 options. For that reason, if an embodiment behaves as described in the preceding paragraph, and if it is reasonably common for quite a few alterable decisions to simultaneously exist in the embodiment, then it may be especially desirable for such an embodiment to include the alteration probability feature and to include a minimum probability threshold (as described in the preceding paragraph) that is sufficiently high that it will be rare for dozens of combinations of options to be included in the alteration cycle. It may also be especially desirable for such an embodiment to include a No key or an Escape key that can revert a decision to its default option (as described in Chapter 9) so that a user who gets tired of cycling through combinations of options can easily cancel the changes he has caused.

In an alternative embodiment, alterable decisions that pertain to the exact same portion of input are not combined as described above, but are instead “connected.” When the interface moves on to the next decision in the alteration cycle, if there is at least one alterable decision remaining in the alteration cycle that is connected to the decision that was the currently alterable decision, then the most relevant of such decisions will be removed from the alteration cycle and will become the new currently alterable decision, and the interface will immediately alter that other decision. For example, in an embodiment, if the interface made a decision not to insert an apostrophe in “its” and also made a decision not to capitalize “its,” and these are connected decisions, then pressing the alteration key twice consecutively may yield “it's” and then yield “Its,” without reverting to “its” between these two outcomes. Such behavior may be easier to implement than combining decisions and may still yield advantages.

### Splitting Decisions

In an embodiment, when a multi-alternative decision is the currently alterable decision or is in the alteration cycle and there is at least one alterable decision in the alteration cycle that has a lower probability of alteration than that multi-alternative decision, the interface will calculate a “split threshold” which equals the greatest probability of alteration of any alterable decision in the alteration cycle that has a lower relevance than the multi-alternative decision, minus a specific fixed amount; then if at least one of the alternate options of the multi-alternative decision has a probability of alteration below the split threshold, then the multi-alternative decision will be split into “partial decisions” as described in the following paragraph. In an embodiment, the specific fixed amount mentioned in the preceding sentence is fairly large, so that an alterable decision will not be split unless one of its alternate options has a probability of alteration that is quite a bit lower than the probability of alteration of a later decision in the alteration cycle. For example, in an embodiment, alterable decisions have probabilities of alteration that are initially between 1.0 and 5.0 inclusive, and a multi-alternative decision will be split into partial decisions only when one of its alternate options has a probability of alteration that is at least 3.0 less than the probability of alteration of a later decision in the alteration cycle.

In an embodiment, when the interface splits a multi-alternative decision into partial decisions in the circumstances described in the preceding paragraph, the interface will separate the multi-alternative decision into a first partial decision and a second partial decision such that each of the two partial decisions has the same default option as the original multi-alternative decision, but the first partial decision has only those alternate options of the original multi-alternative decision that have a probability of alteration that is above the split threshold and the second partial decision has only those alternate options that have a probability of alteration that is below the split threshold. The second partial decision will thus have a significantly lower probability of alteration than the first partial decision, and will come later in the alteration cycle.

For example, in an embodiment, if two alterable interface decisions exist, and one is a single-alternative decision that has a high probability of alteration, and the other is a multi-alternative decision with one alternate option that has a very high probability of alteration and three other alternate options that each have a very low probability of alteration, then that multi-alternative decision will be separated into partial decisions. One of the partial decisions will have the alternate option that has a very high probability of alteration, and the other will have the three alternate options that each have a very low probability of alteration. If the user decides to alter the single-alternative decision by actuating the alteration key repeatedly, he will only need to actuate the alteration key three times: once to alter the first partial decision, a second time to revert it to its default option, and a third time to alter the single-alternative decision. In an embodiment that did not split a multi-alternative decision in such circumstances, the user would need to actuate the alteration key several more times in order to also cycle past the low-probability options of the multi-alternative decision before reaching the single-alternative decision.

Other circumstances in which a multi-alternative decision may be separated into partial decisions are described in Chapter 14, in the explanation of the targeted alteration feature.

In an embodiment, when a user completes review of a partial decision, this causes the probabilities of alteration of all the alternate options that are in that partial decision to be drastically decreased in the original multi-alternative decision, by the same amount as if the user had completed review of the original multi-alternative decision, but does not cause the probabilities of alteration of the alternate options that are in the other partial decision to be decreased.

In an embodiment, when a user explicitly selects an option of a partial decision, this counts as explicitly selecting that option of the original multi-alternative decision, which thus causes the probabilities of alteration of that decision (and all its alternate options) to be drastically decreased, which affects the probability of alteration of the other partial decision as well. In an embodiment, when a user explicitly selects an option of a first partial decision, the second partial decision will be removed from the alteration cycle (but may become included in the alteration cycle again the next time the interface determines a new, updated alteration cycle).

### Rearranging Options in Perspective

In certain circumstances, it may be advantageous for an embodiment to handle contingent decisions as described above, and to combine alterable decisions in certain circumstances as described above, and to split alterable decisions in certain circumstances as described above. However, in some embodiments, the interface behaviors described in the present chapter are likely to be relevant to only a minority of alterable decisions. An embodiment with alterable decision functionality that does not have any of the functionality that is described in the present chapter may still have significant advantages over prior art.

### Chapter 5: Visuals for Interface-Specified Changes

### Highlighting Blocks

In the following paragraph, and throughout the present specification, where appropriate, the word “input” should be understood to also refer to the software's output or to anything else that interface functionality may interact with; for example, in an embodiment where the interface makes an alterable decision whether to display the output of a calculation as a fraction or as a decimal, the “portion of input” that this alterable decision pertains to is actually the output of the calculation.

In the following paragraphs, a “highlighted block” is a portion of input that the interface distinctively highlights for some reason. For example, in an embodiment, when a user searches for a particular word within a document, the interface highlights each occurrence of that word in yellow, and each such highlighted word is thus a highlighted block.

In various embodiments, in certain circumstances, various portions of input will be distinctively highlighted for various reasons. Various such circumstances are described below. It is to be understood that various means of distinctively highlighting a portion of input will be evident to those of skill in the art; for example, a highlighted portion of input may be bold, or may be italicized, or may be underlined, or may have a different foreground color than the surrounding input, or may have a different background color than the surrounding input. Other means of distinctively highlighting a portion of input will be evident to those of ordinary skill in the art.

In an embodiment, a highlighted block may be displayed in a way that changes over time even when the user is not taking any action. For example, a highlighted block may shimmer, or may cycle through various colors, or may slowly become brighter and then dimmer, or may rapidly alternate between black text on a white background and white text on a black background, or may periodically be magnified for a little while and then revert to its original size. Other means of displaying a highlighted block in a way that changes over time will be evident to those of ordinary skill in the art.

In an embodiment, a highlighted block will have a minimum average distinctiveness from its surroundings: when the user is not taking any action, such a highlighted block will in most cases be displayed in a way that does not change very much over time, but the highlighted block will be displayed in a way that changes more over time when necessary in order to sufficiently distinguish the highlighted block from its surroundings. In particular, in an embodiment, if a particular type of highlighted block is surrounded with text that has a white background, then the highlighted block will be highlighted with a particular non-white default background color that does not vary, but if the color differential between the default background color of the highlighted block and the background color of any adjacent text is below a certain threshold, then the background color of the highlighted block will vary between a range of colors that are sufficiently diverse that the average color differential between the highlighted block and its surroundings will remain above a certain threshold. For example, a highlighted block may be highlighted with a light blue background color when it is surrounded by text that has a white background, but may oscillate between a purplish blue and a greenish blue when it is adjacent to any other text that has a light blue background. For purposes of the present paragraph, the “color differential” may be defined as the sum of the differences of the red, green, and blue values of two colors, or may be defined in any other appropriate way such that two colors are guaranteed to be quite distinct visually when their color differential is sufficiently large.

In an embodiment, even when the relevant interface output is in audio form rather than video form, a changeable block may still be “highlighted” for purposes of the interface functionality that is described herein; various means of highlighting audio output are described in Chapter 29.

### Changeable Blocks

In the present specification, an “alterable block” is the portion of input that an alterable interface decision pertains to. Such a portion of input may also be referred to as an “alterable decision” herein, but will generally be referred to herein as an alterable block. The term “alterable block” should not be taken to mean that functionality pertaining to alterable blocks will be present only in embodiments that facilitate altering alterable interface decisions: on the contrary, highlighting alterable blocks as described below may be advantageous even in an embodiment that does not facilitate altering decisions. In an embodiment, the alterable block of a particular alterable interface decision may include additional input that was not affected by the outcome of the decision; for example, when the interface has made an alterable decision to automatically convert the word “friday” to “Friday,” the alterable block for that decision may consist of the entire word “Friday” rather than consisting of only its first letter.

In the present specification, the “undoable block” is the portion of input that will change if the user's next action is an actuation of the Undo key, if any such portion of input exists, and the “redoable block” is the portion of input that will change if the user's next action is an actuation of the Redo key, if any such portion of input exists. However, in an embodiment that is described below, in certain circumstances a single actuation of the Undo key will not cause the interface to undo anything; in such an embodiment, in such circumstances, the “undoable block” is the portion of input that will change if the user's next two actions are two consecutive actuations of the Undo key, if any such portion of input exists. Similarly, in such an embodiment, in circumstances where a single actuation of the Redo key will not cause the interface to redo anything, the “redoable block” is the portion of input that will change if the user's next two actions are two consecutive actuations of the Redo key, if any such portion of input exists.

In some interfaces, certain multi-click keys exist such that an actuation of the multi-click key that is at least a second consecutive actuation of that key may have a special multi-click effect: that is, rather than performing substantially the same function as the first actuation of that key, the actuation may instead cause the interface to change previously typed input in some way. For example, the TI-36X Pro scientific calculator has a certain key such that a first actuation of this key will yield the letter x, but a second consecutive actuation of this key will not yield the letter x: instead, it will cause the interface to replace the previously entered letter x with the letter y. For some multi-click keys in some interfaces, an actuation of the multi-click key that is at least the second consecutive actuation of that key will always have a special multi-click effect; for other multi-click keys, an actuation of the multi-click key that is at least the second consecutive actuation of that key will have a special multi-click effect if and only if a sufficiently small amount of time has elapsed since the most recent previous actuation of that key. In the present specification, the “multi-click block” is the portion of previously typed input that the interface will change if the user's next action causes such a special multi-click effect to occur. When it is not possible for a user's next action to cause a special multi-click effect to occur, a multi-click block will not exist; for example, immediately after a user actuates a key that is not a multi-click key, a multi-click block will not exist.

In the present specification, an “autocorrection block” is the portion of input that an autocorrection or automatic formatting action pertains to. An autocorrection block may include some input that does not change when the autocorrection or automatic formatting occurs; for example, when the interface automatically capitalizes the word “friday,” the autocorrection block may consist of the entire word rather than consisting of only its first letter.

In the present specification, a “changeable block” is an alterable block, undoable block, redoable block, multi-click block, or autocorrection block.

### Highlighting Changeable Blocks

In an embodiment, when changeable blocks are highlighted, different types of changeable blocks are distinctively highlighted in different ways; for example, in an embodiment, a highlighted alterable block is displayed with a light green background, a highlighted undoable block is displayed with a light pink background, a highlighted multi-click block is displayed with a light purple background, and a highlighted autocorrection block is displayed with a light blue background. In an embodiment, if a portion of input would be highlighted for multiple reasons, other types of highlighting take precedence over alterable block highlighting; for example, if a highlighted undoable block happens to contain the same portion of input as a highlighted alterable block, then that input will be highlighted as an undoable block, not an alterable block.

In an alternative embodiment, autocorrection blocks are distinctively highlighted in the same way as alterable blocks. In another alternative embodiment, all changeable blocks are distinctively highlighted in the same way, and whenever any changeable block that is not an alterable block is highlighted, alterable blocks are not highlighted.

In an embodiment, a changeable block may sometimes contain no input at all. For example, in Chapter 48, the present specification describes circumstances where, in an embodiment, the interface may make an alterable decision whether or not to interpolate a degree symbol after a trigonometric operand; therefore, in an embodiment, after the interface makes such a decision, if the interface decided to interpolate a degree symbol then the alterable block will contain that degree symbol, but if the interface decided not to interpolate a degree symbol then the alterable block will contain no input at all. When a changeable block contains no input at all, such a changeable block still may have a definite location (or locations); for example, if the interface makes an alterable decision whether or not to interpolate a degree symbol after a trigonometric operand, then the alterable block of this decision is located after the trigonometric operand even when the alterable block contains no input. As another example, when actuating the Redo key would cause input to be inserted and would have no other effect, the redoable block contains no input and is located where input will be inserted if the user's next action is an actuation of the Redo key.

In an embodiment, when a highlighted changeable block contains no input, a small region around the location (or locations) of the changeable block may be displayed in the appropriate visually distinctive way to indicate the location of the changeable block. For example, in an embodiment, if the interface has made a highlighted alterable decision not to interpolate a degree symbol after a trigonometric operand, and the alterable block of this decision contains no input, then the interface will highlight a small region after the trigonometric operand where the degree symbol could have been interpolated. In an alternative embodiment, if a highlighted changeable block contains no input, then a small empty space will be temporarily inserted in the user's input at the location of the changeable block and displayed in the appropriate visually distinctive way to indicate the location of the changeable block.

However, in an embodiment, in some cases the interface will cause the alterable block of an alterable interface decision to include additional input that was not affected by the outcome of the decision in order to ensure that the alterable block will contain some input. For example, in an embodiment, when the interface decides whether or not to interpolate a degree symbol after a trigonometric operand, the alterable block of that decision will consist of the trigonometric operand in addition to any degree symbol that may or may not be present, so then even if the degree symbol is not present, the alterable block of that decision can be highlighted without recourse to the behavior described in the preceding paragraph.

Also, in an embodiment, in certain cases the interface will cause a “block descriptor” to appear for a highlighted changeable block that contains no input, and in such cases it may be unnecessary to highlight a small region around the location of the changeable block. Block descriptors are explained in detail in Chapter 8.

In an embodiment, in certain circumstances a change that has not yet occurred but may occur in response to the user's next action is a “proximate change” for purposes that are described below. In such circumstances, the portion of input that will change if the user's next action does cause the proximate change to occur is the “proximate block” for purposes that are described below.

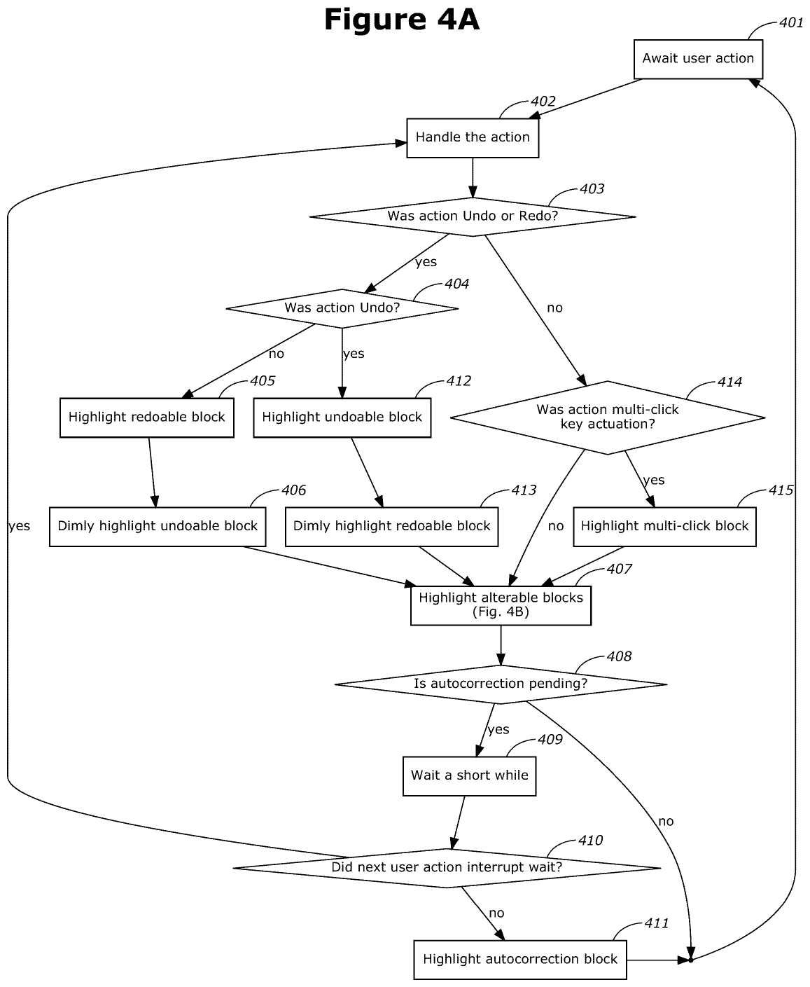

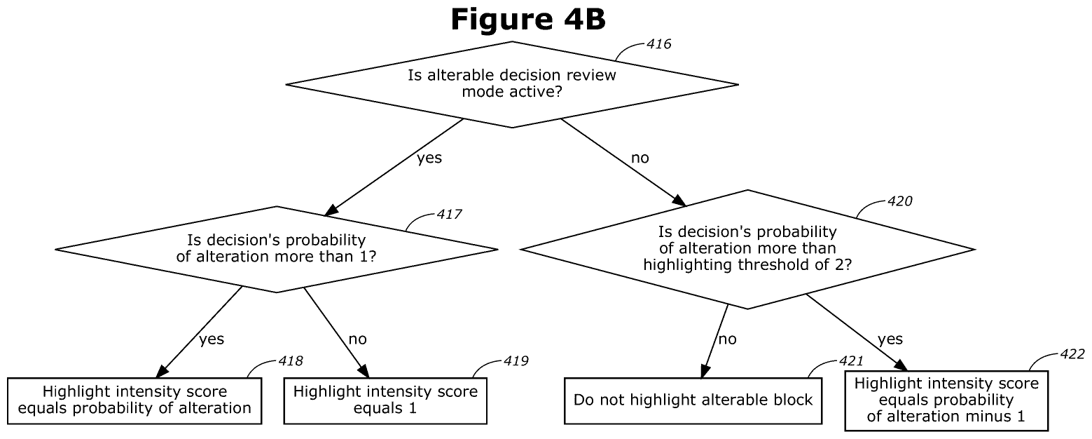

In an embodiment, the interface will highlight changeable blocks as explained in FIG. 4A, which is an illustration of an algorithm for determining what to highlight after each user action. Block 401 says “Await user action” and proceeds to Block 402 which states, “Handle the action.” Block 403 asks, “Was action Undo or Redo?” If the answer is yes, then the algorithm proceeds to Block 404, which asks, “Was action Undo?” If the answer is yes, the interface will highlight the undoable block and dimly highlight the redoable block, as shown in Blocks 412 and 413 of the flowchart. If the answer to the question in Block 404 is no, the interface will highlight the redoable block and dimly highlight the undoable block, as shown in Blocks 405 and 406 of the flowchart.

Continuing with the explanation of FIG. 4A, if the user's action was not Undo or Redo, then the answer to the question in Block 403 is no and the algorithm proceeds to Block 414, which asks, “Was action multi-click key actuation?” If the answer is yes, the interface will highlight the multi-click block as shown in Block 415.

In FIG. 4A, after any user action, regardless of what key the user actuated or what other action the user performed, the interface may highlight alterable blocks (Block 407), as is described in more detail below. In an embodiment, if an autocorrection is pending (Block 408) then the interface will not highlight the autocorrection block immediately, but if the user pauses for a little while (Block 409) then the interface will highlight the autocorrection block (Block 411). Such highlighting behaviors are described in more detail below. However, if the user takes another action and interrupts the wait time, then the answer to the question in Block 410 (“Did next user action interrupt wait?”) is yes, and the algorithm will handle the action (Block 402).

Highlighting behavior is described in more detail below.

### Highlighting Alterable Blocks

In an embodiment, in certain circumstances, an alterable interface decision will be “highlighted,” which means that its alterable block will be distinctively highlighted in some way. In the present specification, the alterable block of such a decision will be referred to as a “highlighted alterable block.” For example, when the interface has made an alterable decision to automatically convert the word “tuesday” to “Tuesday” and that decision is a highlighted alterable interface decision, the displayed word “Tuesday” is a highlighted alterable block.

In an embodiment, an alterable interface decision will be highlighted when its probability of alteration is above a certain “highlighting threshold.” In an alternative embodiment, only the currently alterable decision will be highlighted. In another alternative embodiment, every alterable interface decision will be highlighted.

In an embodiment, an alterable interface decision that would otherwise be highlighted will not be highlighted if its highlighted alterable block overlaps the highlighted alterable block of a more relevant highlighted alterable interface decision. Of course, in such circumstances, the overlapping portion will appear highlighted because it is part of the highlighted alterable block of the other decision; however, even if the less relevant decision's entire alterable block consists of the overlapping portion, the less relevant decision still will not be treated as a highlighted alterable decision.

In an embodiment, when the currently alterable decision is highlighted, it will be distinctively highlighted in a different way than any other alterable decision. For example, the highlighting of its alterable block may have a clearly defined boundary while the highlighting of an alterable block of any other alterable decision has a boundary that gradually blends into the background, or the alterable block of the currently alterable decision may be displayed with a light green background color while the alterable block of any other highlighted alterable interface decision is displayed with an even lighter green background color that more closely resembles the white background color of non-highlighted input. Other means of distinctively highlighting the currently alterable decision in a different way than any other alterable decision will be evident to those of ordinary skill in the art. In an embodiment, whenever any special circumstances obtain such that actuating the alteration key would cause the interface to alter more than one alterable decision, each such decision will be distinctively highlighted as though it were the currently alterable decision. Thus, for example, in an embodiment where repeatedly actuating the alteration key may eventually cause the interface to cycle through various alternate options of a combination decision (as is described in Chapter 2), distinctive highlighting will continue to indicate which alterable block or blocks will change the next time the user actuates the alteration key.

In an embodiment, when the currently alterable decision has a probability of alteration that is below the highlighting threshold, it will be highlighted nonetheless. However, in an embodiment, when the most relevant alterable decision has a probability of alteration that is below the highlighting threshold, there will be no currently alterable decision unless the user's most recent action pertained to alteration functionality. Thus, in such an embodiment, when the most relevant alterable decision has a probability of alteration that is below the highlighting threshold and the user's most recent action did not pertain to alteration functionality, if the user actuates the alteration key, then that actuation of the alteration key will not cause the interface to alter a decision, but will instead cause the most relevant alterable decision to become the currently alterable decision, which will cause the interface to highlight that decision; subsequently, if the user's next action is another actuation of the alteration key, then the interface will alter that decision.

In an embodiment, a highlighted alterable block will be displayed in a way that varies according to the magnitude of its “highlight intensity score,” so that highlighting will be more intense for an alterable block that has a relatively high highlight intensity score, and more subtle for an alterable block that has a relatively low highlight intensity score; when an alterable block has a highlight intensity score of 0, it will not be highlighted. For example, in one embodiment, a highlighted alterable block that has a highlight intensity score of 5.0 will be highlighted a bright color, while a highlighted alterable block that has a highlight intensity score of 1.0 will be be highlighted a pastel color; as another example, in another embodiment, a highlighted alterable block that has a highlight intensity score of 5.0 will cycle rapidly through various bright colors, while a highlighted alterable block that has a highlight intensity score of 1.0 will cycle slowly through various pastel colors.

In an embodiment, in ordinary circumstances, the highlight intensity score of a highlighted alterable block is equal to a certain minimum amount plus the amount by which the probability of alteration of its alterable decision exceeds the highlighting threshold. (Below, special circumstances are described in which the interface may override this default behavior.) For example, in an embodiment, the maximum probability of alteration of an alterable decision is 5.0, the highlighting threshold equals 2.0, and the minimum highlight intensity score of a highlighted alterable block is 1.0. In such an embodiment, the highlight intensity score of a highlighted alterable block is equal to 1.0 plus the amount by which the probability of alteration of its alterable decision exceeds 2.0, so the maximum highlight intensity score of a highlighted alterable block equals 1.0 plus 5.0 minus 2.0, which equals 4.0; therefore, in such an embodiment, in ordinary circumstances, highlight intensity scores for highlighted alterable blocks will range from a minimum of 1.0 to a maximum of 4.0.

In an alternative embodiment, the highlight intensity score of a highlighted alterable block is simply equal to the probability of alteration of its alterable decision, except that if that probability of alteration is negative then the highlight intensity score is zero.

In an embodiment, whenever the user's most recent action caused the interface to alter a decision, if repeating the same action would cause the interface to alter the same decision again, then the proximate change is the change that will occur if the interface alters that decision again, and the proximate block is that decision's alterable block. In an embodiment, whenever the user's most recent action caused the interface to alter a decision, if repeating the same action would cause the interface to alter some other decision (such as because the user's most recent action was an actuation of the alteration key and a different alterable decision is now the currently alterable decision), then the proximate change is the change that will occur if the user repeats the same action, and the proximate block is that other decision's alterable block.

In an embodiment, while the proximate change is an alteration of some alterable interface decision (as described in the preceding paragraph), the interface will treat that decision as the most relevant alterable interface decision, and so that decision will be the currently alterable decision even if other decisions are more recent and/or have a higher probability of alteration. For example, in an embodiment, if a user alters a decision a first time by means of the touch alteration feature, then the decision that the user thus altered will become the currently alterable decision if it was not already the currently alterable decision, at least until the user performs some other action.

### Alterable Decision Review Mode

In an embodiment, the rules that the interface uses in determining what alterable interface decisions to highlight will vary depending on circumstances. In an embodiment, the rules that the interface uses in calculating highlight intensity scores will vary depending on circumstances.

In particular, in an embodiment, when the interface is in a normal mode the interface will highlight only alterable decisions that have a probability of alteration above the highlighting threshold, and when the interface enters an “alterable decision review mode” the interface will highlight all alterable decisions without regard to the highlighting threshold. Therefore, in such an embodiment, any alterable decision that has a probability of alteration that is below the highlighting threshold will be highlighted when and only when the interface is in alterable decision review mode.

In an embodiment, while the interface is in alterable decision review mode, the interface will highlight alterable decisions more intensely than they would otherwise be highlighted. In particular, in an embodiment, while the interface is in alterable decision review mode, each alterable decision will be treated as though its probability of alteration for purposes of highlighting either equals a certain minimum amount or equals its actual probability of alteration plus a certain additional “review mode intensification value,” whichever is greater. For example, in an embodiment, the maximum probability of alteration of an alterable decision is 5.0, and the review mode intensification value is 1.0. While the interface is not in alterable decision review mode, an alterable interface decision is highlighted if its probability of alteration is at least 2.0, and its highlight intensity score equals its probability of alteration minus 1.0, so in ordinary circumstances highlight intensity scores will range from 1.0 to 4.0. While the interface is in alterable decision review mode, though, each alterable decision will be treated as though its probability of alteration for purposes of highlighting equals either a minimum of 2.0 or equals its actual probability of alteration plus 1.0, whichever is greater, so highlight intensity scores may then be as high as 5.0, and even an alterable decision that has an extremely low probability of alteration will have a highlight intensity score of 1.0.

FIG. 4B is a flowchart that illustrates an algorithm for determining how intensely the interface will highlight alterable decisions, in an embodiment. Block 416 asks, “Is alterable decision review mode active?” If the answer to the question is yes, then the algorithm proceeds to Block 417, which asks, “Is decision's probability of alteration more than 1?” If the answer is yes, then the decision's highlight intensity score equals its probability of alteration (Block 418). If the answer is no, then the decision's highlight intensity score equals 1 (Block 419). If the interface is not in alterable decision review mode, then the answer to the question in Block 416 is no and the algorithm proceeds to Block 420, which asks, “Is decision's probability of alteration more than highlighting threshold of 2?” If the answer is yes, then the decision's highlight intensity score equals its probability of alteration minus 1. If the answer is no, then the alterable block is not highlighted (Block 421).

In an embodiment, the interface also has an intensified alterable decision review mode, in which every portion of the display that is not a highlighted alterable block is slightly dimmed in brightness so that highlighted alterable blocks stand out even more.

In an embodiment, whenever the interface is in alterable decision review mode, if a user performs an editing action that does not pertain to alteration functionality, the interface will exit alterable decision review mode, except as otherwise specified.

In an embodiment, when a user actuates the alteration key or invokes any other interface function that is explicitly intended to interact with alterable interface decisions, the interface will enter alterable decision review mode (in addition to any other effects).

In an embodiment, a user may enter alterable decision review mode by invoking a particular interface command that exists specifically for that purpose. It may be particularly advantageous for such an interface command to be readily available in an embodiment where it is relatively difficult to actuate the alteration key (and where it may thus be relatively difficult to cause the interface to enter alterable decision review mode by the means specified in the preceding paragraph). For example, in one embodiment, double-tapping a status line at the top of the screen will cause the interface to enter alterable decision review mode; in another embodiment, simultaneously pressing two buttons on the side of the computing device will cause the interface to enter alterable decision review mode; in another embodiment, touching the lower left corner of the display of the computing device will cause the interface to enter alterable decision review mode, but releasing that touch will cause the interface to immediately exit alterable decision review mode. Other possible means of invoking a particular interface command that causes the interface to enter alterable decision review mode will be evident to those of ordinary skill in the art.

In an alternative embodiment, as an additional means or alternative means of entering alterable decision review mode, simply performing no action for a certain minimum amount of time will cause the interface to automatically enter alterable decision review mode if any alterable decisions exist.

In an embodiment, when the interface is in alterable decision review mode, if the user explicitly selects an option of an alterable interface decision or if the user completes review of an alterable interface decision, then the interface will cease to highlight that decision until the interface exits alterable decision review mode (at which point presumably that decision's probability of alteration will be quite low and so the interface still will not highlight that decision until the interface enters alterable decision review mode again). Thus, in such an embodiment, if the user continues to interact with alterable interface decisions that are highlighted, such as by continuing to repeatedly actuate the alteration key, the number of alterable interface decisions that are highlighted will decrease. In such an embodiment, when no alterable interface decision is highlighted, the interface will exit alterable decision review mode (at which point presumably every decision's probability of alteration will be quite low and so still no alterable interface decision will be highlighted until the interface makes another alterable decision or enters alterable decision review mode again).

### Highlighting Undoable Blocks

In an embodiment, when a user's previous action was an actuation of the Undo key, the undoable block will be distinctively highlighted in some way, and when the user's previous action was an actuation of the Redo key, the redoable block will be distinctively highlighted in some way. In an embodiment, undoable blocks will be distinctively highlighted in a different way than redoable blocks; for example, undoable blocks may be highlighted light pink and redoable blocks may be highlighted light orange.

In an embodiment, when a user's previous action was an actuation of the Undo key, the redoable block will be distinctively highlighted in a way that resembles the way in which the redoable block is distinctively highlighted after an actuation of the Redo key, but is more subtle. For example, in an embodiment where the redoable block is displayed with a light orange background when the user's previous actuation was an actuation of the Redo key, the redoable block may be displayed with an even lighter orange background when the user's previous action was an actuation of the Undo key. Similarly, in an embodiment, when the user's previous action was an actuation of the Redo key, the undoable block will be distinctively highlighted in a way that resembles the way in which the undoable block is distinctively highlighted after an actuation of the Undo key, but is more subtle.

On certain smartphones, in order to access the Undo command, a user must call up an Undo window that has a Cancel button and an Undo button and in some circumstances also has a Redo button. In an embodiment of the present invention, for purposes of the highlighting features disclosed in the preceding two paragraphs, while any such Undo window is displayed, if the user's previous action was not an actuation of the Undo key or the Redo key, then the interface will nevertheless highlight the undoable block (and, in an embodiment, the redoable block) as though the user's previous action were an actuation of the Undo key.

In an embodiment, when a user's previous action was an actuation of the Undo key, the proximate change is the change that will occur if the user's next action is another actuation of the Undo key, and the proximate block is thus the undoable block. In an embodiment, when a user's previous action was an actuation of the Redo key, the proximate change is the change that will occur if the user's next action is another actuation of the Redo key, and the proximate block is thus the redoable block.

### Highlighting Multi-Click Blocks

In an embodiment, when a multi-click block exists, the multi-click block will be distinctively highlighted in some way. In such an embodiment, if a multi-click key has a special multi-click effect only when a sufficiently small amount of time elapses between consecutive actuations of that key, then after the user actuates such a multi-click key, the multi-click block will be distinctively highlighted until either the user performs another action or until enough time elapses that the user's next action can no longer yield a special multi-click effect. After that much time has elapsed, no multi-click block will exist, so the portion of input that previously constituted the multi-click block will no longer be distinctively highlighted in that way.

In an alternative embodiment, when a multi-click block exists, instead of or in addition to highlighting the multi-click block as described in the preceding paragraph, the interface will cause the input cursor to have a distinctive appearance while the multi-click block exists. For example, in an embodiment, after a user actuates a multi-click key, the cursor will be purple (instead of black) until either the user performs another action or until enough time elapses that the user's next action can no longer yield a special multi-click effect.

In an embodiment, if a multi-click key has a special multi-click effect only when a sufficiently small amount of time elapses between consecutive actuations of that key, then after the user actuates that multi-click key, if the user performs no other action, then at a certain time that is a small amount of time before the time when the multi-click block will no longer be distinctively highlighted, the interface will cause the distinctive highlighting of the multi-click block to begin to fade, so that the transition from highlighting the block to no longer highlighting the block will be rapid yet gradual. Such behavior may make it easier for a user to predict whether or not a consecutive actuation of a multi-click key will have a special multi-click effect.

In an embodiment, when it is possible for a user's next action to be an actuation that yields a special multi-click effect, the proximate change is the change to the user's input that would occur as a result of that special multi-click effect, and the proximate block is thus the multi-click block. (However, depending on the details of a particular embodiment, it may never actually matter that the proximate block is the multi-click block, because in some embodiments the existence of a proximate block will have no effect until after a certain amount of time elapses since the user's last action and any multi-click block will cease to be a multi-click block before that time.)

In an embodiment, the above behaviors pertaining to multi-click functionality are applicable only for certain multi-click keys. In such an embodiment, if it is unnecessary to indicate to a user that a consecutive actuation of a particular multi-click key would have a special multi-click effect (in the judgment of the interface designer), then a multi-click block pertaining to such a key will not be highlighted and will not be the proximate block.

### Highlighting Autocorrection Blocks

When pressing the space bar would trigger an autocorrection or automatic formatting action that would not change the space character but would change the word preceding the space character, or when pressing Enter would trigger an autocorrection or automatic formatting action, or in any other circumstances where it is possible that the user's next keystroke may trigger an autocorrection or autoformatting action that affects only input that was typed prior to the user's next keystroke, such an autocorrection or automatic formatting action is “pending” for purposes of the following paragraphs.

In an embodiment, after a certain minimum threshold amount of time has elapsed since the user's last action, if circumstances are such that an autocorrection or automatic formatting action is pending, then that pending action's autocorrection block will be distinctively highlighted in some way. In an embodiment, such a threshold amount of time is a very small amount of time (a fraction of a second), so that after even a slight pause a user will receive a visual indication that an autocorrection or automatic formatting action is pending. In an alternative embodiment, no minimum amount of time is required at all: whenever circumstances are such that an autocorrection or automatic formatting action is pending, that autocorrection block will be highlighted immediately.

In an embodiment, when an autocorrection or automatic formatting action is pending, the proximate change is the change that will occur if the user's next action triggers the pending autocorrection or automatic formatting action, and the proximate block is that autocorrection block (the portion of input that will change if that autocorrection or automatic formatting action occurs).

### Animating Interface-Specified Changes

In the present specification, an “alteration” is the change to the user's input that occurs when an alterable interface decision is altered. An “undo change” is the change that occurs in response to an actuation of either the Undo key or the Redo key. A “multi-click change” is the change to the user's input that occurs as a special multi-click effect in response to at least the second consecutive actuation of a multi-click key. An “autocorrection change” is a change that occurs due to autocorrection or automatic formatting.

In the present specification, an “interface-specified change” is a change that is an alteration, undo change, multi-click change, or autocorrection change. In an embodiment, when an interface-specified change occurs, the interface will animate the change; however, possible exceptions to this behavior are specified in the following two paragraphs.

In some circumstances, a user may not perceive an automatic formatting action as a distinct interface behavior, and may not wish to perceive the automatic formatting action as a distinct interface behavior. For example, when the present writer types a quotation mark in Microsoft Word, the result technically consists of the entry of a straight quotation mark instantly followed by an automatic formatting action that converts the straight quotation mark to a slanted quotation mark, but the present writer is content to perceive the result as though it merely consisted of the direct entry of a slanted quotation mark. In an embodiment, when the interface performs an automatic formatting action that a user is unlikely to wish to perceive as a distinct interface behavior (in the judgment of the interface designer), the interface will not animate the change.

In an embodiment, when the interface performs an autocorrection or automatic formatting action and the decision to perform this action is an alterable interface decision that has a probability of alteration that is below a certain threshold, the interface will not animate the change. For example, in an embodiment, the replacement of the word “dont” with the word “don't” will not be animated because its probability of alteration is very low, but the replacement of the word “its” with the word “it's” will be animated because its probability of alteration is relatively high.

### Animation Methods

In an embodiment, while an animated interface-specified change is occurring, the portion of input that is changing will be distinctively highlighted in some way. In an embodiment, the way of distinctively highlighting such a portion of input will vary depending on whether the interface-specified change is an alteration, an undo change, a multi-click change, or an autocorrection change. In an embodiment, an animated alteration will be highlighted in the same way as the alterable block of the currently alterable decision. In an embodiment, an animated undo change will be highlighted in the same way as a highlighted undoable block if the change is occurring in response to an actuation of the Undo key or will be highlighted in the same way as a highlighted redoable block if the change is occurring in response to an actuation of the Redo key. In an embodiment, an animated multi-click change will be highlighted in the same way as a highlighted multi-click block. In an embodiment, an autocorrection change will be highlighted in the same way as a highlighted autocorrection block.

In the following paragraphs, any reference to a “gradual” change in appearance may be taken to refer to a visual transition that is gradual yet quite rapid. In an embodiment, any such visual transition will be fast enough that it usually is completed before the next keystroke or other user action. In an embodiment, if such a visual transition is not yet complete when the user's next action occurs, then the interface will complete the transition immediately rather than continuing to proceed gradually.

In an embodiment, when a change is animated, rather than instantaneously changing that portion of input, the interface will make the change gradual if possible so that the user may more easily identify the change that is occurring. Therefore, in an embodiment, when a change is animated, if the change causes a portion of input to move, the movement will be rapid but not instantaneous. In an embodiment, even when a change that is animated causes the movement of input other than the portion of input that is being changed, that movement will be gradual; for example, when a change that is animated causes a previously typed word to be replaced with a longer word, any movement of later words to make room for the longer word will be gradual. In an embodiment, when a change that is animated causes a portion of input to be deleted, the deleted portion of input will gradually disappear, and then other input will gradually move to close the gap if appropriate. In an embodiment, when a change that is animated causes input to be inserted, other input will gradually move to open a space for the inserted input if appropriate, and then the inserted input will gradually appear.

In an embodiment, when a change is animated, if the changing portion of input is noncontiguous, then the interface will animate the change to each contiguous subsection of that input simultaneously and independently. In an embodiment, when a change is animated, if in the middle of the changing portion of input there is a sufficiently large subsection that will be the same after the change as it was before the change, then the interface will animate the change as though such a subsection is excluded from the portion of input that is changing, so for purposes of change animation the relevant portion of input will be noncontiguous; the interface will thus simultaneously and independently animate the change to each contiguous subsection that is actually changing. For example, in an embodiment, if a change replaces a three-word phrase with a different three-word phrase that has the same second word, the interface will animate this change by animating the replacement of the first word with a different first word and simultaneously animating the replacement of the third word with a different third word. In an embodiment, a subsection will not be thus excluded from the portion of the input that is changing if the subsection's length is less than one full word.

### Animating Changes that Affect Dependent Output

Various software interfaces may display output that depends in some way on the current state of a user's input or on some other output, so that changing that input or changing that other output will immediately cause the dependent output to change. For example, in spreadsheet applications it is possible for the value of a cell to be calculated by the spreadsheet application based on the value in another cell, so changing the contents of one spreadsheet cell may immediately cause the value displayed in another cell to change. As another example, the inventor has created a calculator app prototype in which a user's input may still be alterable even after the user has pressed Enter and the calculator has displayed the answer, and so altering the user's input may immediately cause a displayed answer to change.

In an embodiment of the present invention, when a change is animated, if the animated change has the potential to immediately cause some dependent output to change, the interface will cause that output to instantaneously disappear before the animated change occurs, and will cause that output to instantaneously reappear with its updated value after the animated change occurs. For example, in an embodiment, if the interface has displayed the answer to sin 2.4° and then an actuation of the alteration key occurs that will cause the degree symbol to be deleted, then first the answer to sin 2.4° will disappear, and then the degree symbol will be deleted, and then the answer to sin 2.4 will appear.

### Animating Transitions

In an embodiment, if the currently alterable decision is highlighted in a different way than other alterable interface decisions, then when a new alterable interface decision becomes the currently alterable decision, the resulting change in highlighting of both the previous currently alterable decision and the new currently alterable decision will be gradual. For example, in an embodiment where the portion of input pertaining to the currently alterable decision is green and all other input is black, when a new alterable interface decision becomes the currently alterable decision, the previous currently alterable decision will gradually change from green to black and the new currently alterable decision will gradually change from black to green, either in that order or simultaneously. In an embodiment, if a user action causes the interface to alter the currently alterable decision and then to change which decision is the currently alterable decision, the alteration will be completed before any change in highlighting occurs. For example, in an embodiment, if a user actuates the alteration key and the interface responds by reverting the currently alterable decision to its default option and then causing a new alterable interface decision to become the currently alterable decision, then this will occur in a sequence of two visually distinct steps: first the selected alternate option of the currently alterable decision will be replaced with the default option of that decision, and then that decision's alterable block will become non-highlighted to indicate that it is no longer the currently alterable decision while simultaneously the new currently alterable decision's alterable block will become highlighted to indicate that it is now the currently alterable decision.

### Scrolling Changes into View

In certain applications, a document will not necessarily consist of a single continuous stream of content, so when a certain portion of input is not in view, in order to cause that portion of input to come into view it may be necessary to navigate in some way other than merely scrolling the display. For example, in a list management application, a document may consist of a set of lists such that when the contents of some particular first list are in view, in order to cause some particular portion of input that is at the bottom of a second list to come into view, it may be necessary to exit the first list and enter the second list and then scroll to the bottom of the second list. In the following paragraphs, every mention of “scrolling the display” is to be understood to refer to whatever means of document navigation is necessary in order to bring a portion of input into view, whether or not such means actually consists of merely scrolling.

In prior art, in Microsoft Word, if an actuation of the Undo key causes a portion of input to change that is not currently in view, Microsoft Word will rapidly scroll up or down as necessary to bring the changed portion of input into view; in such circumstances, a user can usually discern in which direction Microsoft Word scrolls. Similarly, in an embodiment of the present invention, when the interface “scrolls the display” to bring a portion of input into view for any of the reasons specified in the following paragraphs, the scrolling (or other document navigation) will be animated: that is, such scrolling will be rapid but not instantaneous, so it will be possible for a user to discern the difference between scrolling up and scrolling down, for example.

In an embodiment, when an interface-specified change is to occur, if the portion of input that will change is not in view, then the interface will scroll the display so that this portion of input is in view; furthermore, if the portion of input that will change is not fully in view, then the interface will scroll the display so that this portion of input is fully in view if possible. In an embodiment, such scrolling will occur before the interface-specified change occurs, so the user can see the change when it occurs.

In an embodiment, in response to an actuation of the alteration key or Undo key or Redo key, the interface will scroll the display if necessary as disclosed in the preceding paragraph as though an interface-specified change were to occur in response to that key actuation even if the interface-specified change does not actually occur in response to that key actuation for any of the reasons that are specified in the following paragraph.

In an embodiment, in certain circumstances where it may be relatively difficult to identify the portion of input that will change in response to an actuation of the alteration key or Undo key or Redo key, in response to an actuation of the alteration key or Undo key or Redo key, the interface will make it easier to identify the portion of input that will change in response to the next actuation of that key, but will not change any input in response to that particular key actuation. For example, in certain circumstances, in response to an actuation of the Undo key, the interface will highlight the undoable block, but will not actually undo anything. In particular, in an embodiment, when a user actuates the alteration key, if the alterable block of the currently alterable decision is not even partially in view or if the alterable block of the currently alterable decision is not highlighted, then the interface will scroll the display if necessary and will highlight the alterable block of the currently alterable decision, but the interface will not alter the currently alterable decision in response to that actuation of the alteration key. In an embodiment, when a user actuates the Undo key, if the undoable block is not even partially in view, or if the undoable block is not highlighted and the input cursor is no longer at the location where it was after the most recent editing action and a certain minimum amount of time has passed since the last editing action, then the interface will scroll the display if necessary and will move the cursor to the location where it was immediately after the most recent editing action, but the interface will not undo the most recent editing action in response to that actuation of the Undo key. In such an embodiment, if a user who has been editing a large document scrolls to view a different portion of the document so that the location of the most recent change to the document is not even partially in view, then the user can quickly return to the location where the most recent change to the document occurred by actuating the Undo key once, without actually undoing the most recent change. In an embodiment, when a user actuates the Redo key, if the redoable block is not even partially in view, then the interface will scroll the display if necessary and will move the cursor to the location where it was immediately before the original occurrence of the editing action that would be redone, but the interface will not redo an editing action in response to that actuation of the Redo key.

In various prior art interfaces, an Undo menu option or Undo button may include a brief description of the nature of the editing action that will be undone if the Undo function is invoked; for example, a menu option may say “Undo Typing” or “Undo Highlighting” rather than simply saying “Undo.” In an embodiment, in circumstances where the interface would not undo the most recent editing action in response to an actuation of the Undo key but either would just move the cursor or would move the cursor and scroll the display so that the undoable block is in view, such an Undo menu option or Undo button will say “Undo Cursor Movement” or “Undo Scrolling” or something to that effect. Similarly, in circumstances where the interface would not redo anything in response to an actuation of the Redo key, a Redo menu option or Redo button will say “Redo Scrolling” or something to that effect.

In an embodiment, after an actuation of the alteration key or Undo key or Redo key is handled, if the proximate block is not fully in view then the interface will scroll the display so that the proximate block is in view to the maximum extent possible, except that if a portion of input changed as a result of this actuation of the alteration key or Undo key or Redo key then the interface will not scroll the display in a way that would reduce the amount of that portion of input that is visible. Thus, in such an embodiment, when a user repeatedly actuates the alteration key or Undo key or Redo key, the interface will constantly attempt to keep in view both the portion of input that changed in response to the previous key actuation and the portion of input that will change in response to the next key actuation. In an embodiment, any such scrolling will occur after any change occurs that is a result of the actuation of the alteration key or Undo key or Redo key.

An Algorithm for Scrolling Undo Changes into View

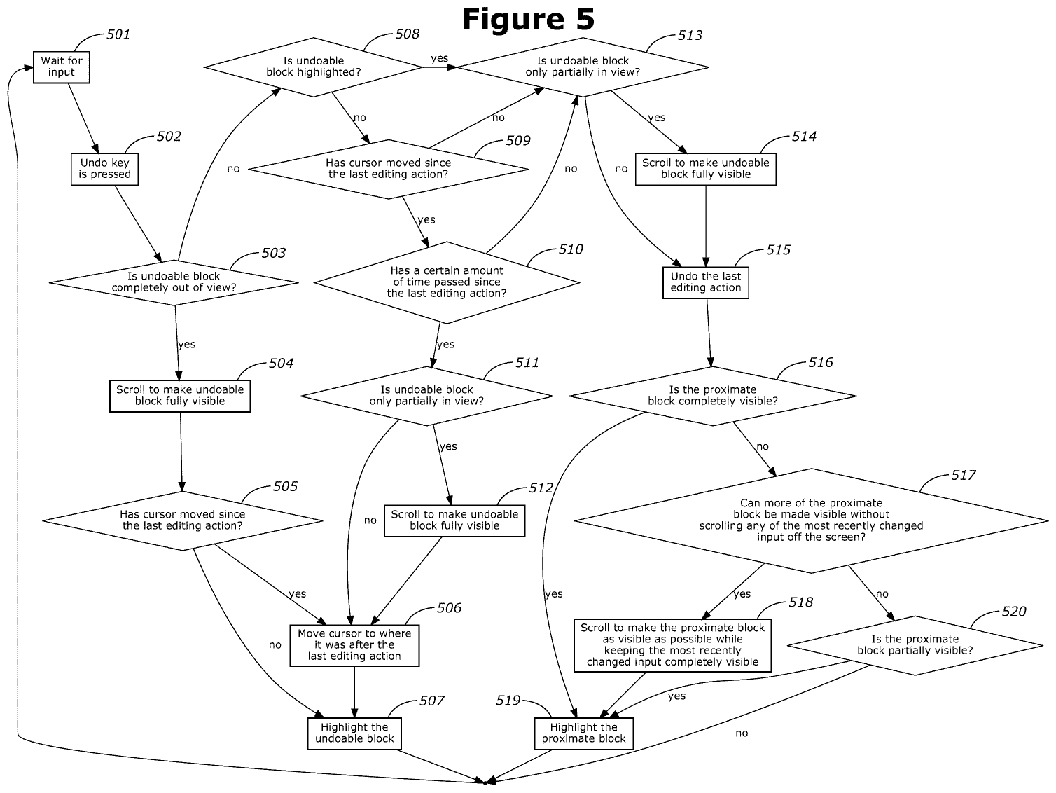

FIG. 5 is a flowchart that illustrates, in an embodiment, how the interface will react when the Undo key is pressed, with particular attention to how the interface will attempt to make undo changes visible for the user. This flowchart does not illustrate what happens in response to any user action other than an actuation of the Undo key.

Block 501 says “Wait for input” and proceeds to Block 502 under the assumption that the Undo key is pressed. Block 502 states, “Undo key is pressed.” From there, the flowchart proceeds to Block 503 which asks, “Is undoable block completely out of view?” If the answer is yes, then the interface will scroll the display so that this portion of input is in view (Block 504).

Subsequently, the algorithm will proceed to Block 505, which asks, “Has cursor moved since the last editing action?” If the answer is no, the interface will highlight the undoable block (Block 507). If the answer is yes, then the interface will move the cursor to the location where it was immediately after the most recent editing action (Block 506), and it will highlight the undoable block (Block 507) but will not actually undo anything. From there, the algorithm returns to Block 501 and waits for the user's next action.

Continuing with the explanation of FIG. 5, if the undoable block is not completely out of view, then the answer to the question in Block 503 is no and the algorithm proceeds to Block 508, which asks, “Is undoable block highlighted?” If the undoable block is not highlighted, then the answer is no, and the algorithm will proceed to Block 509, which asks, “Has cursor moved since the last editing action?” If the answer to the question in Block 509 is yes, the algorithm will proceed to Block 510, which asks, “Has a certain amount of time passed since the last editing action?” If the answer to the question in either Block 509 or Block 510 is no, the algorithm will proceed to Block 513 and continue as described in the following paragraph. If the answer to the question in Block 510 is yes, the algorithm will proceed to Block 511, which asks, “Is undoable block only partially in view?” If the answer is no, then the interface will immediately move the cursor to the location where it was after the last editing action (Block 506). If the answer is yes, then the interface will first scroll to make the undoable text fully visible (Block 512) and then move the cursor to the location where it was after the last editing action (Block 506). As described previously, the interface will then highlight the undoable block (Block 507) but will not actually undo anything. From there, the interface will wait for the user's next action (Block 501).

If the undoable block is not completely out of view and the undoable block is highlighted, then the answer to the question in Block 508 is yes, and the algorithm proceeds to Block 513, which asks, “Is undoable block only partially in view?” If the answer is no and the undoable block is fully visible, then the interface will immediately undo the last editing action (Block 515). If the answer is yes, then the interface will first scroll to make the undoable text fully visible (Block 514) and then undo the last editing action (Block 515). Subsequently, the algorithm proceeds to Block 516, which asks, “Is the proximate block completely visible?” If the answer is yes, the interface will highlight the proximate block (Block 519). If the answer is no, the algorithm proceeds to Block 517, which asks, “Can more of the proximate block be made visible without scrolling any of the most recently changed input off the screen?” If the answer to the question in Block 517 is yes, then the interface will scroll to make the proximate block as visible as possible while keeping the most recently changed input completely visible (Block 518) and then highlight the proximate block (Block 519) and wait for the user's next action (Block 501). If the answer to the question in Block 517 is no, then the algorithm will proceed to Block 520, which asks, “Is the proximate block partially visible?” If the answer is yes, the interface will highlight the proximate block (Block 519) and wait for the user's next action (Block 501). If the answer is no, the interface will wait for the user's next action without highlighting the proximate block.

### Coordinated Key Appearance

In an embodiment, the computing device has a keyboard that includes a key that acts as an alteration key, and the color of the alteration key matches the color that is used to indicate a highlighted alterable block, or the distinctive appearance of the alteration key is similar to the distinctive appearance of a highlighted alterable block in some other way. For example, in an embodiment, the computing device is a smartphone that has a virtual keyboard with an alteration key that is labeled “Alter” in green letters, and highlighted alterable blocks are displayed with a light green highlight.

In an embodiment, the computing device has a keyboard that includes an Undo key and a Redo key, and the colors of such keys match the color or colors that are used to indicate a highlighted undoable block and a highlighted redoable block (respectively), or the distinctive appearance of such keys is similar to the distinctive appearance of a highlighted undoable block and a highlighted redoable block in some other way. For example, in an embodiment, the computing device has a keyboard with a key that is labeled “Undo” in light pink letters, and after a user presses this key once, the portion of input that will change if the user then presses this key a second consecutive time is displayed with a light pink highlight.

In an embodiment, the computing device has a keyboard that includes one or more multi-click keys, and each such multi-click key has a label that includes text that indicates in some way what special multi-click effect can occur as a result of repeatedly actuating the key, and the color of such text matches the color that is used to indicate a highlighted multi-click block, or the distinctive appearance of such text is similar to the distinctive appearance of a highlighted multi-click block in some other way. In an embodiment, each such multi-click key also includes text that does not have a distinctive appearance; such text indicates what effect will occur the first time the key is actuated. For example, in an embodiment, the computing device is a graphing calculator that has a key labeled x^{2,3 . . .} , and on this key x² is black but the remaining text is purple; when a user presses this key once, an exponent of 2 is entered into the user's input and is displayed with a light purple highlight for a certain amount of time or until the user presses a key, and if the user then presses the same key again while the exponent is highlighted, then as a special multi-click effect the interface will increment the highlighted exponent rather than entering a new exponent of 2.

In an embodiment, the computing device has a keyboard that includes a key that acts as a Yes key as described in Chapter 9, and the color of the Yes key matches the color that is used to indicate a highlighted autocorrection block, or the distinctive appearance of the Yes key is similar to the distinctive appearance of a highlighted autocorrection block in some other way. For example, in an embodiment, the computing device has a key that is labeled “Yes” in light blue letters, and highlighted autocorrection blocks are displayed with a light blue highlight.

### Interface Visuals in Perspective

In various prior art interfaces, text is occasionally highlighted, and changes are occasionally animated; however, such behaviors in combination with various behaviors that are described herein may represent significant advantages over prior art. In particular, various prior art interfaces underline supposed spelling mistakes and/or supposed grammar mistakes in order to alert users to such potential mistakes, but some embodiments may have significant advantages over prior art in that they not only highlight potential spelling or grammar mistakes but also highlight various other types of potential mistakes, or in that they also cause such highlighting to disappear eventually so as to not continue to distract users indefinitely, and so forth.

In an embodiment that has an alteration key, it may be especially advantageous to highlight the currently alterable decision, so that a user has some indication what will happen if he actuates the alteration key. In an embodiment that has the touch alteration feature that is described in the following chapter, it may be especially advantageous to highlight all alterable decisions that the touch alteration feature is applicable to, so that a user knows where the touch alteration feature is applicable. More generally, in any embodiment that facilitates altering alterable decisions, it may be especially advantageous to highlight alterable decisions (at least when their probabilities of alteration are not very low), so as to visually indicate that the functionality that facilitates altering alterable decisions is applicable to the highlighted alterable decisions.

However, it may be advantageous to facilitate altering alterable decisions even in an embodiment that does not highlight alterable decisions. Conversely, it may be advantageous to highlight alterable decisions even an embodiment that does not facilitate altering alterable decisions, so as to alert the user to potential mistakes.

Generally, interface behaviors that are described herein that pertain to interface-specified changes may be advantageous when applied to one particular type of interface-specified change, but may have an additional synergistic advantage when applied to multiple types of interface-specified changes. That is, interface behaviors that are described in the present specification that pertain to alterations may be advantageous even in an embodiment that lacks any similar interface behaviors that pertain to undo changes, autocorrection changes, and/or multi-click changes; and likewise, interface behaviors that pertain to undo changes or autocorrection changes or multi-click changes may be advantageous on their own, without similar interface behaviors that pertain to other types of interface-specified changes; but there may be a synergy in incorporating interface behaviors that treat multiple distinct types of interface-specified changes in similar ways, because then for example a user who has become accustomed to the interface behaviors that pertain to undo changes may find it relatively easy to understand similar interface behaviors that pertain to alterations. In the following paragraph, the point that is made in the present paragraph is applied specifically to certain interface behaviors that are described in the present chapter; this same point is also mentioned in later chapters with respect to the interface behaviors that are described in those later chapters.

When a user alters an alterable decision, the user may not know in advance exactly what effect will occur; for example, the first time a user alters an alterable decision that has multiple alternate options, the user may not know which alternate option will become selected. Certain interface behaviors that are described in the present chapter may help users keep track of the effects of alterations, which may be advantageous even in an embodiment that does not help users keep track of undo changes. Conversely, when a user actuates the Undo key, the user may not know in advance exactly what action will be undone, and certain interface behaviors that are described in the present chapter may help users keep track of the effects of undo changes, which may be advantageous even in an embodiment has no alteration functionality whatsoever. However, there may be an additional synergistic advantage in helping users keep track of both alterations and undo changes, because for example a user who has become accustomed to the interface behaviors that facilitate keeping track of undo changes may then find it relatively easy to understand similar interface behaviors that facilitate keeping track of alterations.

### Chapter 6: Touch Controls

### Touch Changes

The interface behavior described in the following paragraph will be referred to as “the touch alteration feature” in the present specification.

In an embodiment, if a user touches a highlighted alterable block, then the interface will alter that particular alterable interface decision. Therefore, in such an embodiment, if alteration works as described in Chapter 2, then the first time a user touches a highlighted alterable block that has not previously been altered, the interface will immediately alter that decision by replacing its default option with an alternate option, without prompting the user for any additional confirmation or clarification. In an embodiment, if after touching a highlighted alterable block the user's next action does not cause the interface to again alter that decision, then performing that next action constitutes “explicitly selecting an option” of that alterable interface decision. In an embodiment, if a user touches a highlighted alterable decision's alterable block more than once consecutively, then after any touch that caused the interface to select an alternate option, the next touch will cause the interface to select a different alternate option that was not selected yet if any such alternate option exists, or will cause the interface to revert the decision to its default option otherwise.

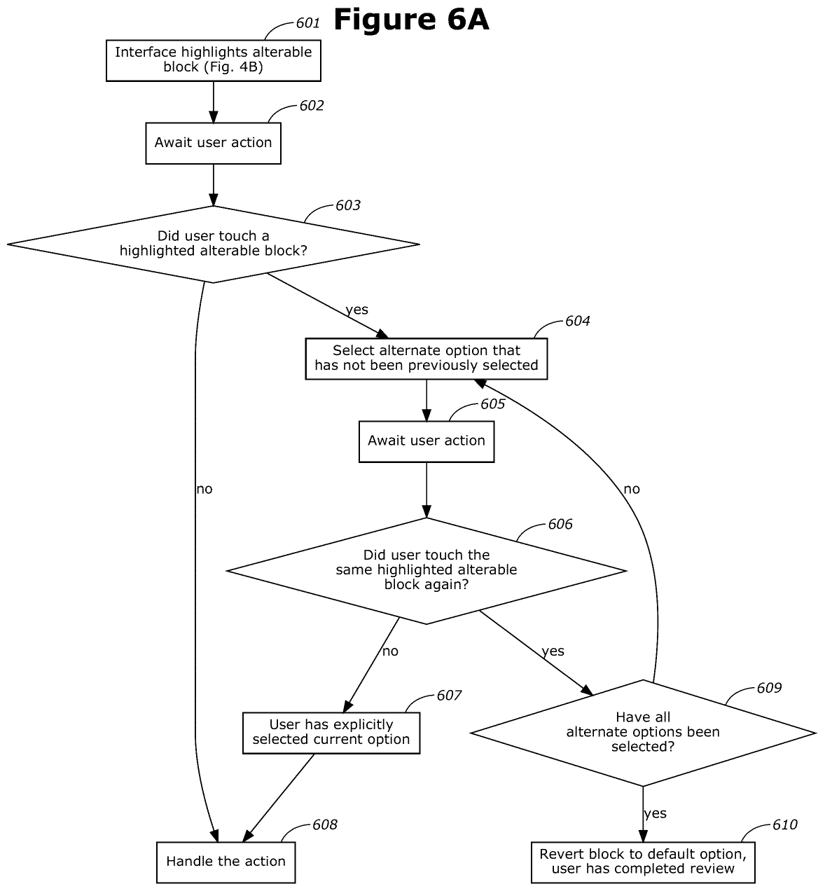

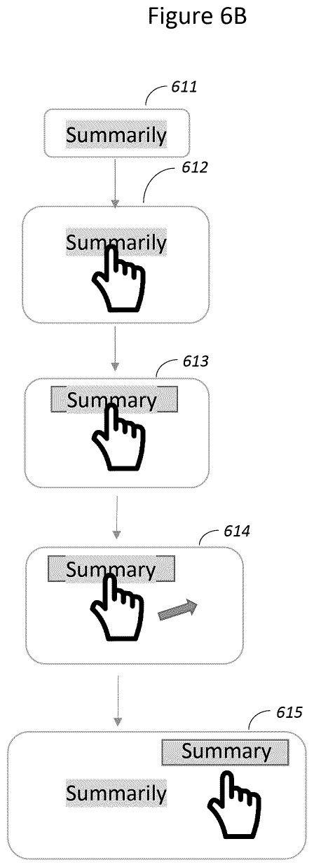

FIG. 6A is a flowchart that illustrates the behavior of an embodiment that has the touch alteration feature as described in the preceding paragraph. Block 601 says, “Interface highlights alterable block (FIG. 4B)” and proceeds to Block 602, which states, “Await user action.” From there, the algorithm proceeds to Block 603, which asks, “Did user touch a highlighted alterable block?” If the answer is no, the interface simply handles the user action (Block 608). If the answer is yes, the algorithm proceeds to Block 604, which says, “Select alternate option that has not been previously selected” and then to Block 605, which says, “Await user action.” From there, the algorithm proceeds to Block 606, which asks, “Did user touch the same highlighted alterable block again?” If the answer is no, the user has explicitly selected the current option of the alterable decision (Block 607) and the interface handles the action (Block 608). If the answer is yes, the algorithm proceeds to Block 609, which asks, “Have all alternate options been selected?” If the answer is no, the algorithm goes back to Block 604 and selects an alternate option that has not been previously selected and continues through the process as described above. If the answer is yes, the interface reverts the block to the default option, and the user has completed review of the alterable decision (Block 610).

In an alternative embodiment, the touch alteration feature will apply only when a user touches the highlighted alterable block of a highlighted alterable interface decision whose probability of alteration is above a certain threshold. In an embodiment, such a highlighted alterable block will be displayed differently than the highlighted alterable block of a highlighted alterable interface decision whose probability of alteration is below the threshold, so that a user can visually distinguish whether or not the touch alteration feature is applicable to any particular highlighted alterable decision.

In an embodiment, if a user touches a highlighted undoable block, the interface will respond as though the user actuated the Undo key; if a user touches a highlighted redoable block, the interface will respond as though the user actuated the Redo key. In an embodiment, if a user touches a highlighted multi-click block, the interface will respond as though the user actuated the relevant multi-click key again. In an embodiment, if a user touches a highlighted autocorrection block, the interface will perform that pending autocorrection. The interface behaviors described in the present paragraph, along with the touch alteration feature, are collectively referred to herein as “touch change features.”

In an embodiment, if a highlighted changeable block contains no input and so the interface highlights a small region around the location of the changeable block in lieu of highlighting the changeable block itself, then touching that region counts as touching the highlighted changeable block for purposes of touch change features.

### Touch Change Toggling

In an embodiment, in many cases, after a user touches a highlighted changeable block and thus invokes a touch change feature, a highlighted changeable block will then be present at the location the user just touched, and touching this highlighted changeable block will reverse the effect of the previous touch. For example, after a user touches a highlighted alterable block, in many cases that highlighted alterable block will continue to be present at the same location, and if it is the alterable block of a single-alternative alterable decision then touching the highlighted alterable block again will reverse the effect of the previous touch. After a user touches a highlighted undoable block, in many cases a highlighted redoable block will then be present where the highlighted undoable block previously was (in an embodiment where the redoable block is highlighted after an actuation of the Undo key), and touching the highlighted redoable block will reverse the effect of the previous touch. After a user touches a highlighted autocorrection block, in many cases a highlighted alterable block will then be present where the highlighted autocorrection block previously was (in an embodiment where autocorrections are alterable decisions), and touching the highlighted alterable block will reverse the effect of the previous touch. It may be desirable to enable a user to undo the invocation of a touch change feature by such means in even more cases, as is described in the following two paragraphs.

In an embodiment, after the touch alteration feature causes the interface to alter a particular alterable interface decision so that an alternate option of that decision becomes selected, if within a sufficiently short amount of time the user again touches the same location the user just touched, then the interface will again alter the same decision the interface just altered, even if for some reason that decision's alterable block is no longer at that location. For example, in such an embodiment, if the alteration that is triggered by touching a highlighted alterable block causes the highlighted alterable block to be entirely deleted, then for a short while, it will still be possible for the user to cause that alterable decision to revert to its default option by means of the touch alteration feature. In an embodiment, during this short amount of time in which touching the same location will cause the interface to alter the same decision, that location will be highlighted by some means; for example, that location may be a different color than surrounding input.

In an embodiment, when a user touches a highlighted autocorrection block and the interface performs the pending autocorrection, the resulting interface decision to perform that autocorrection is an alterable decision that is automatically assigned a probability of alteration that is above the highlighting threshold, so that if the user wishes to undo the autocorrection, the user can immediately do so by means of the touch alteration feature described above. However, in an embodiment, after a user touches a highlighted autocorrection block and the interface performs the pending autocorrection, once the user performs another action, if that next action is not an alteration of the alterable decision to perform that autocorrection, then the interface will consider the user to have explicitly selected the default option of that alterable decision, and so the interface will drastically decrease that alterable decision's probability of alteration and it will no longer be highlighted.

In an embodiment, the invocation of touch change features can also be reversed by another means in certain circumstances, as is described in Chapter 8, in the explanation of side-sliding changes.

### Touch Alteration of Overlapping Blocks

In an embodiment, as is described in Chapter 5, the interface will not highlight an alterable block when it overlaps the alterable block of a highlighted alterable interface decision that has a higher probability of alteration, and in an embodiment, as is described in Chapter 3, the interface will drastically decrease an alterable decision's probability of alteration once the user has completed review of the decision, such as by cycling through all its options. Therefore, in an embodiment, if a user wishes to alter an alterable interface decision by means of the touch alteration feature when that decision's alterable block overlaps the alterable block of an alterable interface decision that has a higher probability of alteration, then the user may do so by touching the overlapping region sufficiently many times consecutively: initially, such touches will cause the interface to alter the decision that has the higher probability of alteration, which the user does not actually wish to alter; but eventually that decision will revert to its default option and its probability of alteration will be drastically decreased, so eventually the alterable decision that the user does wish to alter will have a higher probability of alteration than the other decision and will become highlighted, and then the user's next touch will cause the interface to alter that decision. Similarly, if a user wishes to alter a decision when that decision's alterable block overlaps multiple other alterable blocks, the user may repeatedly touch the overlapping region until all the other alterable decisions have a lower probability of alteration than the one the user wishes to alter, and then the user's next consecutive touch will cause the interface to alter that decision.

In an alternative embodiment where the interface will highlight an alterable block even when it overlaps the alterable block of an alterable interface decision that has a higher probability of alteration, or in an alternative embodiment where the interface does not drastically decrease an alterable decision's probability of alteration once the user has reviewed all its options, each time a user touches a highlighted alterable block, the interface will alter an alterable decision whose alterable block the user touched. In such an embodiment, touching that location will cause the interface to determine and remember a specialized alteration cycle that includes only alterable decisions whose alterable blocks overlap at that location, so that the user will be able to cycle through such decisions by repeatedly touching that location.

### Touch Change Cancellation

In an embodiment, when a user touches a highlighted changeable block, the interface will immediately make the resulting change without waiting for the user to release the touch, but if while still holding the touch the user slides the point of touch more than a certain “previewing distance,” then the interface will position the current text of the changeable block a little ways above the current point of touch and move it in parallel with the point of touch, so that the user is sliding around the current text of the changeable block. When the current text of the changeable block is slid away from its original location, the former text of the changeable block will be visible at that location, as is illustrated in the last panel of FIG. 6B. In an embodiment, if the user slides the current text of a highlighted changeable block more than a certain “cancellation distance” away from its original position and the point of touch is no longer on any portion of the original location of the highlighted changeable block, then that current text will disappear and the interface will undo the change to the changeable block. If the user releases the touch before sliding the current text that far away, the current text will return to its original location.

FIG. 6B illustrates the behavior described in the preceding paragraph. After the interface highlights an alterable decision (Panel 611) and a user touches the highlighted alterable block (Panel 612), the interface immediately evinces the alternate option without waiting for the user to release the touch (Panel 613). While still holding the touch the user slides the point of touch more than the previewing distance from the highlighted alterable block (Panel 614), so the interface positions the current text of the changeable block a little ways above the current point of touch and moves the image as corresponds with the user's point of touch (Panel 615), and when the current text of the changeable block is slid away from its original location, the former text of the changeable block becomes visible at that location (Panel 615).

In an alternative embodiment, when a user touches a highlighted changeable block, the interface will immediately make the resulting change without waiting for the user to release the touch, but subsequently sliding the point of touch will not have any visible effect on the text of the changeable block; nevertheless, if before releasing the touch the user slides the point of touch more than a certain “cancellation distance” and the point of touch is no longer on any portion of the highlighted changeable block, then the interface will undo that change.

Those of ordinary skill in the art will understand that the behavior described in the preceding paragraphs may also be applied to various alternative embodiments that require various means of “touch” in order to invoke the touch alteration feature. For example, in an embodiment, a user who wishes to temporarily view an alternate option for a highlighted alterable interface decision without permanently altering the decision can do so by positioning the mouse cursor on the highlighted alterable block and pressing the left mouse button and then sliding the mouse cursor sufficiently far away from the highlighted alterable block before releasing the left mouse button.

In an embodiment, for purposes of the following paragraphs, touching a highlighted changeable block and then sliding the point of touch far enough to cause the interface to undo the change as described above constitutes “previewing” the changeable block.

In an embodiment, if a user previews a highlighted alterable block, this counts as explicitly selecting the option that had previously been selected for that highlighted alterable decision, which may cause the interface to reduce the probability of alteration of that alterable decision, which may cause the alterable block to no longer be highlighted.

In an embodiment, if a user previews a highlighted undoable block or redoable block, or if a user previews a multi-click block, this counts as performing an action that is not an actuation of the Undo key or Redo key and is not a multi-click key actuation, and so the undoable block, redoable block, or multi-click block that the user previewed will no longer be highlighted.

In an embodiment, if a user previews a highlighted autocorrection block, the interface will cancel the pending autocorrection, and so the portion of input that had constituted the autocorrection block will no longer be highlighted. However, in an embodiment, if the user's next action is an action that would have caused the pending autocorrection to occur had it not been canceled, then the interface's decision not to perform that autocorrection will be an alterable decision with a very low probability of alteration.

### Touch Change Variants

In an alternative embodiment, when a highlighted changeable block can be altered by means of touch change features, that highlighted changeable block is outlined in such a way as to imply that the highlighted changeable block is currently acting as a button. Such behavior may make it easier for a user to become acclimated to touch change features.

In an alternative embodiment, if a user touches the portion of input that an alterable interface decision pertains to, then the interface will alter the most relevant alterable interface decision that the user thus touched even if it is not a highlighted alterable interface decision. Such behavior may make it easier for a user to alter a decision as desired in certain cases, but may also make it easy for a user to alter a decision accidentally, so it may or may not confer a net advantage.

Those of ordinary skill in the art will understand that various alternative embodiments may require various means of “touch” in order to invoke various touch change features. For example, in one embodiment the touch alteration feature is invoked if a user simply touches and releases a highlighted alterable block; in an alternative embodiment the touch alteration feature is invoked only if a user double-clicks a highlighted alterable block; in another alternative embodiment the touch alteration feature is invoked only if a user traces a small clockwise circle that begins and ends on a highlighted alterable block; in another alternative embodiment the touch alteration feature is invoked if a user simply touches and releases a highlighted alterable block, but only when the interface is in alterable decision review mode; and so forth. In one embodiment the same means of touch may invoke touch change features for highlighted alterable blocks, highlighted undoable and redoable blocks, highlighted multi-click blocks, and highlighted autocorrection blocks; in an alternative embodiment single-clicking suffices for a highlighted undoable block, but double-clicking is required for a highlighted alterable block, and touch change features do not work at all for highlighted multi-click blocks or highlighted autocorrection blocks; and so forth.

In an embodiment, more than one distinct touch gesture may exist such that if a user performs the touch gesture on the alterable block of an alterable interface decision, and the decision's probability of alteration is above an optional minimum threshold, then the interface will alter that decision; each such distinct gesture may correspond to a different such optional minimum threshold. For example, in an embodiment, a simple tap gesture will invoke the alteration of a decision only if the decision has a high probability of alteration, and some more complex touch gesture will invoke the alteration of any alterable decision whatsoever. In an embodiment, if the probability of alteration of an alterable interface decision is above any particular such threshold, then the alterable block of that alterable interface decision is displayed differently than the way it would be displayed if its probability of alteration were below the threshold, so that an experienced user can visually distinguish which touch gestures can be used to invoke the alteration of any particular alterable decision.

Diverse embodiments that have touch change features may have diverse advantages. On the one hand, it may be extremely advantageous to minimize the effort required to fix a mistake, so it may be extremely advantageous for the touch alteration feature to be invoked by simply touching and releasing the alterable block of any alterable decision that has a probability of alteration that is not especially low. On the other hand, if a previously existing interface is modified in such a way as to embody the invention, and so users are already familiar with a version of that interface that did not have the touch alteration feature, then it may be advantageous for the touch alteration feature to instead be invoked by a means that is sufficiently complex that users who are not familiar with the touch alteration feature will seldom invoke the touch alteration feature by mistake. For example, in an embodiment, the touch alteration feature can be invoked only when the interface is in alterable decision review mode, and the interface is in alterable decision review mode only while the user is touching the lower left corner of the display of the computing device; in such an embodiment, a user who becomes familiar with the touch alteration feature may come to think of touch alteration invocation as a single input gesture that requires two fingers, and may learn to invoke the feature quite rapidly, but a user who is unfamiliar with the touch alteration feature will seldom invoke the touch alteration feature by mistake.

In an embodiment, the means that is required to invoke the touch alteration feature can be reconfigured. For example, in an embodiment, the touch alteration feature either can be invoked only when the interface is in alterable decision review mode or can be invoked at any time, depending on the current value of a particular interface setting, so that an individual user can explicitly set the touch alteration feature to operate in a way that suits the individual user's preference. Likewise, in an embodiment, the means that are required to invoke various other touch change features can be reconfigured.

### Touch Controls in Perspective

Generally, most prior art mistake recovery features require at least two touch gestures, such as a first touch to open a mistake correction menu and a second touch to select the desired outcome. In an embodiment, the touch alteration may generally enable faster correction of a wider variety of mistakes.

U.S. Pat. No. 8,074,172 appears to describe an iPhone feature such that just a single touch of an autocorrected word will undo the autocorrection, but as far as the present writer is aware, that particular feature has never actually been implemented in any of the publicly available iPhones covered by that patent, presumably because that feature as described would be disadvantageous in many cases: on a phone with such a feature, a single touch of a replacement word could instantly undo an autocorrection that was a desired autocorrection of a very obvious typographical error, which is a result that a typical user would not expect and would not desire. In various embodiments, the touch change features that are described herein may be more advantageous than that prior art feature in various ways. In particular, in an embodiment, touch change features are invoked by a simple tap gesture only when the relevant changeable block is highlighted and so merely tapping non-highlighted text will not cause an unexpected change, and autocorrections that have a very low probability of alteration are not highlighted and thus cannot be accidentally undone by a single touch; and in an embodiment, many other types of errors can be corrected by means of touch change features other than just undesired autocorrections.

It may be extremely advantageous for a user to be able to alter an alterable decision by means of a single quick action, so the touch alteration feature may be especially desirable in an embodiment that lacks an alteration key, and vice versa. However, it may be preferable for an embodiment to have both the alteration key and the touch alteration feature, so as to enable users to quickly alter alterable decisions by whatever means they find most convenient.

As is mentioned in the previous chapter, interface behaviors that are described herein that pertain to interface-specified changes may be advantageous when applied to one particular type of interface-specified change, but may have an additional synergistic advantage when applied to multiple types of interface-specified changes. In particular, the touch alteration feature may be advantageous in an embodiment that does not have any other touch change features, and the touch change feature that enables a user to undo an action by means of touching a highlighted undoable block may be advantageous in an embodiment that does not have any other touch change features, but there may be an additional synergistic advantage in having both the touch alteration feature and other touch change features so that for example a user who has become accustomed to touching a highlighted undoable block in order to undo an action may then find it relatively easy to understand that touching a highlighted alterable block will alter a decision.

### Chapter 7: Menu-Based Alteration

### Option Descriptions

For certain purposes, it may be desirable for an option of an alterable interface decision to have a description that fits within a region of limited size. In particular, if an interface is to display a menu that lists the options of an alterable interface decision, it may be desirable for each description of an option to be displayed in an area that does not exceed a certain height and width.

In prior art, it is customary for menu options to consist of plain text (though often with some letters underlined to indicate shortcut keys). Menu options typically will not have special formatting such as italics or superscripts; if a programmer wishes a menu to include an option such as x² that has special formatting, the programmer may need to create custom menu functionality rather than relying on pre-existing menu functionality that restricts options to plain text. The following discussion of text descriptions of alterable interface decisions will primarily have in view plain text descriptions such as are commonly encountered in prior art menus. Nevertheless, the limitation in view in the following discussion is a spatial limitation, not a formatting limitation: it may possibly be appropriate for a menu to include an option such as x² that has special formatting, but it may not be appropriate for a menu to include an option such as

$$\frac{\frac{1}{2}}{\frac{3}{4}}$$

that exceeds the height allotted for menu options. Thus, the so-called “text descriptions” discussed below may optionally include special formatting or even non-textual graphics, provided that the descriptions fit within a sufficiently small region. A “brief text description” is thus any description that can fit within a row of an ordinary interface menu, and an “extremely brief text description” is any description that can fit within a region that is only large enough to contain a dozen or so plain text characters. (In various embodiments, the exact size constraints for an “extremely brief text description” may vary.)

Two types of approaches to providing brief text descriptions for options of alterable interface decisions are: a self-descriptive approach, in which an option of an alterable interface decision serves as its own brief text description; and non-self-descriptive approaches, in which an option of an alterable interface decision is described in terms of its purpose or nature or in terms of the way the decision's outcome may be modified in order to yield that option.

An alterable interface decision that is intended to facilitate the correction of a potential word entry mistake will typically have options that consist of small portions of text, and so can easily serve as their own brief text descriptions. For example, if the interface makes an alterable decision to convert the word “arnor” to the word “armor,” then the two options of this alterable decision can be briefly described as “arnor” and “armor.” It would be more difficult to create an algorithm that briefly describes such options by means of a non-self-descriptive approach.

An alterable interface decision that is intended to facilitate the correction of an undesired autocorrection or a formatting mistake will typically have options that can easily be described by means of a non-self-descriptive approach. For example, if in response to an actuation of the Paste key the interface makes an alterable decision whether to keep the original format of the pasted text or to change the format of the pasted text to match its new surroundings, the options of that decision may be briefly described as “keep source formatting” and “match destination formatting,” or in some similar way. If the pasted text is lengthy, then such a decision's options cannot be briefly described by means of a self-descriptive approach.

In many cases, the options of an alterable interface decision can easily be described by either type of approach. For example, if the interface makes an alterable decision to automatically convert the word “friday” to “Friday,” the options of that decision may be briefly described as “friday” and “Friday,” or they may be briefly described as “keep lowercase” and “capitalize.” In other cases, the options of an alterable interface decision may not be easy to describe by either type of approach. For example, if the default option of an alterable interface decision is

$$\sqrt{\frac{3}{4}}$$

and an alternate option is

$$\frac{\sqrt{3}}{4} ,$$

it is not obvious to the present writer how to briefly describe these options in plain text that the average user will quickly understand. Nevertheless, it will usually be possible to describe the options of an alterable interface decision by means of a non-self-descriptive approach, even if such a description will not be easy for the average user to quickly understand. For example, in certain circumstances, if the options of an alterable interface decision are

$$\sqrt{\frac{3}{4}} and \frac{\sqrt{3}}{4} ,$$

these options may be described as “don't alter” and “shrink square root.”

In an embodiment, the interface will use a self-descriptive approach to describe options of alterable interface decisions that are intended to correct word entry mistakes, and will use a non-self-descriptive approach to describe options of other alterable interface decisions. In an alternative embodiment, the interface will use a self-descriptive approach to describe options of alterable interface decisions whenever possible, and will use a non-self-descriptive approach in other cases.

For certain purposes, it may be desirable for an option of an alterable interface decision to have a text description that is extremely brief. In an embodiment, whenever an extremely brief text description of an option of an alterable interface decision is required, if the interface is otherwise unable to provide an extremely brief text description, then the interface will use a default description such as the word “Alter.”

### Alteration Menus

In various prior art interfaces, in various circumstances, the interface may display a menu of options where each option consists of a brief portion of text that is contained in a separate row of the menu. On a prior art iPhone, in various circumstances, the interface may display a pop-up menu of a few options where each option consists of an extremely brief portion of text and all the options are contained within a single row with dividers between the various options. In certain prior art interfaces, whenever a menu needs to contain more options than the quantity of options that can fit within its allotted space, the menu will have a special option such that when this option is selected the menu will replace the set of menu options that were visible with a different set of menu options. For example, on an iPhone, in certain circumstances a single-row menu may appear that contains the four options “Cut,” “Copy,” “Paste,” and “ [symbol] ”; if the user selects the option “ [symbol] ”, then the first three options will be replaced with the options “ [symbol] ”, “Replace . . . ”, and “Define”; if the user then selects the option “ [symbol] ”, then the menu will revert to its original version. Accordingly, those of ordinary skill in the art will understand that an alteration menu as described below may contain as many options as necessary, regardless of the size of the display of a computing device. (However, each individual option should have a description that fits within a region of limited size, as discussed above.)

In an embodiment of the present invention, when a user performs some particular touch gesture on an alterable block, the interface will display an “alteration menu,” which is a menu that includes a brief text description for each alternate option of that alterable interface decision; if the user then selects one of these options from the menu, the interface will close the menu and will replace the previously selected option of that decision with the option the user just selected. If such an embodiment has the touch alteration feature, then the touch gesture that invokes an alteration menu is different than the touch gesture that invokes the touch alteration feature; for example, in an embodiment, the touch alteration feature is invoked by a very simple touch gesture such as a click of the left mouse button or a single tap with a finger, and an alteration menu is invoked by a click of the right mouse button or a touch with a finger with application of additional pressure.

In various embodiments, either the touch gesture that invokes an alteration menu may do so only when the touch gesture indicates the location of an alterable block that is highlighted, or else the touch gesture may invoke an alteration menu whenever the touch gesture indicates the location of any alterable block regardless of whether the alterable block is highlighted.

In various embodiments, either an alteration menu may include only the alternate options of an alterable interface decision, or it may also include the default option, possibly with some distinguishing mark or distinguishing highlight to indicate that the default option is currently selected. Each approach has its advantages. In an embodiment that is a computing device with a very small display, such as a smartphone, one possible advantage of including only the alternate options is that the alteration menu may then take up slightly less space.

In various prior art interfaces, a user who wishes to select a menu option from a menu that is on a menu bar may click on the title of the desired menu in order to open that menu and then click on the desired option to select that option, or may instead press and hold the mouse button in order to open the desired menu, then slide the mouse cursor to the desired option, and there release the mouse button to select that option. Accordingly, in an embodiment of the present invention, if a user holds the touch (or mouse button press) that causes the interface to display an alteration menu, then the user can select an option from that menu by sliding the touch (or mouse cursor) to the desired option and there releasing the touch (or mouse button press).

In an embodiment, if a user presses and holds the alteration key for at least a certain specific length of time, then the interface will display an alteration menu for the currently alterable decision. Thus, in such an embodiment, when a user wishes to correct a mistake by means of altering the currently alterable decision, the user can explicitly select the desired correction without the need to explicitly indicate the location of the mistake first. In an embodiment, if a user presses the Escape key or the alteration key while an alteration menu is displayed, the interface will close that menu without selecting an option from that menu.

In an embodiment, selecting an option of an alterable interface decision from an alteration menu constitutes “explicitly selecting an option” of that alterable interface decision. In an embodiment, closing an alteration menu without selecting an option of an alterable interface decision from that menu constitutes “completing review” of that alterable interface decision.

### Additional Options and Additional Menus

In an embodiment, when the interface displays a menu of options of an alterable decision, the interface may also present the user with one or more options that allow the user to quickly access relevant customization features. For example, if the interface has made an alterable decision to automatically convert a numeral to an exponent, then when the interface displays a menu of options for that alterable decision, the interface may include an additional menu option such as “Stop Automatically Creating Exponents.”

In an embodiment, if a user performs the touch gesture that invokes an alteration menu at a location that is the location of more than one overlapping alterable block, then the interface will display an alteration menu for only the most relevant alterable interface decision that has an alterable block that the user thus touched. In an alternative embodiment, if a user performs the touch gesture that invokes an alteration menu at a location that is the location of more than one overlapping alterable block, then the interface will display a combined alteration menu that includes the options of each alterable interface decision that has an alterable block that the user thus touched, optionally with dividers between any adjacent options that are options of different alterable interface decisions. In another alternative embodiment, if a user performs the touch gesture that invokes an alteration menu at a location that is the location of more than one overlapping alterable block, then the interface will simultaneously display one alteration menu for each alterable interface decision that has an alterable block that the user thus touched; if the user selects an option from any of these menus, the interface will close all of these menus.

In an embodiment, an alteration menu may also include options that do not pertain to alterable interface decisions. In an embodiment, the touch gesture that invokes an alteration menu may also cause some other menu or menus to appear along with the alteration menu. Such a behavior may be desirable if an interface designer wishes to enable a user to easily access alteration menus and also wishes to enable a user to easily access certain other menu options that are unrelated to alteration functionality. For example, in an embodiment, right-clicking an alterable block will simultaneously invoke an alteration menu that appears above the alterable block and also a menu of formatting options that appears below the alterable block.

### Presenting Numerous Options Via Menu

In an embodiment, when the interface alters an alterable interface decision, if that decision has more than a certain threshold quantity of alternate options that have not been selected yet, then rather than replacing the selected option with an alternate option that has not been selected yet, the interface will display a menu of alternate options that have not been selected yet for that interface decision. For example, in an embodiment, if a user actuates the alteration key when the currently alterable decision has 10 alternate options, then the interface will open a menu of brief text descriptions of these 10 alternate options. In such an embodiment, when an alterable decision has numerous options, a user will not need to cycle through all the other options individually in order to reach the last option, and when an alterable decision does not have numerous options, a user will be able to alter the decision quickly without using a menu.

In an alternative embodiment, when the interface alters an alterable interface decision, if that decision has more than a certain number of alternate options that have not been selected yet, the interface will count the number of alternate options that have not been selected yet that have nearly as high a probability of alteration as the option that would be selected next: that is, the interface will calculate a threshold probability of alteration that is a certain amount lower than the probability of alteration of the option that would be selected next, and then the interface will count the number of alternate options that have not been selected yet that have a probability of alteration that is above this threshold probability. If the number of such alternate options is more than a certain threshold quantity, then rather than replacing the selected option with the next alternate option that has not been selected yet, the interface will display a menu of alternate options that have not been selected yet for that interface decision. (Such a menu may include alternate options that have not been selected yet that are below the threshold probability.) If however the number of such alternate options is less than the threshold quantity, then the interface will replace the currently selected option with the next alternate option as usual. For example, in an embodiment, if a particular alterable interface decision has one alternate option with a high probability of alteration and 10 alternate options with a low probability of alteration, then the first time the interface alters that decision it will replace the decision's default option with the alternate option that has a high probability of alteration, and the second time the interface alters that decision it will open a menu of brief text descriptions of the other 10 alternate options.

In an embodiment, when the interface displays a menu of all the alternate options that have not been selected yet as described in either of the two preceding paragraphs, if the user then performs a gesture that would cause the interface to alter the same decision again if this menu were not open, then the interface will close this menu; the user has then “completed review” of that alterable interface decision. For example, in an embodiment, if the user actuates the alteration key twice consecutively when the currently alterable decision has 10 alternate options with approximately equal probabilities of alteration, then the first actuation of the alteration key will cause the interface to open a menu of brief text descriptions of these 10 alternate options, and the next actuation of the alteration key will cause the interface to close this menu; the user has then completed review of that alterable interface decision, so a different decision may become the currently alterable decision.

### Holding a Touch to Invoke a Menu

In an embodiment, if a user invokes the touch alteration feature by touching a highlighted alterable block and continues to hold the touch for at least a certain specific length of time, then the interface will display a menu of options for the decision that was just altered.

In an embodiment, when holding a touch causes the interface to display a menu of options of an alterable interface decision, the menu will include every option of that decision, including the option that is currently selected, and the option that is currently selected will be displayed in a manner that is distinct from the other options. In an alternative embodiment, when holding a touch causes the interface to display a menu of options of an alterable interface decision, the menu will not include the option that is currently selected.

In an embodiment, when holding a touch that invoked the touch alteration feature causes the interface to display a menu of options of an alterable interface decision, the touch alteration that just occurred will be undone (and so such a menu need not necessarily include the default option). In an alternative embodiment, when holding a touch that invoked the touch alteration feature causes the interface to display a menu of options of an alterable interface decision, the touch alteration that just occurred will not be undone (and so such a menu need not necessarily include the option that became selected when the touch alteration feature was invoked).

### Menu-Based Alteration in Perspective

In various prior art interfaces, in certain circumstances a user can correct a word entry mistake or an undesired autocorrection by means of first performing an action that causes a menu of one or more correction options to pop up and then selecting the desired outcome from the menu. For example, on a prior art iPhone, if the iPhone performs an undesired autocorrection, in certain circumstances a user can correct the undesired autocorrection by means of first backspacing so that the input cursor is immediately after the word that was autocorrected, thus causing the interface to display a small flag menu that includes at least the word the user originally typed, and then touching the word the user originally typed.

In an embodiment that has other means of altering alterable decisions (such as the alteration key or the touch alteration feature), an alteration menu may be a relatively inefficient means of altering an alterable decision in most circumstances. Nevertheless, even in an embodiment that has other means of altering alterable decisions, an alteration menu may be the most convenient means of altering an alterable decision in certain circumstances, such as when an alterable decision has numerous alternate options, as is described above.

An embodiment that has other means of altering alterable decisions in addition to or instead of alteration menus may be more advantageous than an embodiment that has only alteration menus. Nevertheless, in various ways, an embodiment that has alteration menus but does not have other means of altering alterable decisions may still have significant advantages over prior art. For example, in an embodiment that has alteration menus and that has many types of alterable decisions that do not pertain to word entry mistakes or undesired autocorrections, there may be many more circumstances than in prior art wherein a user can quickly recover from a mistake by means of first invoking a menu and then selecting the desired outcome from the menu.

### Chapter 9: Additional Controls

### Additional Alteration-Related Keys

In various embodiments, various keys that are referred to herein may have various labels. For example, an alteration key as described in Chapter 2 may be labeled “Alter” or may instead be labeled “Oops” or something else. A Yes key as described below may be labeled “Yes” or may instead be labeled “Okay” or something else. Various other possible labels for various keys will be evident to those of ordinary skill in the art.

The Yes key, the No key, and the Not That key that are described below are “alteration-cycle-related keys” for purposes of interface behaviors that are described in Chapter 2. Below, in each explanation of how the interface will respond to an actuation of one of these three alteration-cycle-related keys, it is assumed that a currently alterable decision exists when the key is actuated. In an embodiment, if a user actuates any of these three alteration-cycle-related keys when there is no currently alterable decision, then that key actuation will have no effect.

In the following paragraphs, when the interface is said to “explicitly select” an option of an alterable interface decision, this means that the interface selects that option, and that this counts as explicitly selecting that option (so, in an embodiment, the interface drastically decreases the decision's probability of alteration); additionally, after the interface “explicitly selects” any option of the currently alterable decision, the interface moves on to the next decision in the alteration cycle. (When the interface moves on to the next decision in the alteration cycle, this usually means that a new alterable decision becomes the currently alterable decision if possible; the interface behavior that constitutes “moving on to the next decision in the alteration cycle” is explained in more detail in Chapter 2.)

In an embodiment, the computing device has a Yes key such that when the Yes key is actuated, the interface explicitly selects whatever option of the currently alterable decision was already selected, and so the interface moves on to the next decision in the alteration cycle. When a user wishes to alter a particular alterable interface decision, such a Yes key will not necessarily enable the user to achieve any result that could not have been achieved by means of the alteration key, but may enable the user to achieve a desired result faster than the result could have been achieved by means of the alteration key alone. For example, in an embodiment, if a user wishes to alter a particular alterable decision when one other alterable decision is more relevant and is thus the currently alterable decision, then to achieve the desired result, the user may actuate the Yes key once to accept the currently selected outcome of the more relevant decision so that the less relevant decision becomes the currently alterable decision, and then actuate the alteration key once to alter the less relevant decision, for a total of two key actuations. To achieve the same result by means of the alteration key alone, the user would have to actuate the alteration key at least twice to complete review of the more relevant decision, and then actuate the alteration key once to alter the less relevant decision, for a total of at least three key actuations.

In an embodiment, as an exception, when the Yes key is actuated, if a multi-click block is highlighted, then actuating the Yes key does not cause the interface to explicitly select the currently selected option of the currently alterable decision. Instead, in such circumstances, actuating the Yes key has no effect other than to naturally cause the multi-click block to no longer be highlighted (because an immediately subsequent actuation of the relevant multi-click key would no longer constitute a consecutive actuation of that key). Thus, in such an embodiment, when a multi-click block is highlighted, a first actuation of the Yes key will cause that highlighted multi-click block to no longer be highlighted, and then if the user continues to consecutively actuate the Yes key, subsequent actuations of the Yes key may cause the interface to explicitly select options of alterable interface decisions, which may thus cause highlighted alterable blocks to no longer be highlighted.

In an embodiment, the computing device has a Yes to All key such that when the Yes to All key is actuated, the interface explicitly selects the currently selected option of every highlighted alterable decision. Thus, in an embodiment where alterable decisions are highlighted only when their probability of alteration is above a certain highlighting threshold, and where explicitly selecting an option of an alterable decision decreases its probability of alteration enough that it certainly will not be above the highlighting threshold, after a user actuates the Yes to All key, no alterable decisions will be highlighted. In an embodiment, actuating the Yes to All key while the interface is in alterable decision review mode will also cause the interface to exit alterable decision review mode. In an embodiment, the Yes to All key is not actually an independent key on a hardware keyboard, but is instead a key combination that is actuated by some particular means, such as, in an embodiment, by holding down a particular modifier key such as Ctrl while pressing the Yes key.

In an embodiment, the computing device has a No key such that when the No key is actuated, if the currently selected option of the currently alterable decision is not its default option, then the interface will explicitly select the default option of the currently alterable decision. In an embodiment, when the No key is actuated, if the currently selected option of the currently alterable decision is its default option, then that actuation of the No key will have no effect; in an alternative embodiment, when the No key is actuated, if the currently selected option of the currently alterable decision is its default option, then the interface will alter that decision as though the user had actuated the alteration key.

In an embodiment, when the Escape key is actuated, if the currently selected option of the currently alterable decision is not its default option, then the interface will explicitly select the default option of the currently alterable decision, and in other circumstances the Escape key may have its other usual effects. (In such an embodiment, the Escape key thus serves a similar purpose to the No key that is described in the preceding paragraph, so it may be redundant for such an embodiment to also have a No key.)

In an alternative embodiment, instead of or in addition to the No key that is described above, the computing device has a Not That key such that when the Not That key is actuated, if the currently selected option of the currently alterable decision is its default option, then the interface will alter that decision; if not, then the interface will first explicitly select the default option of the currently alterable decision (as though the user had actuated the No key as described above) and will then alter the new currently alterable decision if it is a different decision than the one whose default option the interface just explicitly selected. For example, in such an embodiment, if the interface has made two alterable decisions and a user actuates the alteration key but this does not alter the particular decision that the user intended to alter, the user may then be able to achieve the desired result by a single actuation of the Not That key, which will both undo the alteration of the decision that the user did not intend to alter and also alter the decision that the user did intend to alter.

In an alternative embodiment, when the Escape key is actuated, if this actuation does not yield some other effect that does not pertain to alteration functionality and if there is a currently alterable decision, then the interface will explicitly select the default option of the currently alterable decision, whether or not that option was already selected. In other words, in such an embodiment, the Escape key may cancel an alteration that just occurred in the same way as the No key described above, and also, whenever the default option of the currently alterable decision is selected, the Escape key may indicate acceptance of that option in the same way as the Yes key described above. Also, in an embodiment, when the Enter key is actuated, if there is a currently alterable decision and the currently selected option of that decision is not its default option, then the interface will explicitly select the currently selected option of that decision. In other words, in such an embodiment, whenever an alternate option of the currently alterable decision is selected, the Enter key may indicate acceptance of that option in the same way as the Yes key described above. An embodiment where the Escape key and the Enter key both function as described in the present paragraph may have advantages that are similar to the advantages of an embodiment that has a Yes key and a No key, without the need to add additional keys to the interface. However, such an embodiment also has the disadvantage that a user may sometimes need an additional keystroke in order to simply alter the currently alterable decision and resume working: in particular, if a user wishes to first alter the currently alterable decision by some means and then advance to the next line by means of pressing Enter, then an actuation of the alteration key followed by a single actuation of the Enter key will not achieve the desired result, because the interface will treat that actuation of the Enter key as an alteration-related action and so will not yet advance to the next line.

In an embodiment, the computing device has an Emphatic Alteration key, an Emphatic Yes key, and/or an Emphatic No key. In an embodiment, such “keys” are not actually independent keys on a hardware keyboard; for example, in an embodiment, holding down the Shift key or some other similar modifier key while pressing the alteration key, Yes key, or No key will cause that key to instead serve as the emphatic version of that key. In an embodiment, each such emphatic alteration-related key has the same effect as the non-emphatic version of the key, but also informs the interface that the user has an emphatic preference so that the interface can adapt its behavior in order to better suit the user's preference, as is described in Chapter 21.

### Additional Undo-Related Keys

In an embodiment, the interface has various additional keys that enable a user to navigate through the history of actions in an undo buffer by various means. In particular, in an embodiment, the interface has an Undo Rewind key, a Redo Play key, and an Undo Stop key, When a user actuates the Undo Rewind key, the interface will enter “undo rewind mode,” which means that it will undo one action at a time at a certain rate until the user performs some other action. When a user actuates the Redo Play key, the interface will enter “redo play mode,” which means that it will redo one action at a time at a certain rate until the user performs some other action. The Undo Stop key will have no effect other than to cause the interface to exit undo rewind mode or redo play mode.

In an embodiment, while the interface is in undo rewind mode or redo play mode, the undo changes that occur are animated. In an embodiment, different changes may take different amounts of time to occur, so that for example if the interface undoes a single action that deleted a large portion of text, and so a large portion of text reappears, then the interface will take longer than usual before undoing the next action, so that the user has a little extra time to review what just happened.

In an embodiment, the speed at which the interface traverses actions while in undo rewind mode or redo play mode can be adjusted by some means. For example, in an embodiment, repeatedly actuating the Undo Rewind key will increase the speed at which the interface rewinds, until the interface reaches a certain maximum speed or the user performs some other action.

### Additional Autocorrection-Related Keys

In an embodiment, when an autocorrection change or optional interpolation is pending, the Yes and No keys do not function as alteration-related keys as described above, but instead behave as described in the following paragraphs.

In an embodiment, when a user actuates the Yes key, if there is a pending autocorrection change or pending optional interpolation, then the interface will perform that autocorrection change or that interpolation immediately. In an embodiment, when a user actuates the right arrow key, if the input cursor is at the end of the user's input so the actuation of the right arrow key cannot have its usual effect of moving the input cursor one character to the right within the user's input, and if there is a pending autocorrection change or pending optional interpolation, then the interface will perform that autocorrection change or that optional interpolation immediately.

In an embodiment, when a user actuates the No key or the Escape key or the Delete key, if there is a pending autocorrection change or pending optional interpolation, then the interface will cancel that autocorrection change or optional interpolation so that it is no longer pending.

For example, in an embodiment, when a user has typed “tuesday” and has not yet pressed the space bar or any other key, pressing the space bar would trigger an autocorrection that would change “tuesday” to “Tuesday,” so that particular autocorrection change is a pending autocorrection change. If the user does press the space bar, the interface will change “tuesday” to “Tuesday” and then append a space character. If instead the user presses the Yes key, the interface will change “tuesday” to “Tuesday” without appending a space character. If instead the user presses the No key, the interface will cancel that autocorrection change, so if the user then presses the space bar the interface will append a space character without changing “tuesday” to “Tuesday.”

### Situational Control Panels

In an embodiment, in certain circumstances the interface will display a “situational control panel” that includes controls that are particularly relevant in those circumstances. For example, after a user actuates the Undo key once, the interface may display an undo control panel that includes an Undo button; this may be especially advantageous on a smartphone or other computing device where an Undo key actuation ordinarily takes longer than most other key actuations.

In an embodiment, situational control panels will have a standard location, so that for example the location where an alteration control panel is sometimes visible is the same location where an undo control panel is sometimes visible. In an embodiment, this location is a location where an autocorrection bar is sometimes visible, such as immediately above a virtual keyboard. In an alternative embodiment, this location is at the very top or very bottom of the screen. In another alternative embodiment, this location is a touch bar virtual keyboard zone at the top of a hardware keyboard. Other possible locations for situational control panels will be evident to those of ordinary skill in the art.

In an embodiment, a situational control panel will have a small X on its right edge such that touching or clicking this X will cause the situational control panel to disappear.

In an embodiment, a situational control panel may have near its right edge a right arrow or other button such that touching or clicking the button will cause the interface to scroll the situational control panel so that different buttons come into view; if this happens, then a left arrow or other button will appear on the left edge to enable scrolling back to the set of buttons that were originally in view.

In an embodiment, when the interface enters alterable decision review mode, the interface will display an “alteration control panel” that is a situational control panel that includes one or more virtual alteration-related buttons that a user can click or touch. In an embodiment, such buttons include the alteration key, No key, Yes key, Yes to All key, and Emphatic Yes key. In an embodiment, when the interface exits alterable decision review mode, such a situational control panel will disappear. For example, in an embodiment, if a user is extremely displeased by the outcome of a particular interface decision, and that decision is the only highlighted alterable decision, the user can cause the interface to enter alterable decision review mode, then press the alteration key, and then press the Emphatic Yes key upon arriving at the desired result.

In an embodiment, when the user's last action was an actuation of the Undo key or Redo key or any other key pertaining to undo functionality, the interface will display an “undo control panel” that is a situational control panel that includes one or more virtual undo-related buttons. In an embodiment, such buttons include the Undo key, Redo key, Undo Rewind key, Redo Play key, and Undo Stop key. In an embodiment, to save space, such keys are labeled with appropriate icons instead of words. In an embodiment, when the user performs any action that does not pertain to undo functionality, such a situational control panel will disappear.

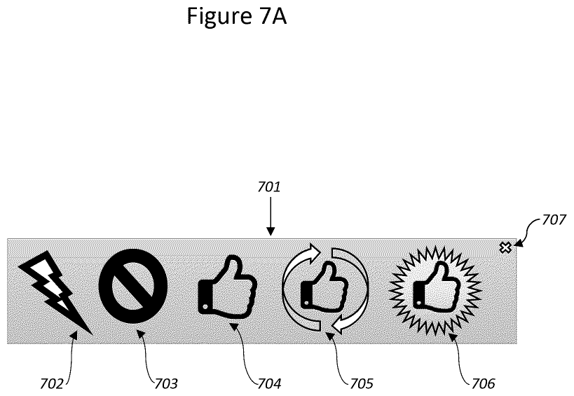

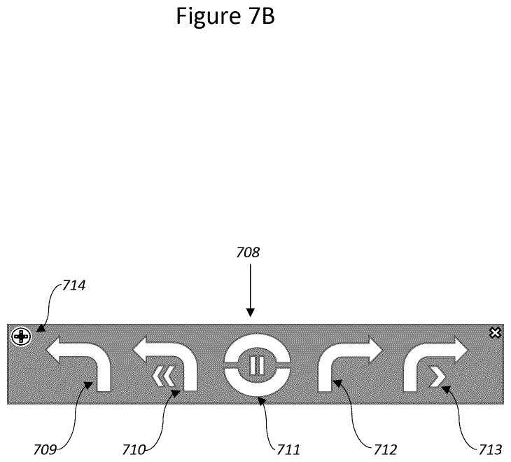

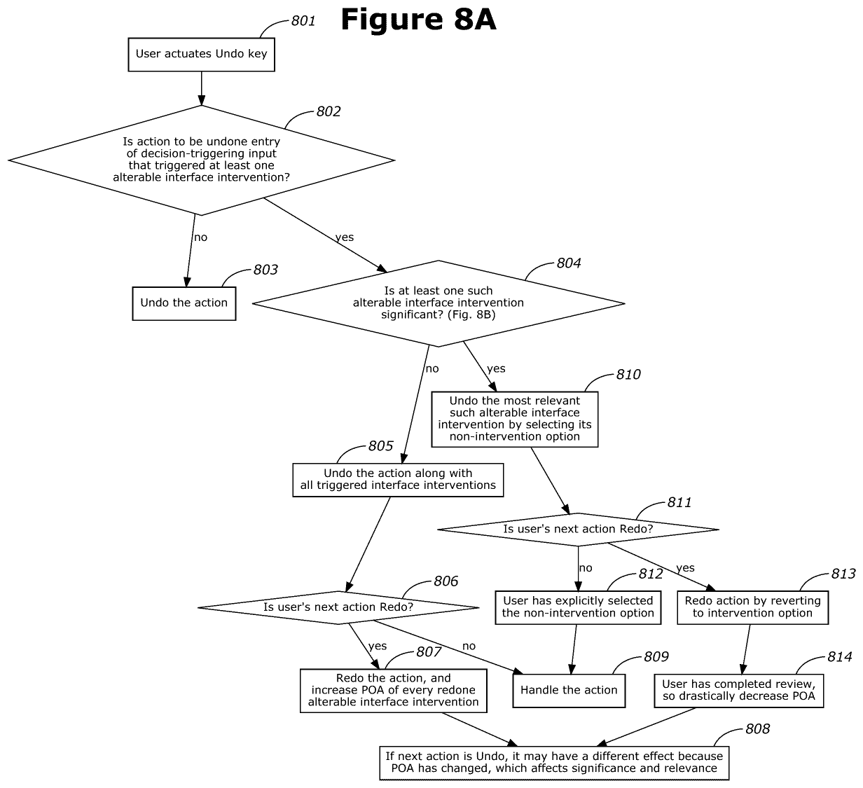

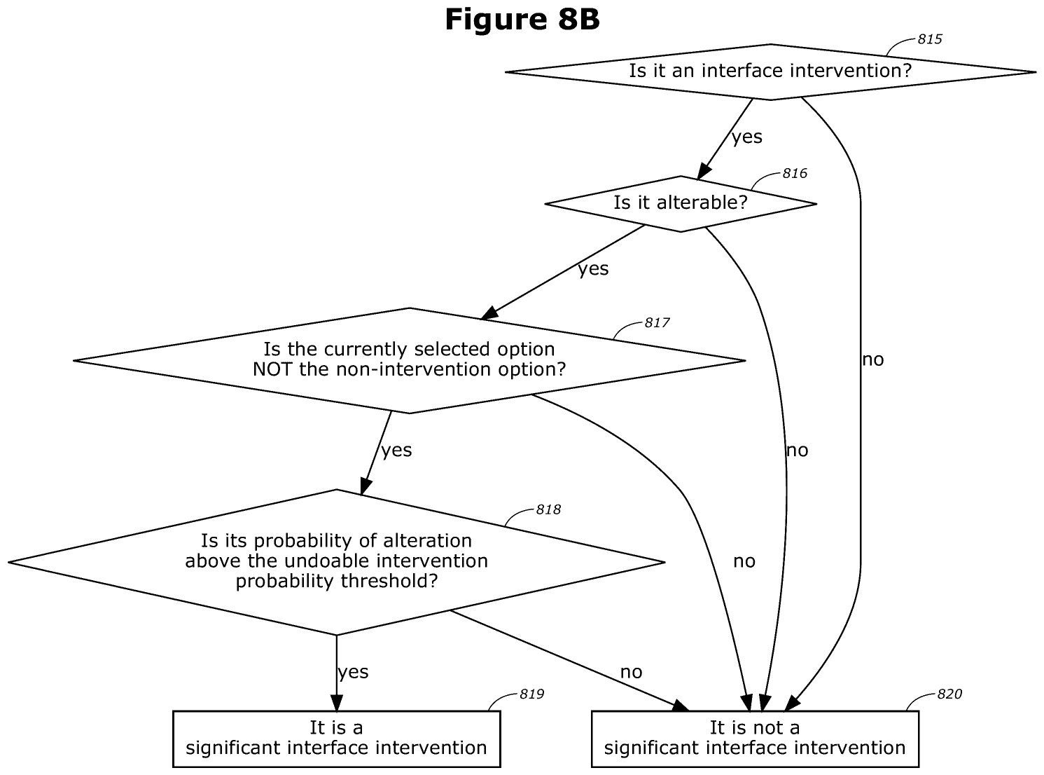

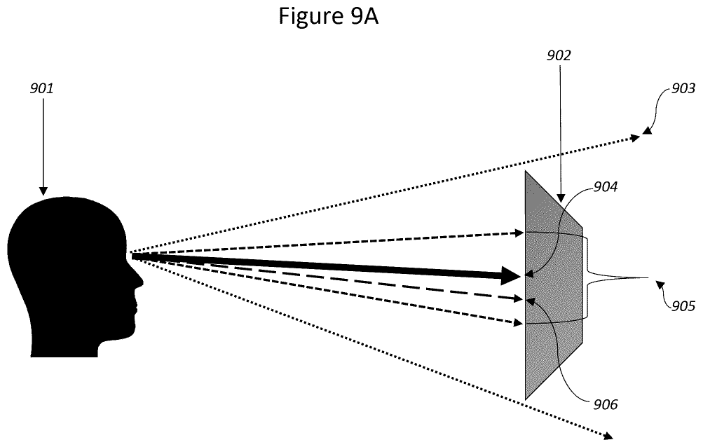

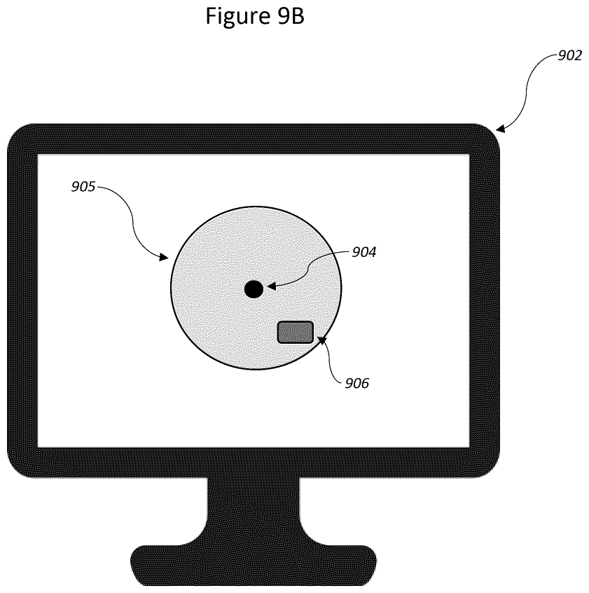

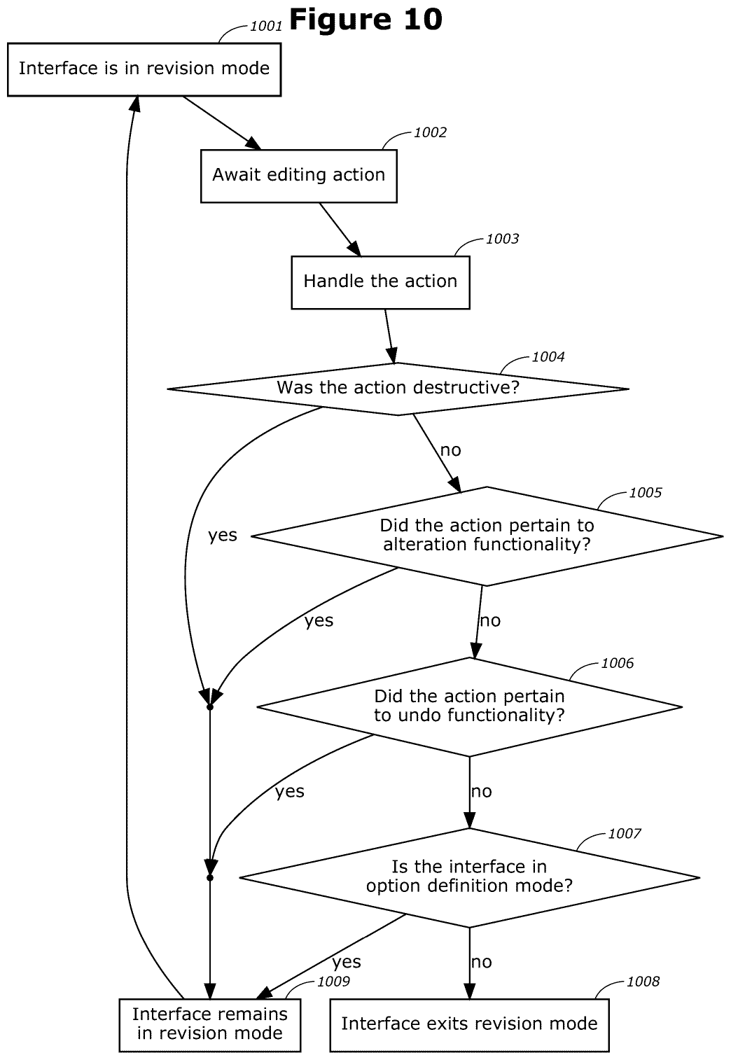

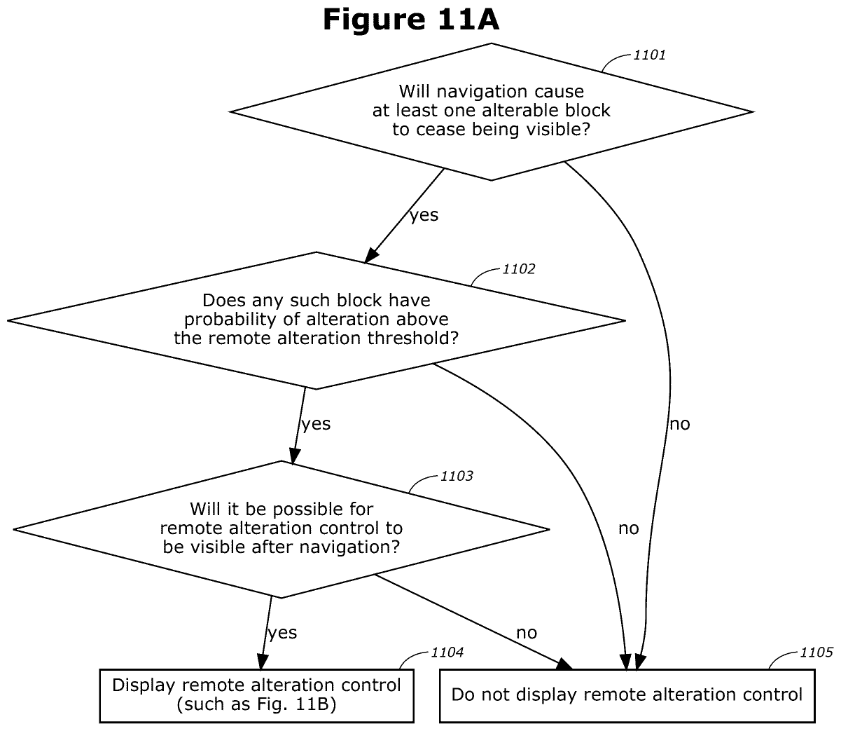

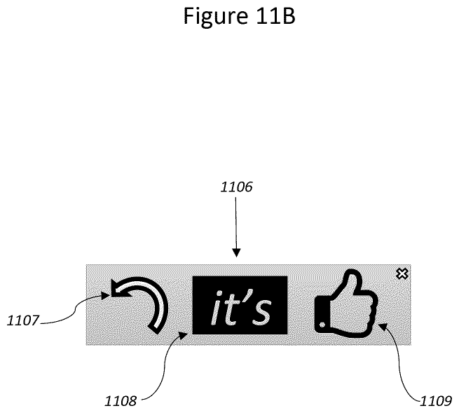

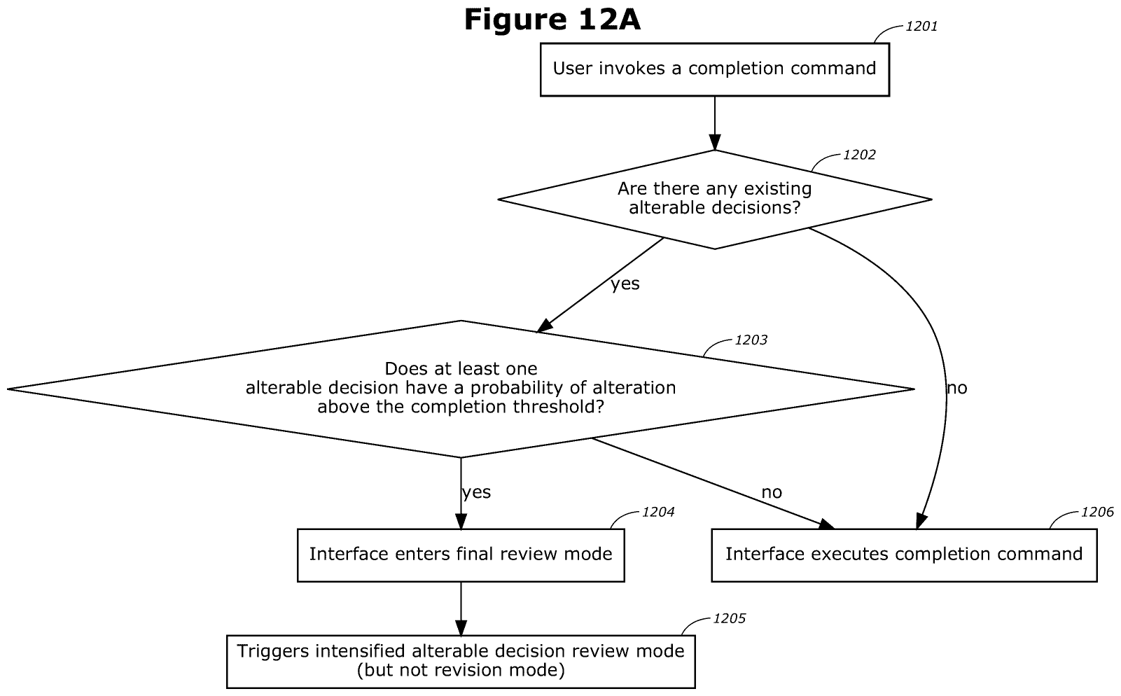

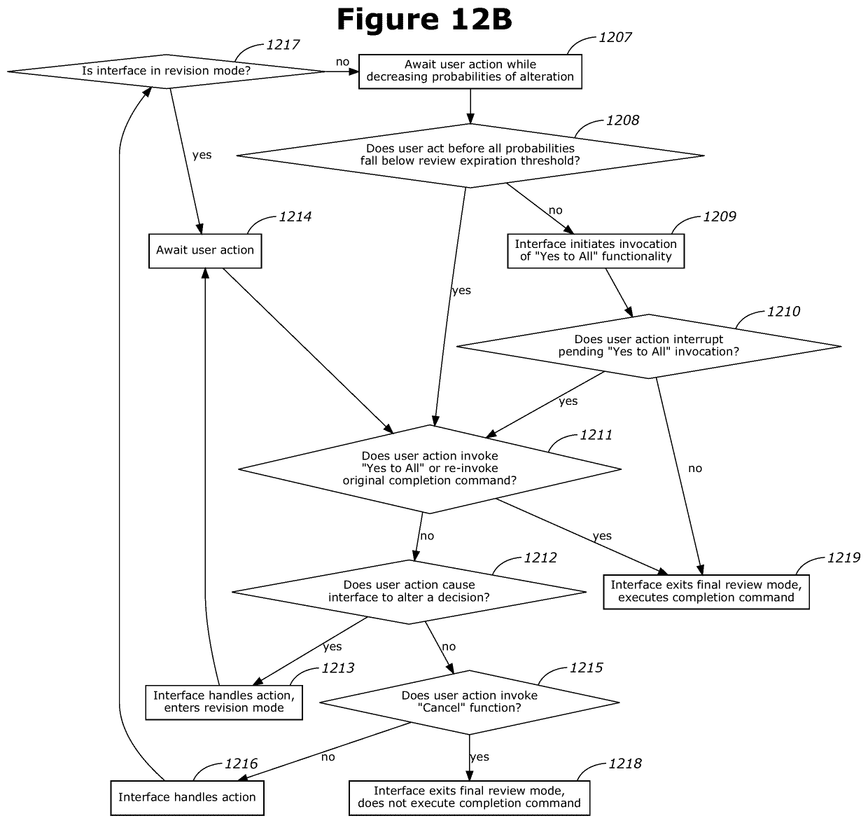

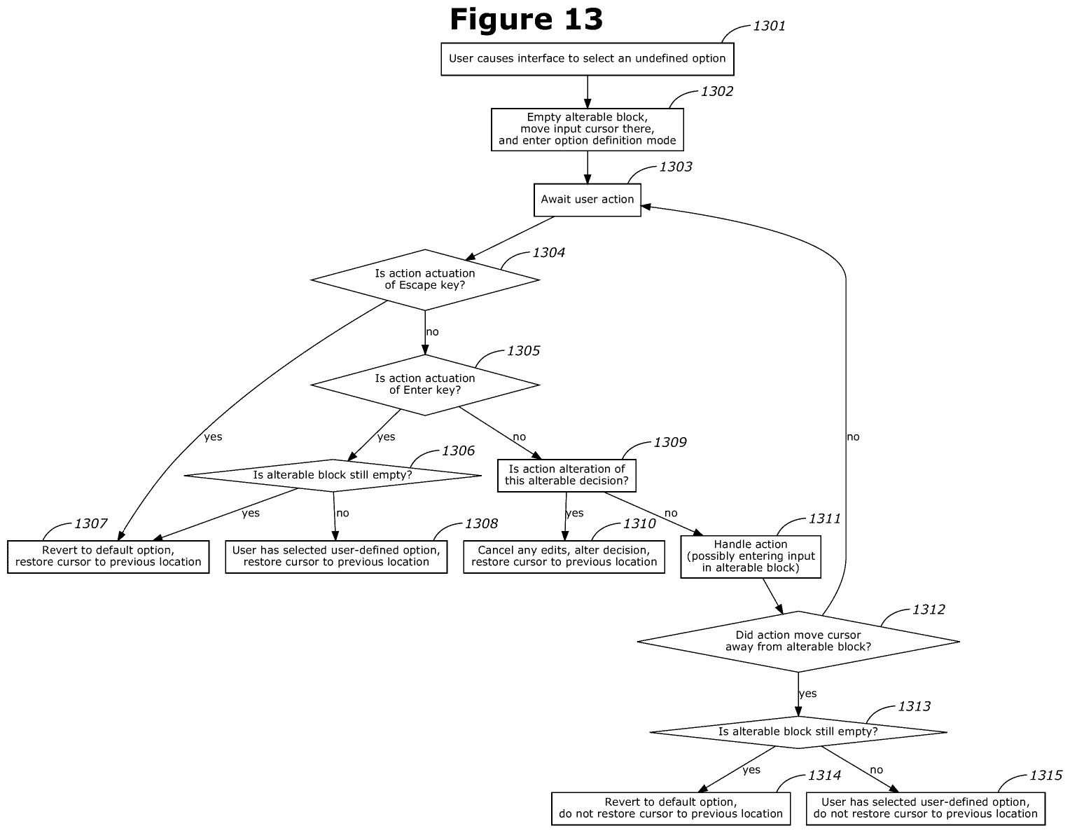

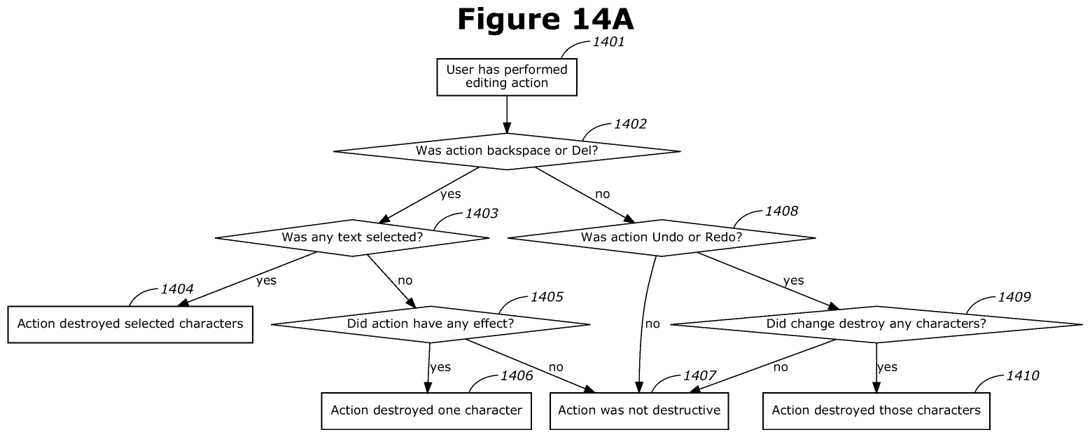

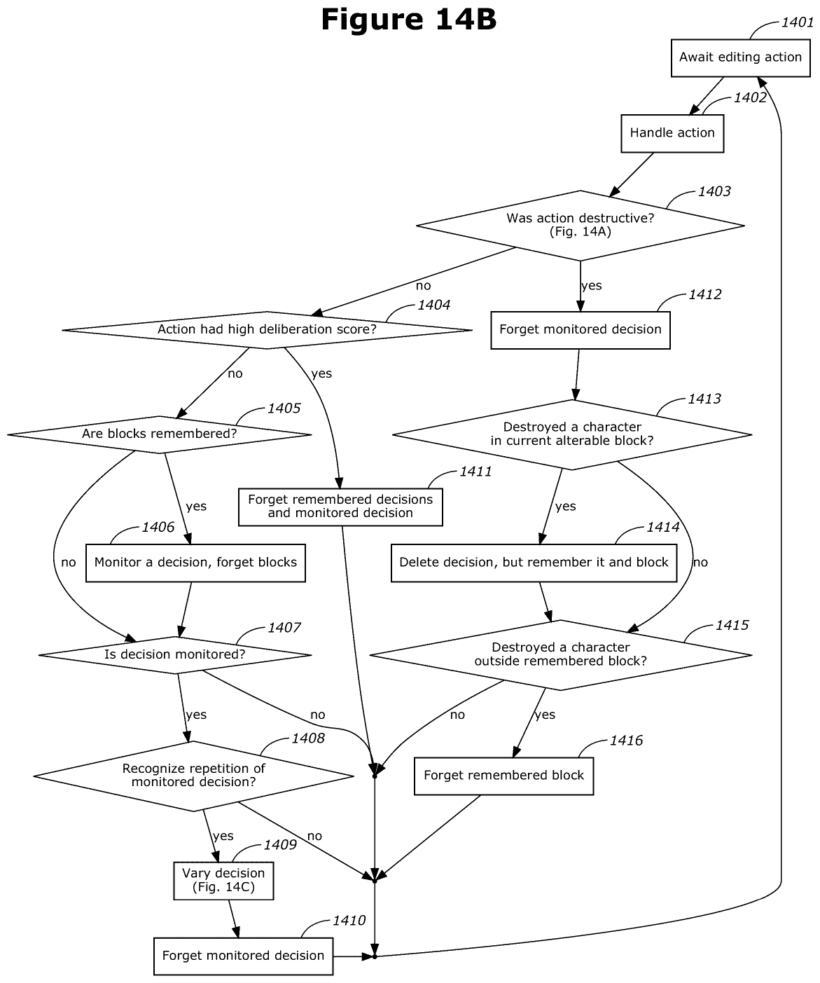

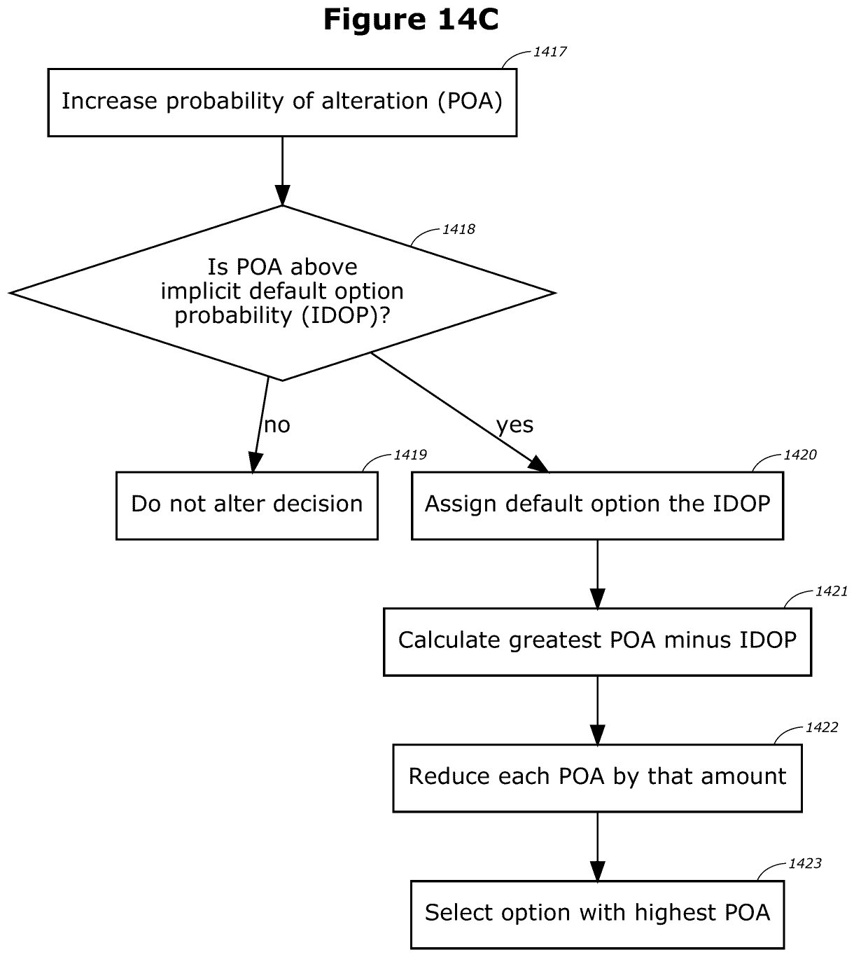

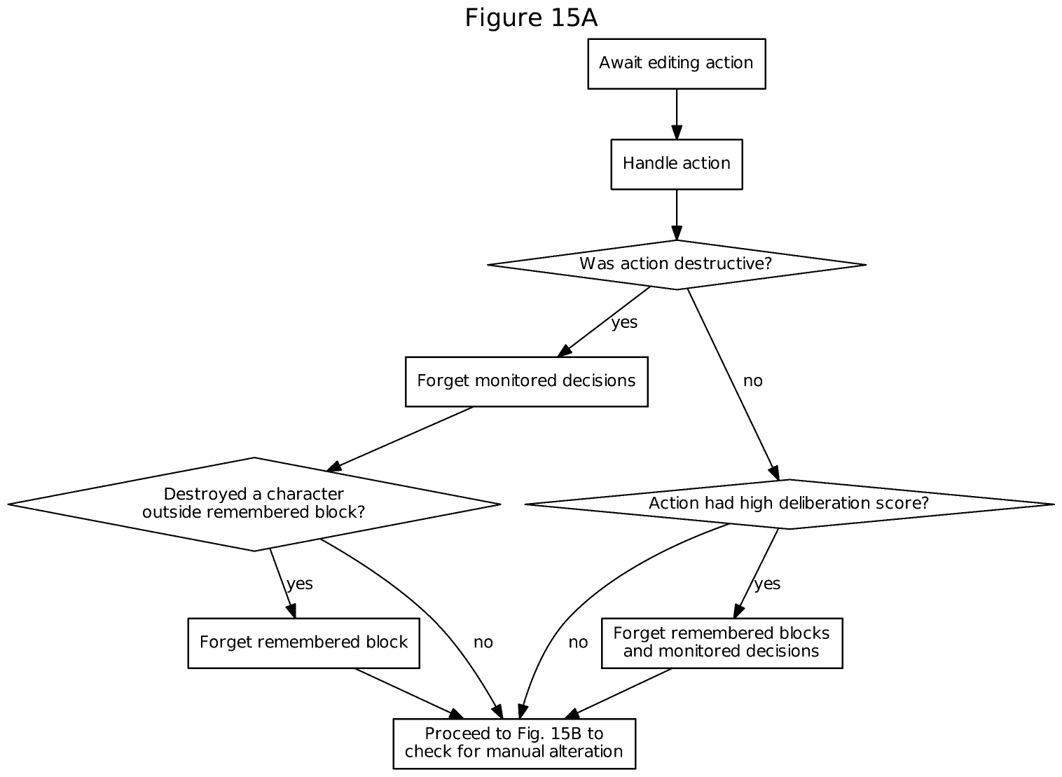

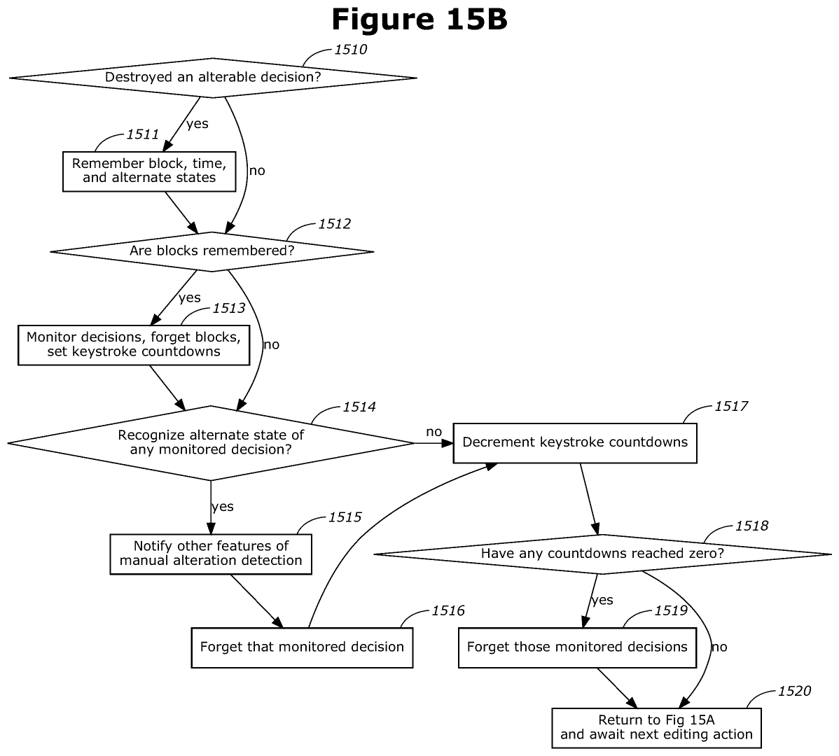

FIG. 7A shows an alteration control panel (701) with buttons that use icons instead of words to indicate their functions, including an alteration key button (702), a No button (703), a Yes button (704), a Yes to All button (705), and an Emphatic Yes button (706), along with an X (707) in the upper right corner for closing the alteration control panel. FIG. 7B shows an undo control panel (708) featuring an Undo button (709), an Undo Rewind button (710), an Undo Stop button (711), a Redo button (712), a Redo Play button (713), and an Undo Scope button (714) which is explained in Chapter 11.

### Quick Alteration Buttons

In an embodiment, in certain circumstances the interface will display one or more “quick alteration buttons,” where each such button contains a description of an alternate option of an alterable interface decision, and pressing the button will cause the interface to explicitly select that option. Such a quick alteration button is thus very similar to a preview descriptor as described in Chapter 8, with the distinction that a preview descriptor will appear near the relevant alterable block when possible, whereas a quick alteration button will appear in a standard location, as is explained in the following paragraphs.

In an embodiment, when the interface displays quick alteration buttons that pertain to more than one highlighted alterable interface decision, the interface will not highlight all highlighted alterable blocks the same color, but will instead highlight each highlighted alterable block that is associated with a quick alteration button a different color, and will highlight each quick alteration button the same color as its associated highlighted alterable block, so that a user can discern what portion of input each quick alteration button pertains to by finding the portion of input that is highlighted the same color as the button.

In an embodiment, when quick alteration buttons pertaining to multiple alterable decisions are displayed in the same row of buttons, the quick alteration buttons will be arranged from right to left with buttons that pertain to more relevant alterable decisions on the right and buttons that pertain to less relevant alterable decisions on the left. For example, in an embodiment, if the interface has made two alterable decisions, including an alterable decision with the alternate option “its” that has a high probability of alteration and including an alterable decision with the alternate option “tuesday” that has a low probability of alteration, then if a quick alteration button for each of these decisions is displayed in the same row of buttons, the “its” button will be displayed to the right of the “tuesday” button.

In an embodiment, whenever an alteration control panel as described above is visible, in addition to buttons such as the alteration key, No key, and so forth, the alteration control panel will include quick alteration buttons for some or all alternate options of highlighted alterable decisions, if any highlighted alterable decisions exist. (If the alteration control panel is scrollable, it may include indefinitely many quick alteration buttons.)

In an embodiment, whenever a highlighted alterable decision exists, a certain region of the display of the computing device will have one or more quick alteration buttons if sufficient space is available in that region. In particular, in an embodiment, if the computing device has a hardware keyboard that has a touch bar virtual keyboard zone at the top, then whenever a highlighted alterable decision exists, this touch bar will include one or more quick alteration buttons, unless the touch bar does not have room available (such as because it is already full of other virtual keys).

Quick alteration buttons as described above may be advantageous in certain circumstances even in an embodiment that has other means of quickly altering alterable interface decisions. However, because it may be extremely advantageous for a user to be able to alter an alterable decision by means of a single quick action, quick alteration buttons may be especially desirable in an embodiment that lacks other means of quickly altering alterable interface decisions.

### Currently Alterable Decision Highlight Navigation

In an embodiment, while a user holds down the alteration key, the interface will enter alterable decision review mode at least until the user is no longer holding down the alteration key, so that a user can more easily see what decisions are alterable.

In an embodiment, when the currently alterable decision is highlighted distinctively, pressing an arrow key while holding down the alteration key may cause the interface to change which decision is the currently alterable decision. In particular, in an embodiment, in such circumstances, pressing the left arrow key while holding down the alteration key will cause the interface to find the alterable decision with an alterable block that precedes the alterable block of the currently alterable decision and is as near as possible to the alterable block of the currently alterable decision, and make that decision be the currently alterable decision; pressing the right arrow key while holding down the alteration key will cause the interface to find the nearest alterable decision that is after the currently alterable decision, and make that decision be the currently alterable decision; pressing the up arrow key while holding down the alteration key will have the same effect as pressing the left arrow key, except that it will skip any alterable decision whose alterable block is on the same line of input as the currently alterable decision; and pressing the down arrow key while holding down the alteration key will have the same effect as pressing the right arrow key, except that it will skip any alterable decision whose alterable block is on the same line of input as the currently alterable decision. In an embodiment, pressing an arrow key while holding down the alteration key will have no effect if it cannot have the effect described in the preceding sentence; for example, when there are no alterable decisions with alterable blocks that are after the alterable block of the currently alterable decision, pressing the right arrow key or down arrow key while holding down the alteration key will have no effect.

The interface behavior described in the preceding paragraph may be particularly desirable in an embodiment such as a graphing calculator that does not have a mouse or touch screen, because it enables a user to select a specific alterable decision to alter without clicking or touching an alterable block.

### Alteration Hotkeys

In an embodiment, one or more specific types of alterable interface decisions may be individually assigned specific alteration hotkeys, so that actuating such an alteration hotkey will cause the interface to alter an alterable interface decision of that particular type, if such an alterable interface decision exists. Such a hotkey may be a key combination. For example, in an embodiment, holding down the alteration key and then pressing the period key while the alteration key is held down will cause the interface to alter an alterable decision regarding whether or not to display a number in decimal form.

In an embodiment, one or more specific types of alterable interface decisions may be “hotkey-exclusive alterable decisions,” where a hotkey-exclusive alterable decision is an alterable decision that can only be altered by means of actuating an alteration hotkey, and thus cannot be altered by means of actuating the alteration key alone or by other ordinary means of altering interface decisions. One particular type of hotkey-exclusive alterable decision is described farther below.

### Chapter 19: Decision Function Optimization

### Decision Functions

In certain circumstances a prior art TI-84 Plus C Silver Edition graphing calculator running OS 4.0 will make a decision whether to display an answer in the form of a decimal or in the form of a fraction. The following paragraph explains when the TI-84 will decide to display an answer in the form of a decimal and when it will decide to display the answer in the form of a fraction. This particular decision serves as an example of a somewhat complex interface decision, and in the following discussion of interface decisions, any mention of “the example decision function” is a reference to the behavior that is described in the following paragraph.

The TI-84 Plus C Silver Edition has a mode settings screen with a line that says “ANSWERS: AUTO DEC FRAC-APPROX.” When this calculator makes a decision whether to display an answer as a decimal or as a fraction, if the selected ANSWERS mode setting is DEC, then the calculator will decide to display the answer as a decimal. If the selected setting is FRAC-APPROX, then the calculator will decide to display the answer as a fraction. If the selected setting is AUTO, then the calculator will decide to display the answer as a fraction if the problem for which the calculator is providing an answer includes a fraction, or as a decimal otherwise.

In the present specification, a “decision function” is a mapping of circumstances to decision outcomes: that is, a decision function specifies which outcome an interface will choose in any given circumstances. Any particular decision function can be implemented by means of various algorithms. For example, the decision function that is specified in the preceding paragraph could be implemented by an algorithm that as its first step checks the calculator's ANSWERS mode setting, and then if the setting is DEC chooses decimal form; or if the setting is FRAC-APPROX chooses fraction form; or if the setting is AUTO, as its second step checks whether the user's input included a fraction, and then chooses fraction form if the input included a fraction, or decimal form otherwise. However, the same decision function could instead be implemented by an algorithm that as is its first step checks whether the user's input included a fraction, and then if the input included a fraction, as its second step checks the calculator's ANSWERS mode setting and then chooses fraction form unless the setting is DEC; or if the input did not include a fraction, as its second step checks the calculator's ANSWERS mode setting, and chooses decimal form unless the setting is FRAC-APPROX. Throughout the present specification, if a decision function is specified by describing one particular algorithm that implements the decision function, it is to be understood that those of ordinary skill in the art may be able to construct other algorithms that implement the same decision function.

In the present specification, a “decision class” is the set of all decisions such that an interface will make the decisions by means of the same decision function. For example, some interfaces have a setting that determines whether or not the interface will automatically capitalize days of the week, so in such an interface, if a user types “sunday” on one occasion and the interface makes a decision whether or not to capitalize that word, and the user types “monday” on another occasion and the interface makes a decision whether or not to capitalize that word, both these decisions are made by means of the same function, which simply checks the same setting; both these decisions thus belong to the same decision class. In the present specification, an “alterable decision class” is a decision class such that the decisions are alterable decisions; a “threshold decision class” is a decision class such that the decisions are threshold decisions; and so forth. In the present specification, a decision class may be said to be the decision class of a certain decision function, and a decision function may be said to be the decision function of a certain decision class.

### Analyzing Decision Outcomes

In the present specification, an “optimizable decision” is any decision that an interface makes such that user behavior may later make it clear in retrospect whether the decision had a beneficial outcome or a non-beneficial outcome. For example, an interface's decision to automatically capitalize the word “tuesday” may be considered to have a non-beneficial outcome if the user immediately changes the word back to lowercase. When for some reason it is not possible to determine in retrospect whether an optimizable decision had a beneficial outcome or non-beneficial outcome, the decision may be considered to have had a neutral outcome. For example, an interface's decision to automatically capitalize the word “tuesday” may be considered to have a neutral outcome if the user immediately deletes the entire paragraph and closes the document.

A decision may be an optimizable decision as defined above even if the interface does not actually analyze the outcome of the decision. For example, when the prior art Microsoft Word interface decides whether or not to automatically capitalize the word “tuesday,” this decision is an optimizable decision even though Microsoft Word does not determine in retrospect whether or not the decision had a beneficial outcome. However, the decision adaptation functionality that is described below requires the interface to analyze the outcomes of optimizable decisions in order for them to be adaptive decisions (as defined below).

Below, it will generally be assumed that when the interface determines that a decision had a non-beneficial outcome, the interface will also determine what outcome would have been beneficial. In an embodiment, if somehow a decision has more than two possible outcomes and the interface determines that the initial outcome of the decision was non-beneficial but cannot determine which of the other outcomes would have been beneficial, then such a decision may be treated as having a neutral outcome rather than a non-beneficial outcome for purposes of decision adaptation.

In an embodiment, for any optimizable decision that is an alterable decision, the interface will consider the decision to have a beneficial outcome when its initial default option remains selected. The interface will consider the decision to have a non-beneficial outcome when any other option is selected, and will consider the option that is selected to be the outcome that would have been beneficial. The interface will consider the decision to have a neutral outcome if the alterable decision is deleted because the user deleted or manually modified a portion of its alterable block, except that if the alterable decision is deleted but subsequently the manual alteration feature recognizes manual alteration of the decision then this will be treated as though the user had altered the decision by means of alteration functionality, or if the alterable decision is deleted and then the automatic decision variation feature causes a matching alterable decision to be created then this matching alterable decision will be treated as the same decision for purposes of the decision adaptation feature and so the interface will no longer consider the decision to have a neutral outcome.

If a particular embodiment has the decision adaptation functionality that is described below, and analyzes the outcomes of optimizable decisions that are alterable decisions as described in the preceding paragraph, and has the manual alteration detection feature, then it may be quite advantageous for the embodiment to have a wide variety of optimizable decisions be “alterable decisions” whether or not the embodiment actually includes any features that facilitate altering such decisions, because this will make it easy to take advantage of decision adaptation functionality for such decisions.

### Optimizing Decisions

The process of improving the decision function for a particular interface decision class so that such decisions will be more likely to have beneficial outcomes will be referred to in the following discussion as “optimizing a decision.”

Optimizing decisions may be more advantageous for some embodiments of the present invention than for prior art interfaces. One reason is that some embodiments of the present invention can easily be configured to analyze the outcomes of a wide variety of optimizable decisions, as described above, which will make it easy to take advantage of decision adaptation functionality to optimize such decisions. Another reason is that some embodiments of the present invention may reduce the need for interface decisions to be simplistic. In prior art interfaces, if a user does not notice right away that an interface decision had a non-beneficial outcome, then the user will typically need to perform several actions in order to achieve the desired outcome and resume working. If an interface is very simple, then although the interface may make decisions that have non-beneficial outcomes, at least a typical user may soon understand the interface well enough to know when to look for a non-beneficial outcome, so the user will usually notice right away if an interface decision has a non-beneficial outcome. In some embodiments of the present invention, though, if a user does not notice right away that an interface decision had a non-beneficial outcome, the user may nevertheless be able to achieve the desired outcome with just a single keystroke or single touch gesture. For that reason, it may be unnecessary for the interface to be very simple: a typical user may not care very much whether it is possible to understand the interface well enough to know when to look for a non-beneficial outcome. Instead, it may be more desirable for the interface to make decisions that have beneficial outcomes as often as possible, even if this means that the user may not know when to look for the occasional non-beneficial outcomes. In other words, an interface can be more aggressively helpful when its inevitable mistakes are unlikely to cause much inconvenience.

To optimize a particular interface decision class, an interface designer may cause the interface to take past decision outcomes into account when making the decision, or may cause the interface to take immediate context into account when making the decision, or both. Causing the interface to take past decisions outcomes into account when making a decision will be referred to herein as “making a decision adaptive,” and causing the interface to take current context into account or causing it to do so in a more sophisticated way will be referred to as “making a decision smarter.”

Below, the present specification will explain how to divide an interface decision class that has more than two possible outcomes into component decision classes, because it may be easier to optimize such component decisions individually. Next, the present specification will explain a generalized approach for making decisions adaptive. After that, the present specification will discuss some generally applicable principles for making decisions smarter. After that, the present specification will discuss some ways that adaptation behavior can be customized, so that for example the interface may be quicker to adjust the behavior of some decision classes than other decision classes. After that, the present specification will discuss customization of entire alteration-related features (such as the automatic decision variation feature), as opposed to individual decision classes.

### Composite Decisions

In some cases, even if an interface decision that has more than two possible outcomes appears to the user to be a single interface decision, the interface may actually make the decision by dividing it into component decisions and making those decisions sequentially. Any decision that is divided into component decisions may be referred to herein as a “composite decision.”

As an example, consider an interface decision class regarding whether to display an answer to a calculation as a decimal, proper fraction, improper fraction, or mixed fraction. This decision class will be referred to as “the example composite decision class.” This composite decision class may be divided into three component decisions. To decide what form to display a particular answer in, first, the interface will make a component decision whether to display the answer as a decimal or as a fraction. If the interface decides to display the answer as a fraction, then the interface will make a component decision whether or not to display the answer as a proper fraction. If the interface decides not to display the answer as a proper fraction, then the interface will make a component decision whether to display the answer as an improper fraction or as a mixed fraction.

In terms of graph theory, a composite decision can be represented as a tree structure that has more than one internal node, where each internal node represents a component decision and each leaf represents an outcome of the composite decision. When the example composite decision class is represented as a tree, its root node represents the first component decision. The root node has two children: one is a leaf that represents the decimal outcome, and the other is an internal node that represents the second component decision. The node representing the second component decision has two children: one is a leaf that represents the proper fraction outcome, and the other is an internal node that represents the third component decision. The node representing the third component decision also has two children: one is a leaf that represents the improper fraction outcome, and the other is a leaf the represents the mixed fraction outcome.

In some cases, certain outcomes of a decision class will be possible outcomes for some decisions of that class but not for other decisions of that class. In the present specification, an “unavailable outcome” is an outcome that is not possible for a particular decision but would be possible for certain other decisions of the same decision class; an “available outcome” is an outcome that is possible for a particular decision. For example, for the example composite decision class, when a particular answer equals 0.5 it is not possible to display that answer as an improper fraction, so the outcome of displaying the answer as an improper fraction is then an unavailable outcome; in such circumstances, the outcome of displaying the answer as a mixed fraction is also an unavailable outcome. When an answer equals 1.5, the improper fraction outcome and the mixed fraction outcome are available outcomes, but the proper fraction outcome is an unavailable outcome. When an answer equals \sqrt{2}, only the decimal outcome is available.

In the following discussion of composite decisions, a “decision path” is a possible sequence of individual outcomes of component decisions that leads to an outcome of the composite decision. When a composite decision is represented as a tree structure, each path from the root node to a leaf thus represents a decision path. For a particular decision, an “available decision path” is a decision path such that each outcome of a component decision is an available outcome for that component decision.

When a composite decision is an alterable decision, in order to determine what outcomes are available, the interface can either determine every available outcome directly, or it can systematically traverse every available decision path in order to determine every available outcome. For example, for the example composite decision class, the interface can directly figure out which outcomes will be available for a particular answer based on the value of the answer. Alternatively, the interface can first check which outcomes of the first component decision are available outcomes; then if the fraction outcome is available, check which outcomes of the second component decision are available; then if the outcome of not displaying the answer as a proper fraction is available, check which outcomes of the third component decision are available.

When a composite decision is an alterable decision, in order to assign probabilities of alteration to the various alternate options, the interface can assign probabilities of alteration directly, or alternatively, if the interface assigns probabilities of alteration to the outcomes of the individual component decisions, then the interface can calculate the probabilities of alteration of the alternate options of the composite decision by treating each possible outcome of the composite decision as a combination of outcomes of the component decisions along the relevant decision path, and calculating the probability of that combination of outcomes as described in Chapter 4. This latter method may be particularly useful in an embodiment where the interface may adjust the probabilities of alteration of outcomes of component decisions, as described below. For example, for the example composite decision class, the interface can, say, assign a low probability of alteration to the mixed fraction outcome whenever it is an alternate option; alternatively, the interface can calculate the probability of alteration for the mixed fraction outcome based on the probabilities of alteration of the component decision outcomes along the decision path that leads to the mixed fraction outcome, so that interface adaptation that affects the probability of alteration of any component decision along that path will affect the probability of alteration of the mixed fraction outcome as an outcome of the composite decision.

When a composite decision is an adaptive decision, the interface can analyze the outcome of each component decision based on its analysis of the outcome of the composite decision. Such behavior may be particularly useful in an embodiment where the interface may adapt its behavior based on its analysis of the outcomes of component decisions, as described below. For purposes of the present paragraph, the “target outcome” of a composite decision is its initial outcome if that outcome was beneficial, or the outcome that would have been beneficial if its initial outcome was not beneficial. In an embodiment, when the interface is able to determine the target outcome of a composite decision, it will then analyze the outcomes of that decision's component decisions as follows: Every component decision that is not along the decision path to the target outcome will be considered to have had a neutral outcome, and every component decision that had only one available outcome will be considered to have had a neutral outcome. If a component decision is along the decision path to the target outcome and had more than one available outcome, then if the outcome of that component decision was the outcome that leads towards the target outcome, or if its outcome would have been the one that leads towards the target outcome if the interface had made that component decision, then that component decision will be considered to have had a beneficial outcome; if it had or would have had an outcome that leads away from the target outcome, it will be considered to have had a non-beneficial outcome. For example, if the interface made a component decision to display an answer as a decimal rather than a fraction, but it would have chosen to display the answer as a mixed fraction rather than an improper fraction if it had chosen to display the answer as a fraction, then if the interface determines that displaying the answer as a mixed fraction would have been beneficial, then the interface will determine that the component decision regarding whether to display the answer as a decimal or a fraction had a non-beneficial outcome but the component decision regarding whether to display the answer as a mixed fraction or an improper fraction had a beneficial outcome.

### Dividing Decisions into Components

In the present specification, a “true decision” is an interface decision that has at least two available outcomes; a “false decision” is an interface decision that has only one available outcome. When a decision is a false decision, it cannot be altered or optimized. For example, in the example composite decision class, the component decision regarding whether to display an answer as an improper fraction or as some other kind of fraction always entirely depends on the value of the answer: the answer can be displayed as an improper fraction only if its absolute value is less than 1, and the answer can be displayed as some other kind of fraction only if its absolute value is greater than 1. That component decision is always a false decision.

Below, the present specification explains a general procedure for optimizing interface decisions. In the explanation of this procedure, it will be assumed that any interface decision class that is to be optimized has a constant set of outcomes that are available whenever the decision is a true decision. This procedure thus cannot be directly applied to an interface decision class that has an outcome that may or may not be available when the interface makes a true decision of that class. For example, the procedure cannot be directly applied to the example composite decision class described above, because when a decision of that class has at least two outcomes available, it may or may not have the improper fraction outcome available.

If an interface decision class has an outcome that may or may not be available when the interface makes a true decision of that class, then the interface decision class may be divided into two entirely distinct decision classes—one for when that outcome is available, and one for when it is not available. For example, an interface could have one decision class for deciding how to display an answer whose absolute value is less than 1, and another decision class for deciding how to display an answer whose absolute value is greater than 1. These decision classes may then be optimized separately using the procedure that is described below. However, by causing closely related decisions to be members of entirely distinct decision classes, such an approach may cause interface adaptation to be somewhat inefficient. For example, if an interface has distinct decision classes for deciding how to display an answer depending on its absolute value, then even after the interface has fully adapted to the fact that a user strongly prefers an answer to be displayed as a decimal when its absolute value is less than 1, the interface may not yet have begun to adapt to the fact that the user also strongly prefers an answer to be displayed as a decimal when its absolute value is greater than 1. Of course, it is possible that such an approach may sometimes yield better results than any other approach would yield, and even when such an approach yields suboptimal results, in some embodiments alteration functionality may reduce the inconvenience caused by such results; nevertheless, another approach may be more desirable in most cases.

Instead, if an interface decision class has an outcome that may or may not be available when the interface makes a true decision of that class, then the interface decision class may be divided into component decision classes such that no component decision class has an outcome that may or may not be available when the interface makes a true decision of that component class. One possible way to achieve such a division is by repeatedly subdividing the decision until each component decision has only two possible outcomes; both of those two outcomes will then be available whenever the interface makes a true decision of that class, because when less than two outcomes are available for a decision, it is not a true decision. These component decision classes may then be optimized separately using the procedure that is described below. This approach has some advantages over the approach described in the preceding paragraph; in particular, if the component decisions of the example composite decision class are optimized separately, then after the interface has fully adapted to the fact that a user strongly prefers an answer to be displayed as a decimal when its absolute value is less than 1, the interface will equally assume that the user strongly prefers an answer to be displayed as a decimal when its absolute value is greater than 1, because the component decision regarding whether or not to display an answer as a decimal is distinct from the component decision that takes into account the absolute value of the answer.

When a decision class has more than two possible outcomes, even if it has a constant set of outcomes that are available whenever the decision is a true decision, it may still be advantageous to divide the decision into component decisions that have only two outcomes each, if the resulting component decision classes will be easier to optimize than the original decision class would be. For example, the present writer has attempted to design an algorithm that would attempt to intelligently decide whether to display an answer as a decimal, improper fraction, or mixed fraction, and ultimately decided it would be easier to accomplish that task by dividing it into smaller pieces: he first designed an algorithm that attempts to intelligently decide whether to display an answer as a decimal or as a fraction and then designed a distinct algorithm that attempts to intelligently decide whether to display an answer as an improper fraction or mixed fraction.

When dividing a composite decision into component decisions, it may generally be preferable to organize the possible outcomes of the composite decision into a hierarchy, so that component decisions between very similar outcomes will tend to occur later in the decision process than component decisions between outcomes that are not very similar. For example, if the three outcomes of a composite decision consist of displaying an answer as an ordinary decimal, displaying it in scientific notation, and displaying it in engineering notation, then it may be preferable for the first component decision to be the decision whether or not to display the answer as an ordinary decimal, and the second component decision to be the decision (if necessary) whether to display the answer in scientific notation or in engineering notation. This can make it easier for an interface designer to optimize the component decisions. For example, both scientific notation and engineering notation are commonly used for extremely large numbers; if an interface designer wishes to bias the composite decision accordingly, then if those two outcomes are grouped together under one possible outcome of the first component decision, the interface designer will only need to bias that first component decision in favor of steering towards those two outcomes whenever an answer is extremely large, but if the composite decision is broken down into two component decisions in a different manner, then the interface designer will need to bias both of the component decisions.

### Chapter 20: Decision Function Adaptation

### Decision Settings

When the interface makes a decision, the outcome is determined by which decision function the interface uses and the circumstances that the decision function takes into account. Generally, the circumstances that a decision function takes into account may or may not be readily visible. This distinction is somewhat subjective, but for many decision functions it is easy to distinguish between circumstances that are readily visible and circumstances that are not readily visible. For example, the example decision function may take into account the input of a problem the user just typed, which will be readily visible, and may also take into account the calculator's ANSWERS mode setting, which is visible in a special settings screen but may not be readily visible when the calculator is displaying the answer to a problem. In the present specification, information regarding circumstances that are readily visible is “decision context.” Information regarding circumstances that may not be readily visible is “decision settings.” In the present specification, a “setting variable” is a particular decision setting that may vary according to circumstances, and a “setting value” is one possible value for a setting variable. For example, the ANSWERS mode setting mentioned above is a setting variable, and AUTO, DEC, and FRAC-APPROX are setting values. A “setting value combination” is a possible combination of setting values for a decision function, so for any decision function that takes into account the value of only one setting variable, a setting value combination is simply a setting value for that setting variable.

For the sake of brevity, a setting value combination may be referred to herein as a “setting.” It is to be understood that such a “setting” may be a specific value for a single setting variable, or may actually be a combination of specific values for multiple setting variables. Also, decision context may be referred to herein as simply “context.”

For any decision function that takes into account the current setting values of setting variables, the decision function can be specified in terms of a set of “setting-specific functions,” where each setting-specific function describes how the decision function will behave when a specific setting value combination is selected. For example, the example decision function above can be specified in terms of three setting-specific functions, where each setting-specific function describes how the decision function will behave for a specific setting value of the ANSWERS mode setting: the setting-specific function for the DEC setting value will always choose decimal form; the setting-specific function for the FRAC-APPROX setting value will always choose fraction form; and the setting-specific function for the AUTO setting value will choose fraction form if the user's input included a fraction, or decimal form otherwise.

If a decision function does not take into account the current setting values of setting variables, then that decision function can still be considered to have a single possible setting value combination that consists of no setting values whatsoever, and the decision function can be considered to itself constitute a single “setting-specific function” that describes how the function will behave for that setting value combination.

In the present specification, when the behavior of a decision function is described in terms of the behavior of a set of setting-specific functions, this does not imply that such a decision function must be implemented in terms of an algorithm that first checks the current setting value combination and then invokes an algorithm that implements the appropriate setting-specific function. In some cases, it is certainly possible to implement a decision function by an algorithm that first checks the current setting value combination and then accordingly selects and invokes an algorithm that implements the setting-specific function that corresponds to that specific setting value combination. For example, the example decision function may be implemented by an algorithm that first checks the current setting value of the ANSWERS mode setting and invokes either an algorithm that implements the setting-specific function for the DEC setting value (by just choosing decimal form), or an algorithm that implements the setting-specific function for the FRAC-APPROX setting value (by just choosing fraction form), or an algorithm that implements the setting-specific function for the AUTO setting value. However, those of ordinary skill in the art may be able to construct other algorithms that implement the same behavior that do not begin by checking the current setting value combination.

Setting-specific functions do not themselves take into account any setting values. For example, if the example decision function is implemented in terms of an algorithm that checks setting values and then invokes the appropriate setting-specific function, then the algorithm for the DEC setting-specific function will be invoked only after the example decision function checks setting values, and will not itself check any setting values. If the behavior of a decision function is entirely determined by decision context and thus does not take into account any setting values, then that decision function consists of one setting-specific function, in a sense.

In the present specification, a “smart setting-specific function” is a setting-specific function that takes into account decision context (and thus chooses different outcomes depending on context), and a “simple setting-specific function” is a setting-specific function that does not take into account decision context (and thus always chooses the same outcome). For example, when the behavior of the example decision function described above is described in terms of three setting-specific functions, the setting-specific functions for the DEC setting value and the FRAC-APPROX setting value are simple setting-specific functions and the setting-specific function for the AUTO setting value is a smart setting-specific function.

In the present specification, a “smart decision function” is a decision function that takes into account decision context. When a smart decision function is described in terms of the behavior of a set of setting-specific functions, at least one of those functions will be a smart setting-specific function as defined above. For example, the example decision function described above is a smart decision function, and the setting-specific function for its AUTO setting value is a smart setting-specific function. In the present specification, a “simple decision function” is a decision function that does not take into account decision context. When a simple decision function is described in terms of the behavior of a set of setting-specific functions, all of those functions will be simple setting-specific functions.

In the present specification, the setting-specific function that describes the behavior of a decision function when a particular setting value combination is selected may be spoken of as though it were entirely synonymous with that setting value combination, and thus may itself be referred to as a “setting.” For example, rather than saying, “The setting-specific function for the DEC setting value always chooses to answer in decimal form,” the present specification could say, “The DEC setting always chooses to answer in decimal form.”

### Setting Adaptation Maps

In the following paragraphs, various terms are defined, and then “setting adaptation maps” are explained. A setting adaptation map is a way of organizing the possible settings that a particular adaptive decision class has. Subsequently, in explaining how to make optimizable decisions adaptive and how to make them smarter, it will be helpful to refer to setting adaptation maps.

The following explanation of setting adaptation maps includes some technical terms from the field of graph theory and is fairly complicated, but only because it is intended to be applicable to a wide variety of possible optimizable decision classes, including optimizable decision classes that have more than two possible outcomes and have multiple smart settings. The setting adaptation map of a typical optimizable decision class will actually turn out to be quite simple.

In the present specification, if two settings are said to be “non-comparable” with respect to a certain outcome, this means that each of the two settings will choose that outcome in at least one context where the other will not choose that outcome. If two settings are “comparable” with respect to a certain outcome, this means that at most one of the two settings will choose that outcome in a context where the other will not choose the outcome. When two settings are comparable with respect to a certain outcome, if one of the two settings will choose that outcome in at least one context where the other will not, then the former may be said to be “more biased” towards that outcome than the latter, and the letter may be said to be “less biased” towards that outcome of the former; otherwise, the two settings may be said to be “equally biased” towards that outcome.

In the present specification, if a setting is said to be “maximally biased” towards a certain outcome, this means that it is comparable to all the other settings of the relevant decision function and it is more biased or equally biased towards that outcome when compared to any other setting. For example, in the example decision function, the FRAC-APPROX setting is more biased towards the outcome of answering in fraction form than the AUTO setting, which is more biased towards that outcome than the DEC setting; the FRAC-APPROX setting is maximally biased towards that outcome.

In the present specification, if a setting is said to be “intermediate between” two other settings, this means that with respect to each possible outcome of the relevant decision function, the setting is comparable with both of those other two settings, and when the setting is compared with those other two settings, either the setting and at least one of those other two are equally biased towards that outcome, or else the setting is more biased towards that outcome than one of those other two settings and less biased than the other. In other words, if a setting is intermediate between two other settings, then there is no outcome such that the setting is more biased towards that outcome than both of the other two settings, and there is no outcome such that the setting is less biased towards that outcome than both of the other two settings. For example, in the example decision function, the AUTO setting is intermediate between the DEC setting and the FRAC-APPROX setting: it is more biased towards the outcome of answering in fraction form than the DEC setting and less biased than the FRAC-APPROX setting, and it is more biased towards the outcome of answering in decimal form than the FRAC-APPROX setting and less biased then the DEC setting.

In the following discussion of setting adaptation maps, a “setting vertex” is any vertex of a graph that corresponds to a setting of a decision function. A setting vertex may be spoken of as though the vertex itself is synonymous with the corresponding setting; for example, one setting vertex may be said to have less bias towards an outcome than another setting vertex. The “destination vertex” for an outcome is some particular setting vertex that is maximally biased towards that outcome; when more than one setting of a decision function is maximally biased towards a particular outcome, only one such setting will be the destination vertex for that outcome. An “empty vertex” is a vertex of a graph that does not correspond to a setting of a decision function.

In the present specification, a “setting adaptation map” is an acyclic connected graph that has one distinct setting vertex for each setting of a decision function (and may also have empty vertices that do not correspond to settings of the function), and that has a destination vertex for each possible outcome, and that has the property that for any particular setting vertex and any particular outcome, if the unique simple path is traced from that setting vertex through zero or more intermediate vertices to that outcome's destination vertex, then that particular setting will have a bias towards that outcome that is less than or equal to the bias of every setting vertex that the path travels through. In other words, a setting adaptation map is a map of paths connecting settings such that the road from any particular setting to a maximally biased setting never passes through a less biased setting.

It is always possible to create a setting adaptation map for any decision function, as long as the decision function has a destination vertex for each possible outcome. One way to do so is to directly connect each setting vertex to a single central empty vertex, and not directly connect any setting vertex to any other setting vertex. However, for most decision functions, it is also possible to create a setting adaptation map that does not have any empty vertices; the following two paragraphs explain a couple of specific situations in which it is possible to create a setting adaptation map that does not have any empty vertices.

If a decision function has one simple setting per possible outcome along with just one smart setting, then a setting adaptation map for that decision function can be an arrangement such that all of the simple setting vertices are directly connected to the smart setting vertex, and none of them are directly connected to each other. An example of such a setting adaptation map is a graph where the setting vertex DEC and setting vertex FRAC-APPROX are both directly connected to the setting vertex AUTO (and not to each other). If the outcome of answering in scientific notation is added to the example decision function and a simple setting called SCI-NOT that always chooses to answer in scientific notation is added to the example decision function, then a graph in which the setting vertices DEC, FRAC-APPROX, and SCI-NOT are all directly connected to the setting vertex AUTO (and not to each other) will be a setting adaptation map for this modified example decision function.

If a decision function has only two possible outcomes, and every possible pair of settings of the decision function is comparable with respect to both of the possible outcomes, then a setting adaptation map for that decision function can be an arrangement of the function's settings in a linear sequence from the least biased towards a certain outcome to the most biased towards that outcome, with an edge directly connecting each setting to the next. For example, the settings of the example decision function can be arranged from the least biased towards the outcome of answering in fraction form to the most biased towards that outcome: DEC, then AUTO, then FRAC-APPROX. If a graph is constructed such that the setting vertex DEC is directly connected to the setting vertex AUTO which is directly connected to the setting vertex FRAC-APPROX (but the setting vertex DEC is not directly connected to the setting vertex FRAC-APPROX), then this constitutes a setting adaptation map for the sample decision function. If another setting called PROBABLY-DEC is added to the example decision function, and this setting is intermediate between the DEC setting and the AUTO setting, then a graph in which DEC, PROBABLY-DEC, AUTO, and FRAC-APPROX are arranged in that order from left to right and adjacent settings are directly connected to each other will be a setting adaptation map for this modified example decision function.

### Adaptive Decisions

In an embodiment, for one or more optimizable decision classes, at some time after the interface makes a decision of such a class, the interface will analyze the outcome of the decision, and in certain circumstances will then adjust relevant setting variables in an attempt to increase the likelihood that future decisions of that class will have beneficial outcomes, or in an attempt to increase the likelihood that future decisions of that class will have more appropriate probabilities of alteration assigned to them, or both. Such decisions may be referred to herein as “adaptive decisions.”

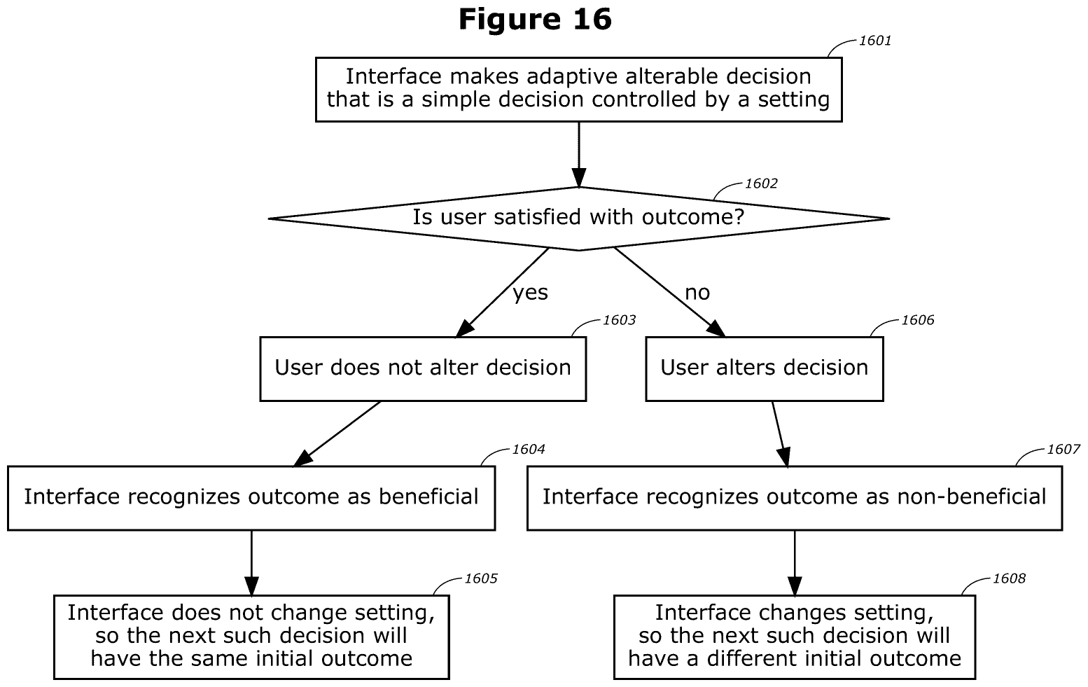

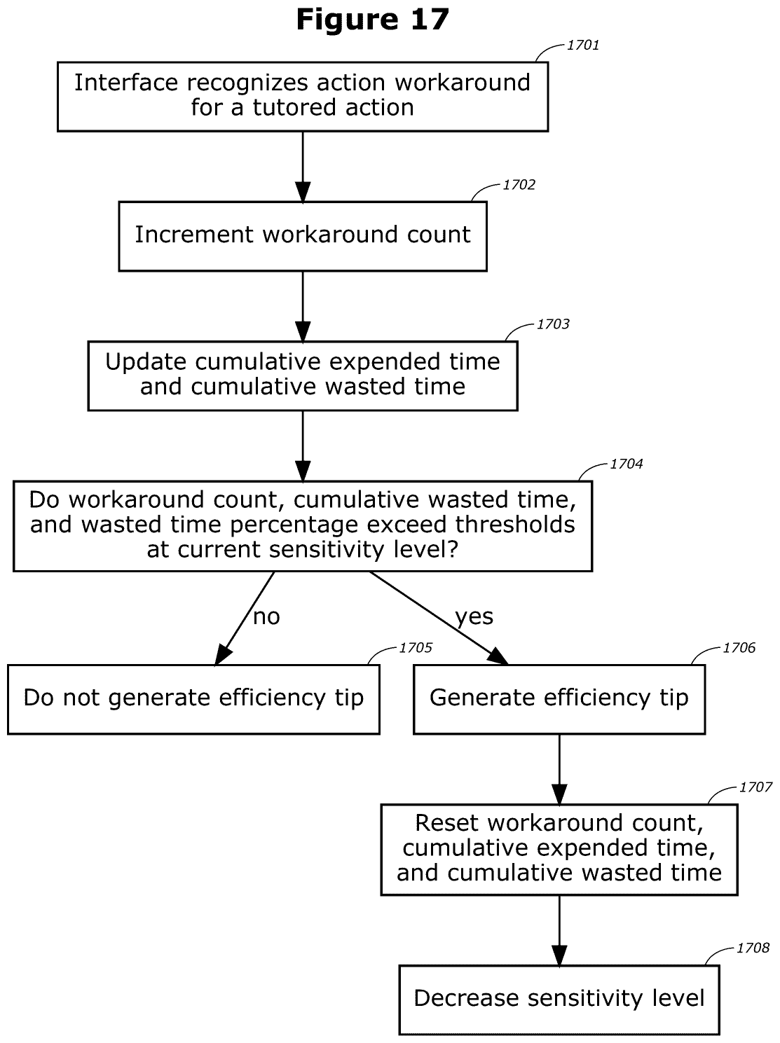

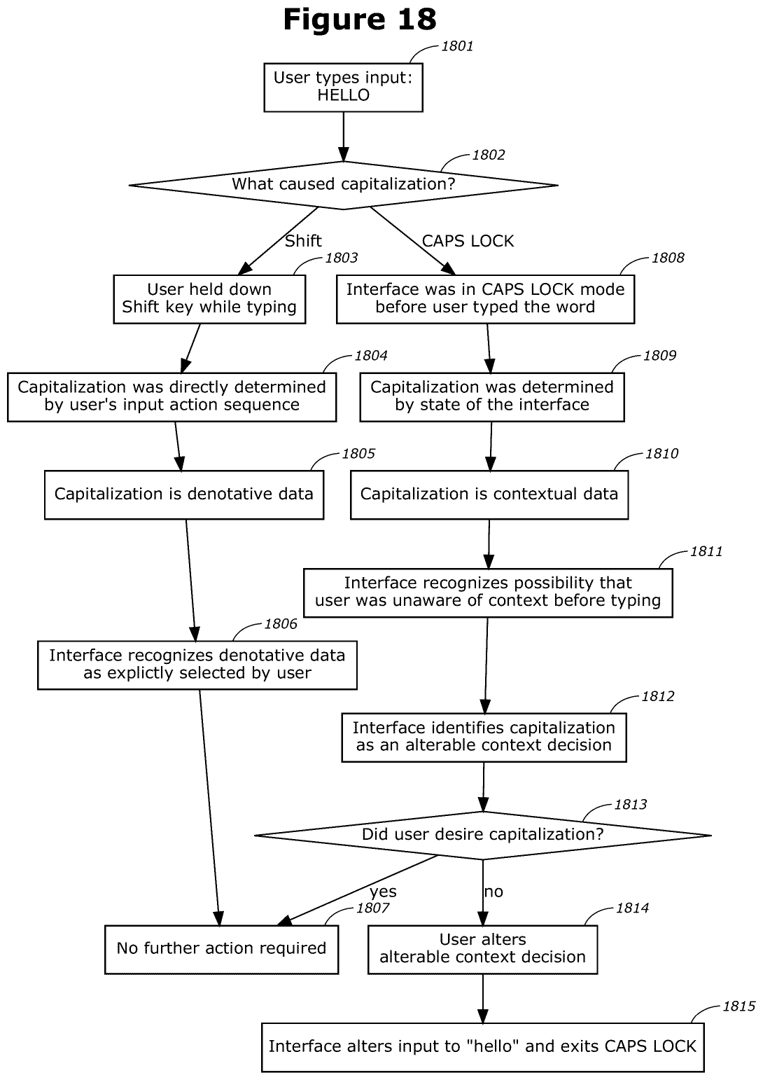

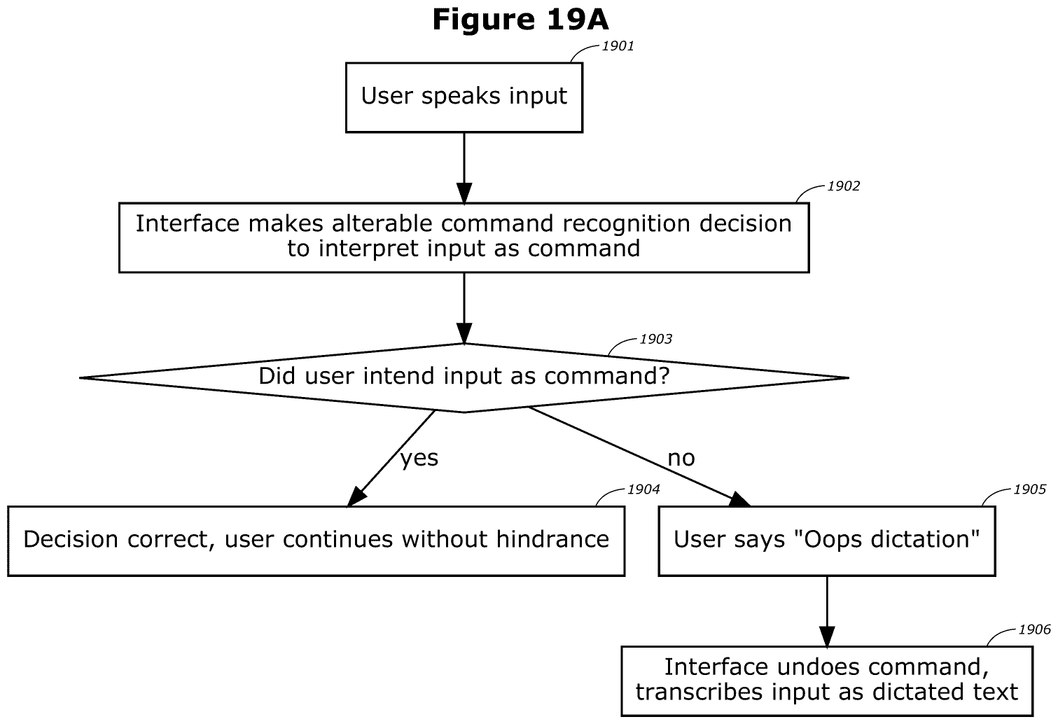

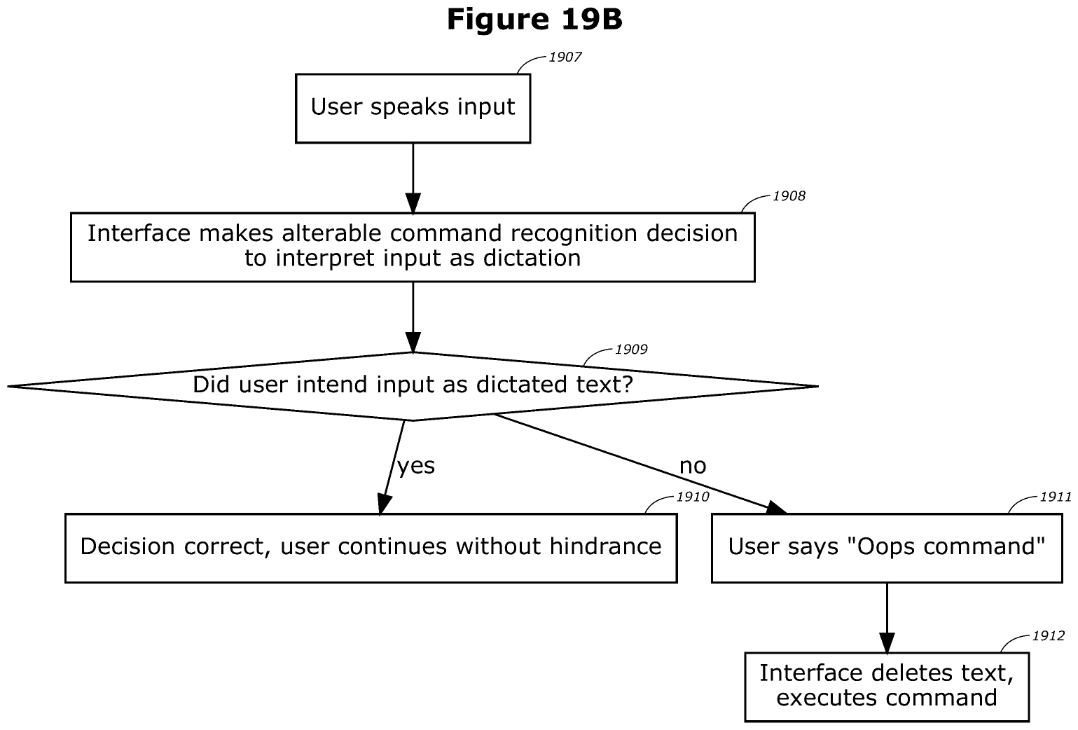

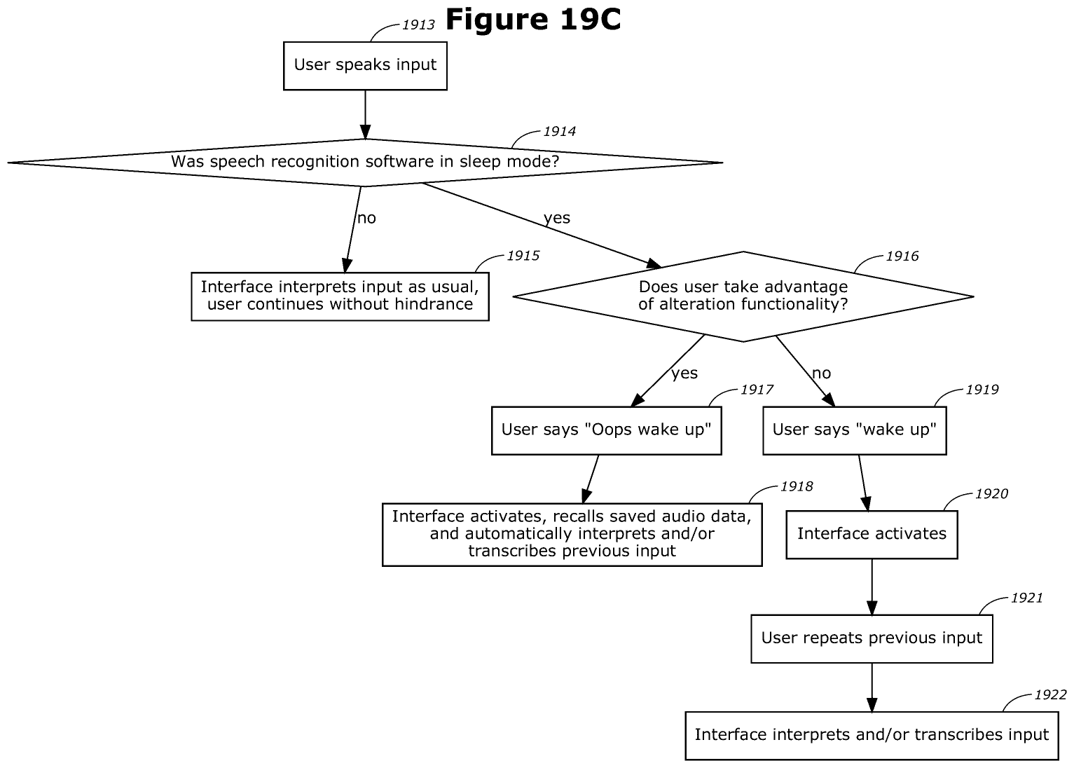

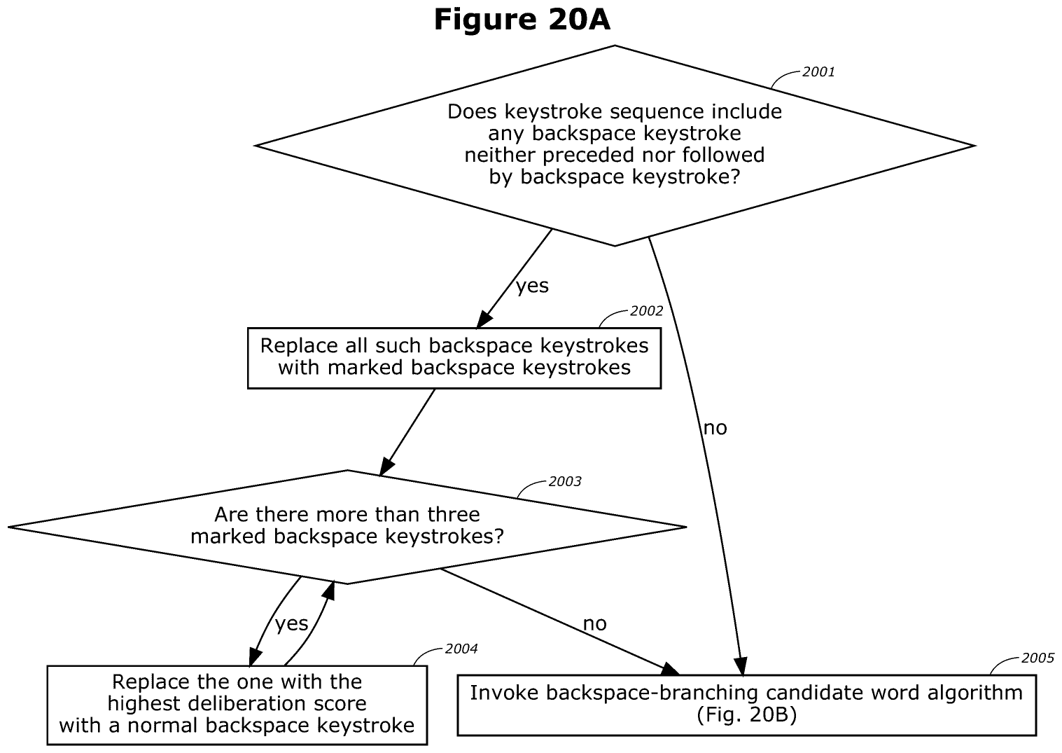

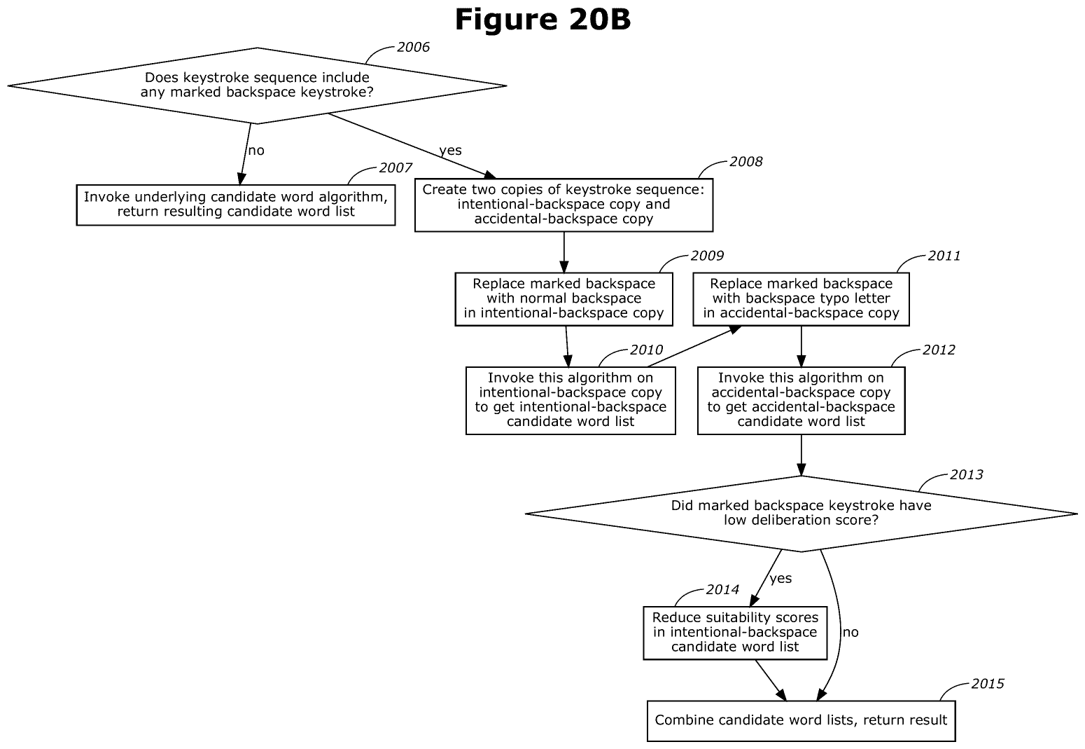

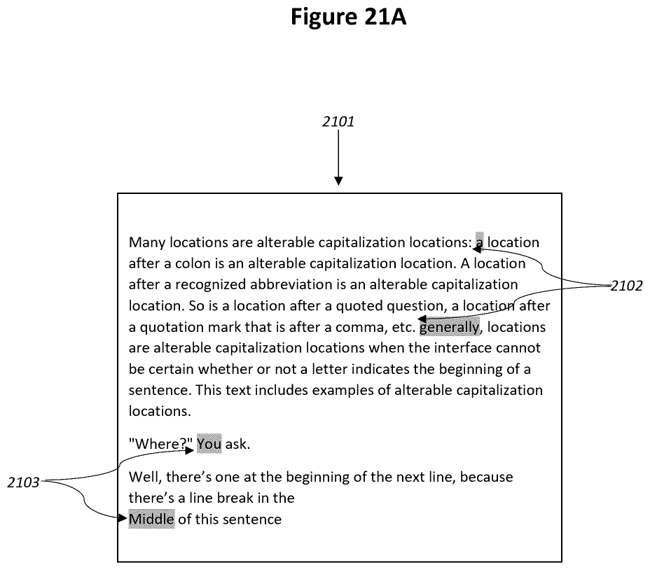

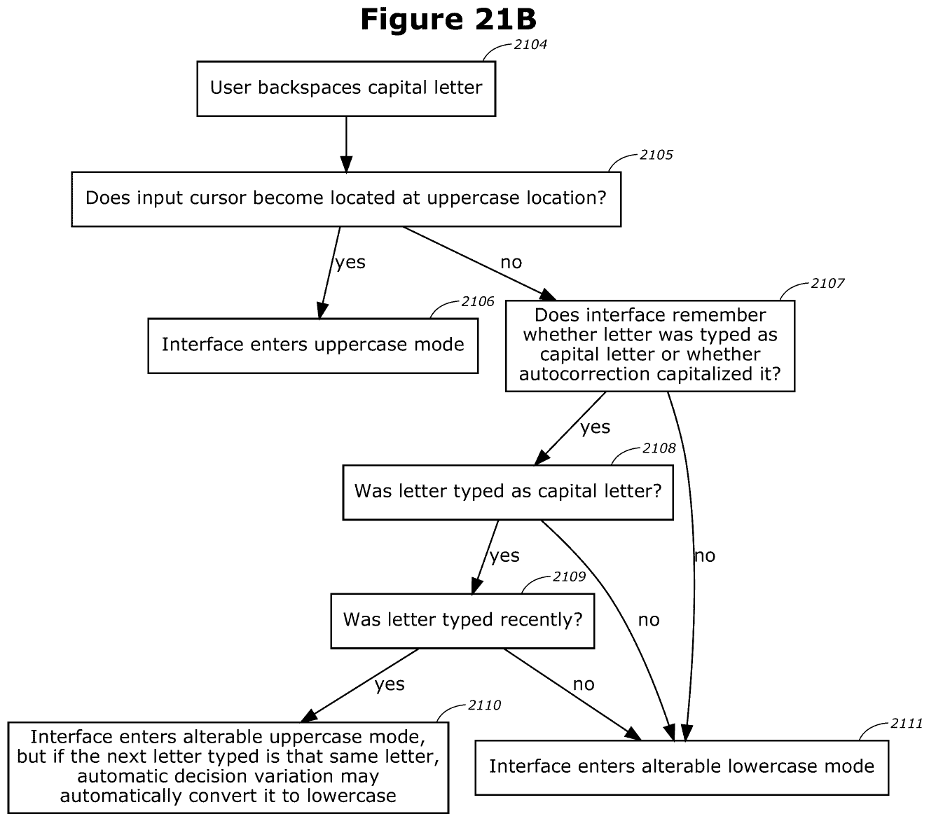

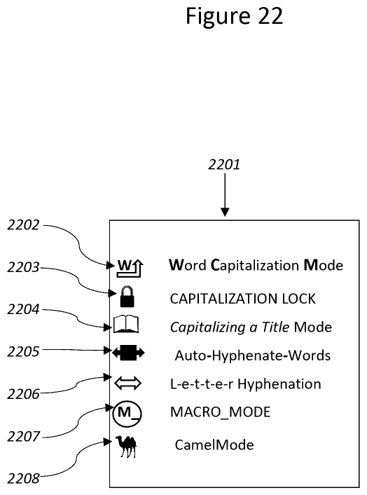

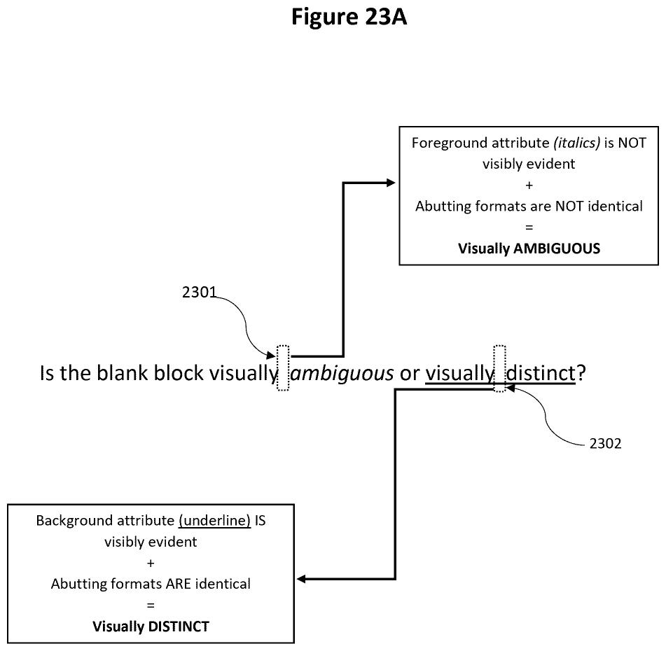

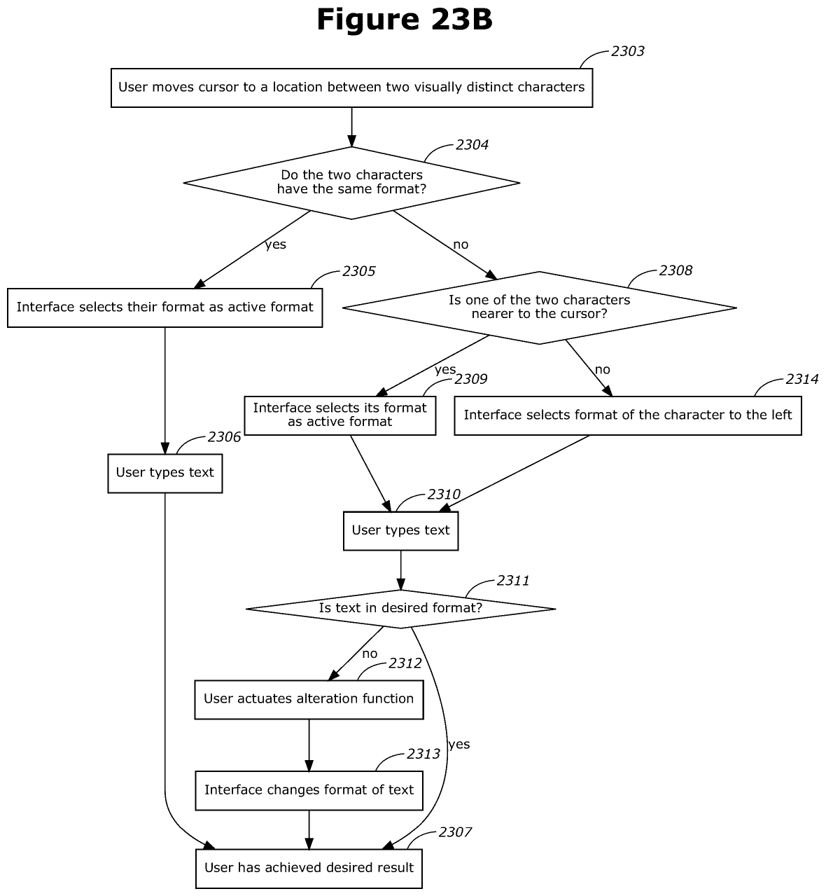

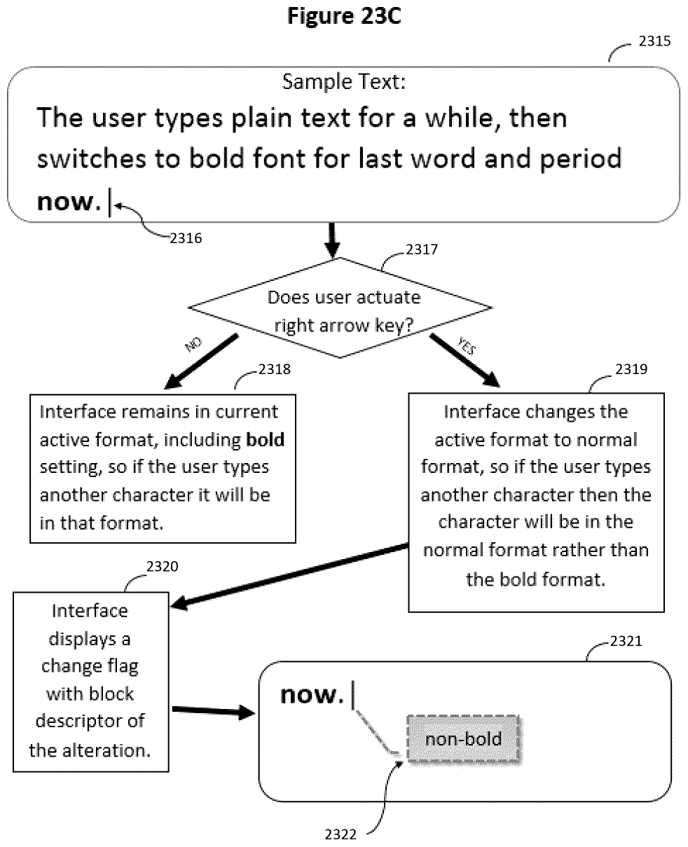

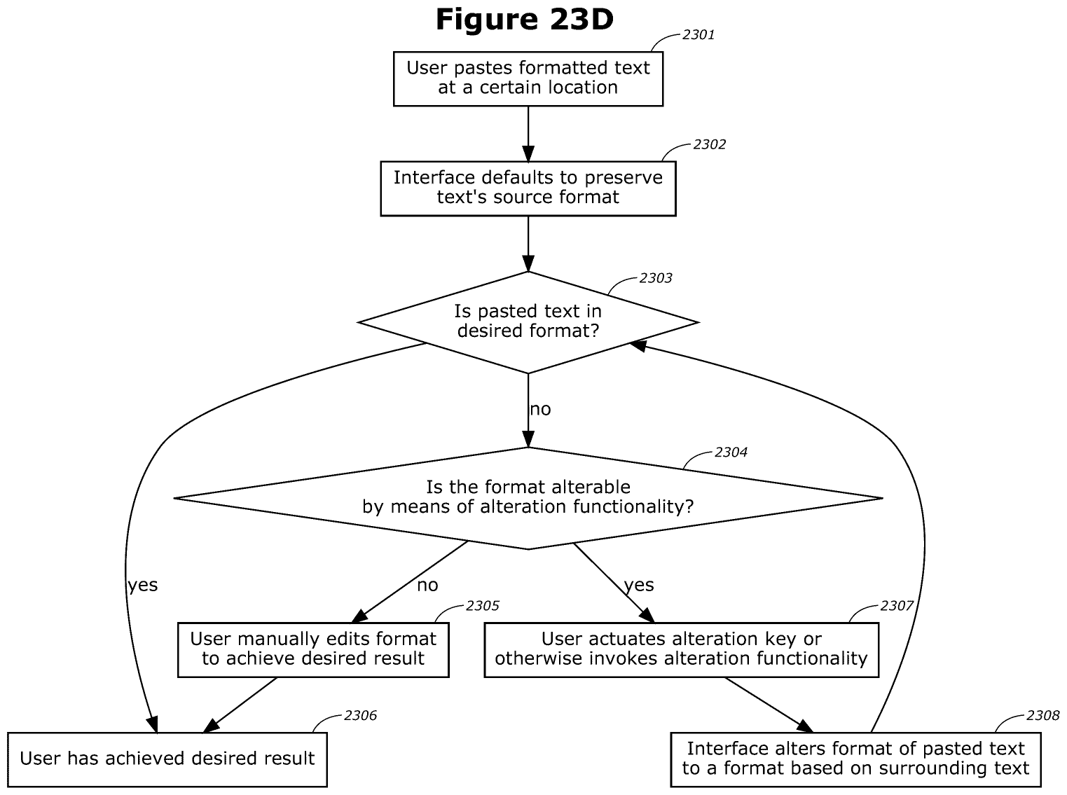

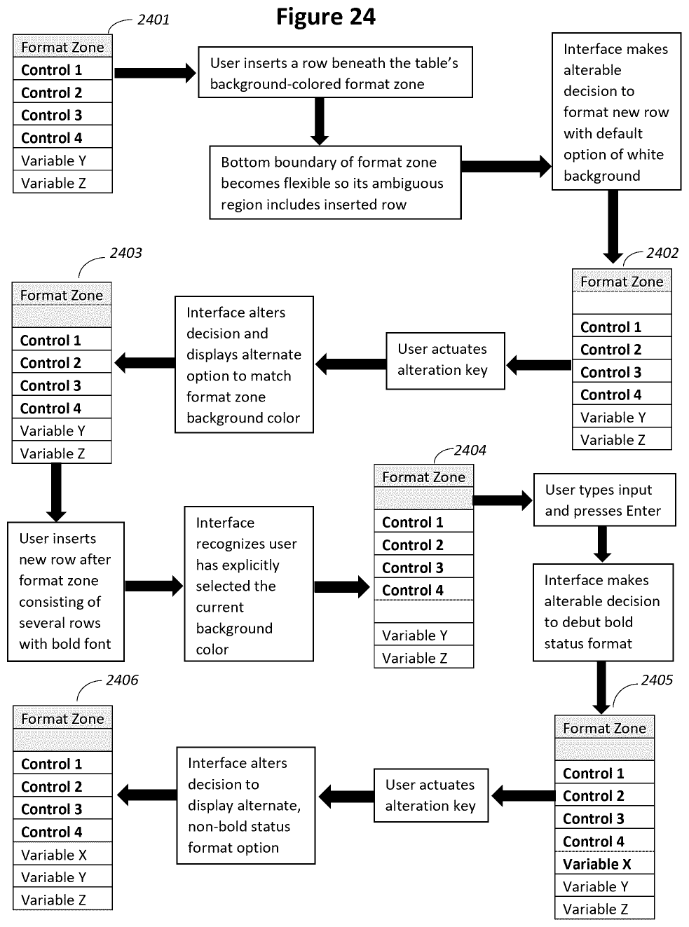

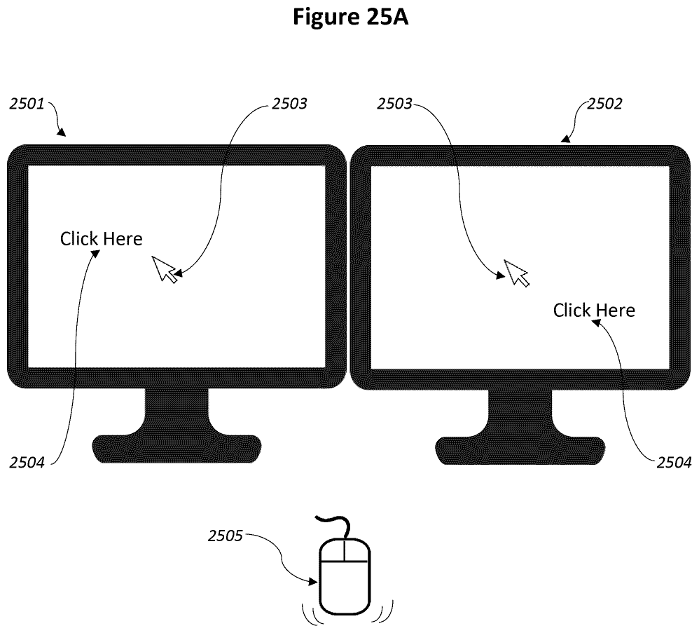

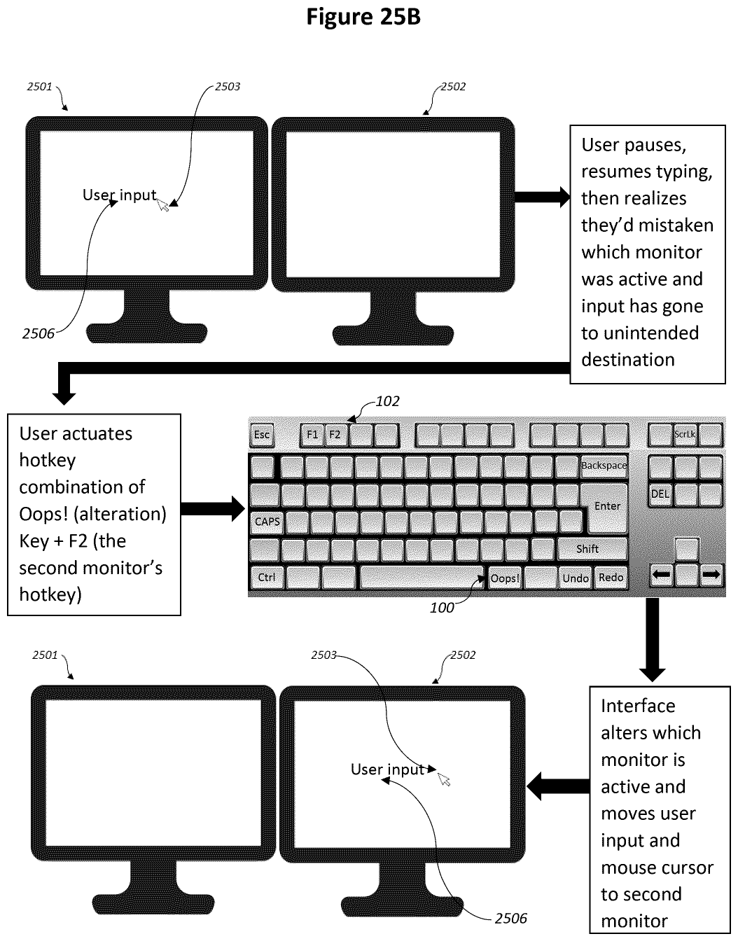

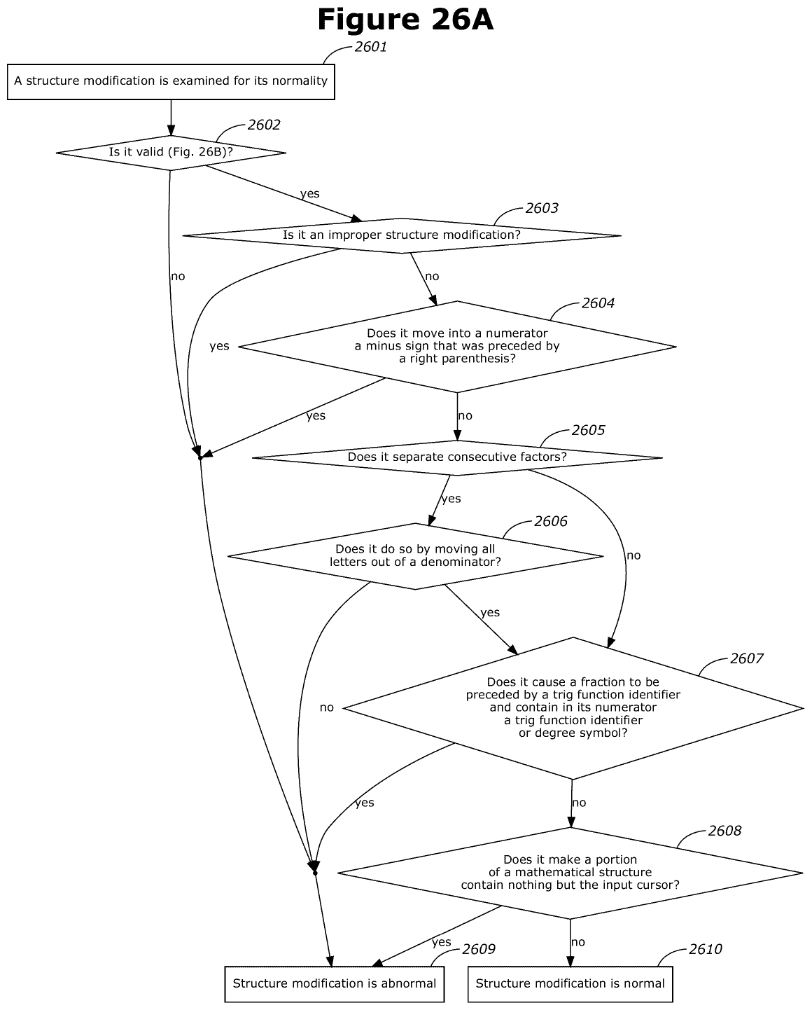

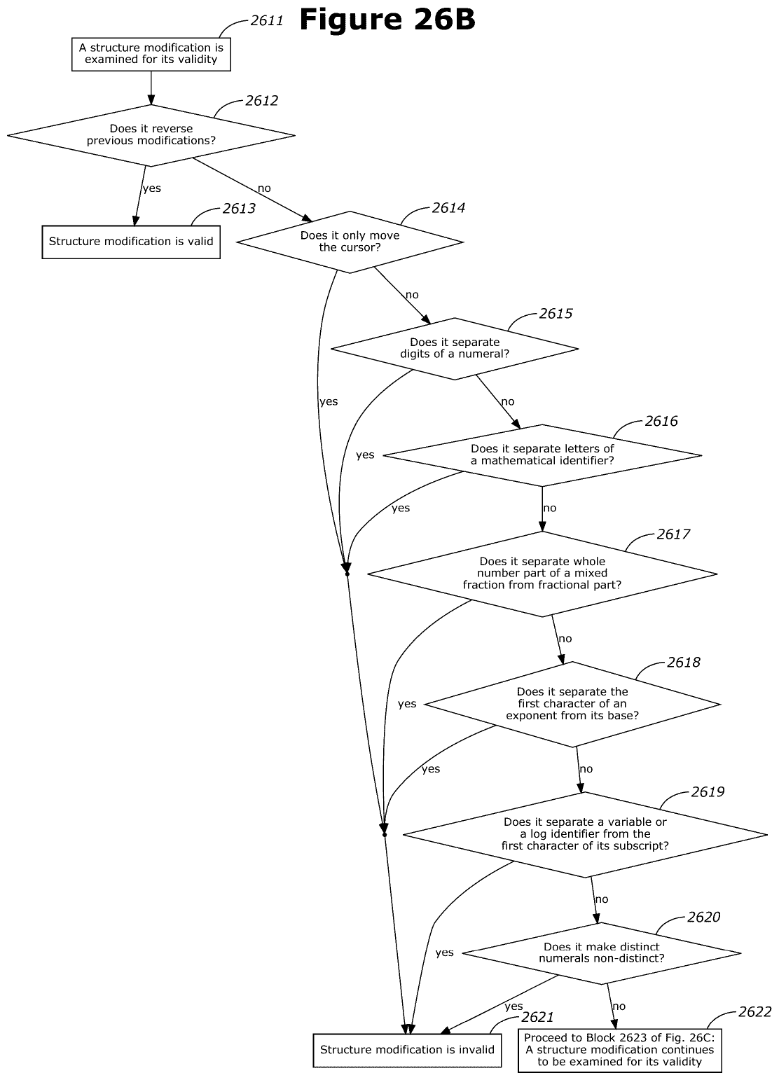

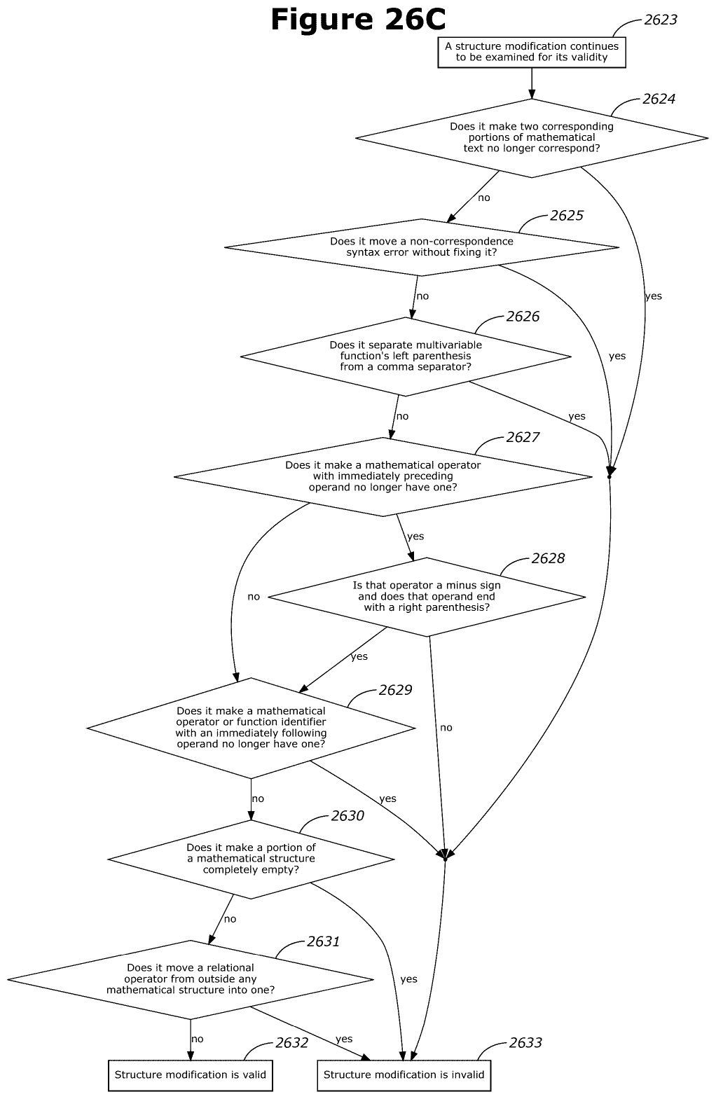

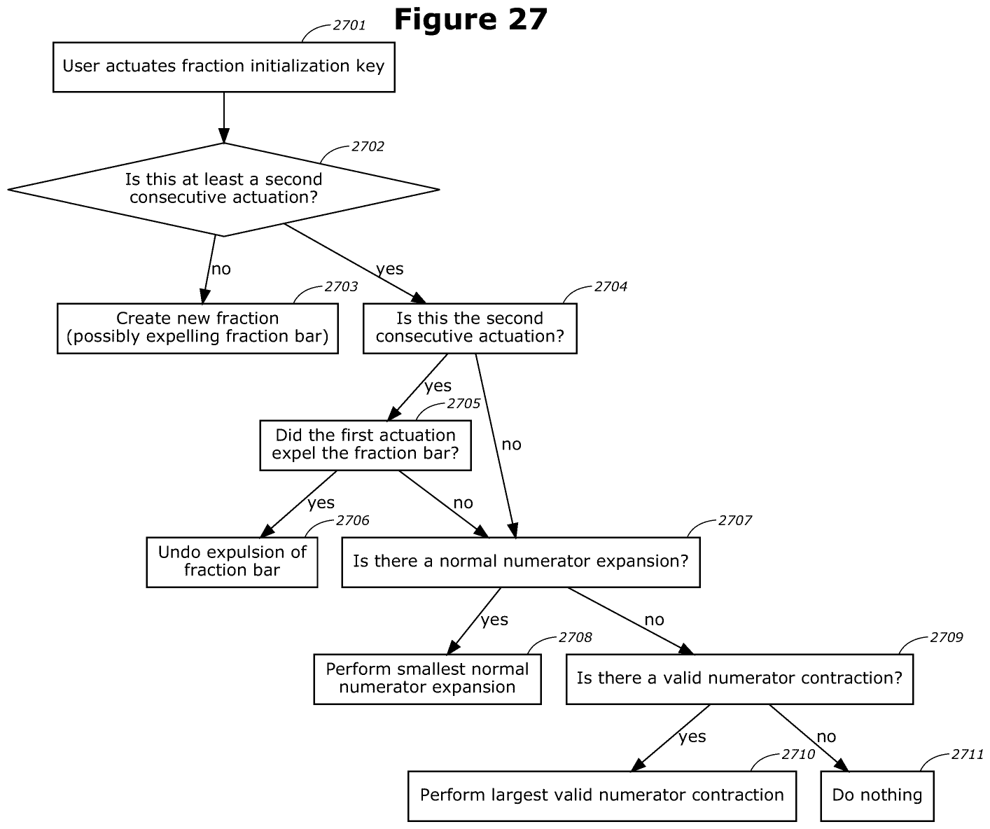

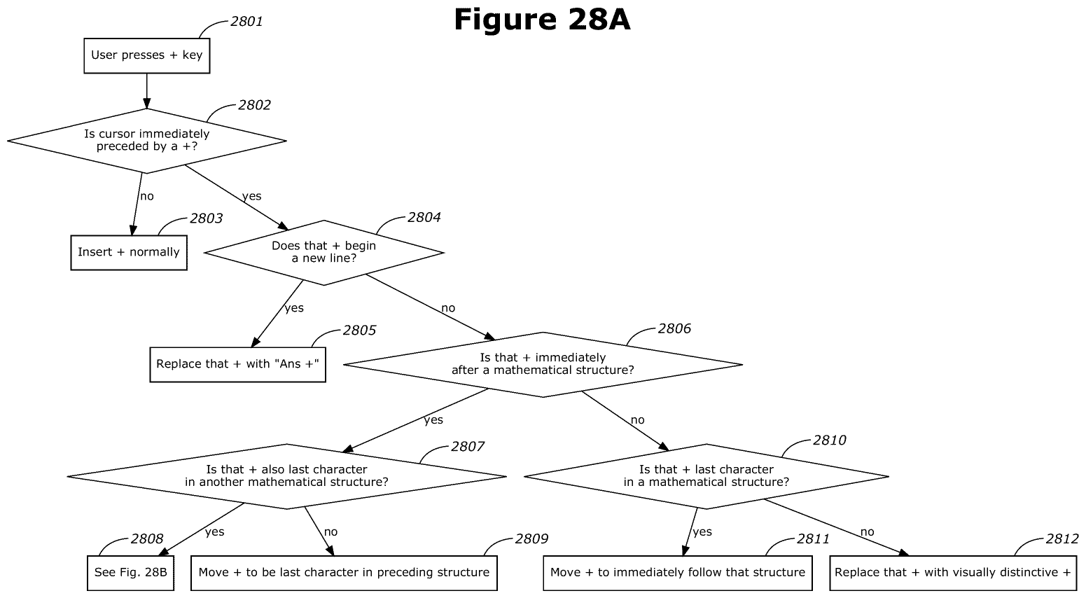

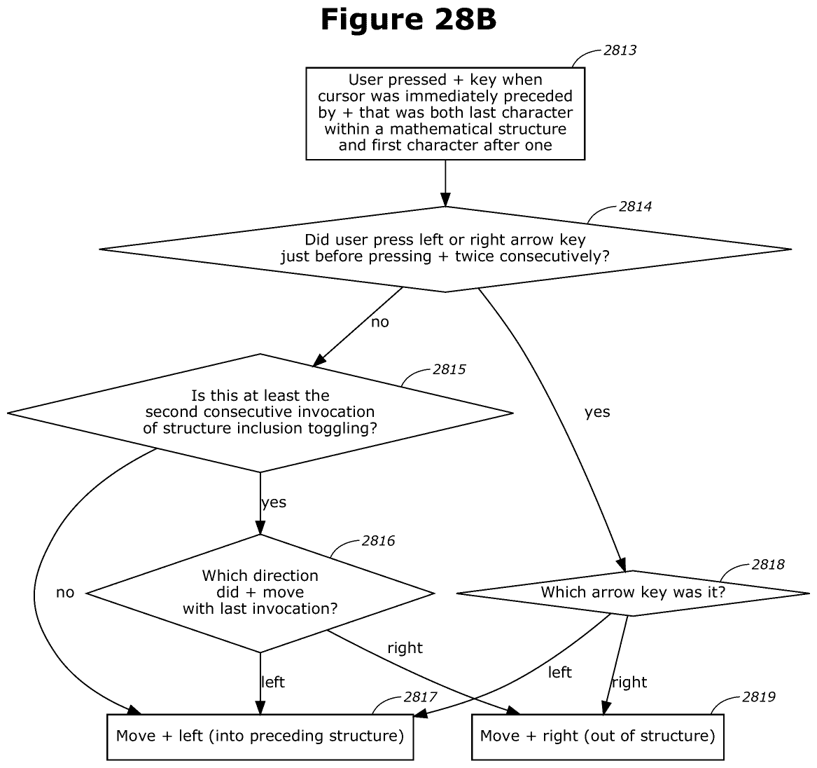

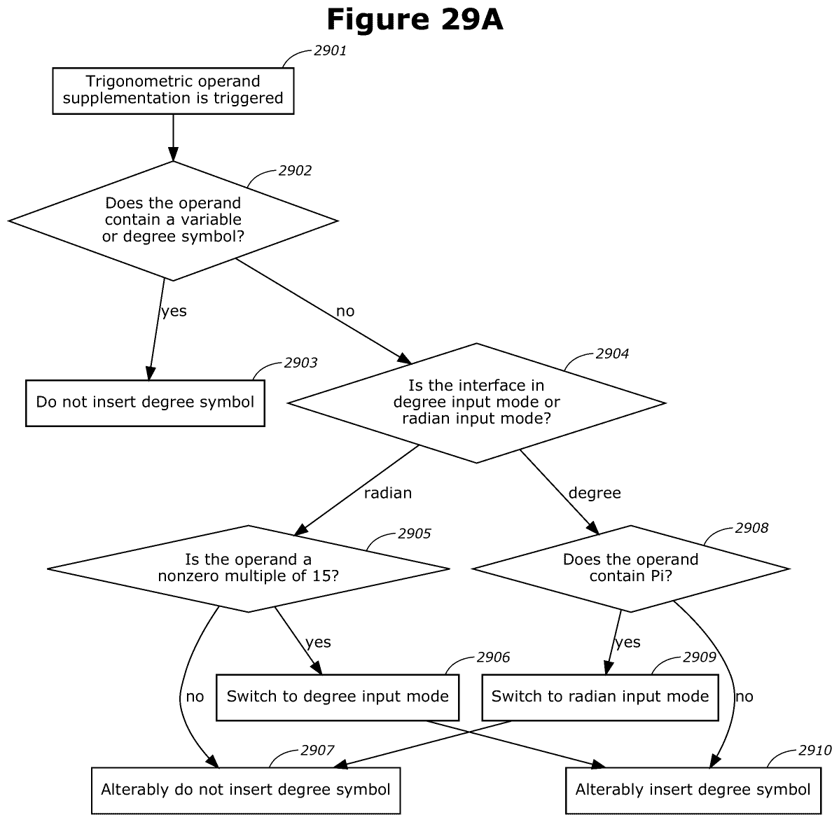

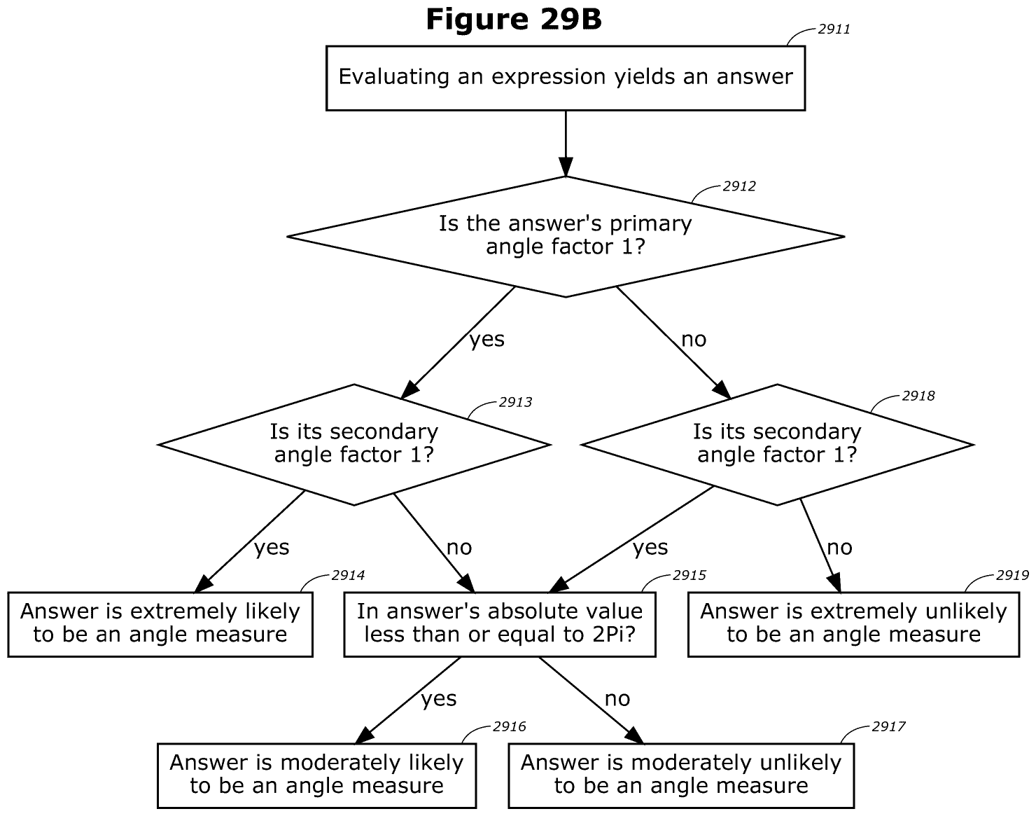

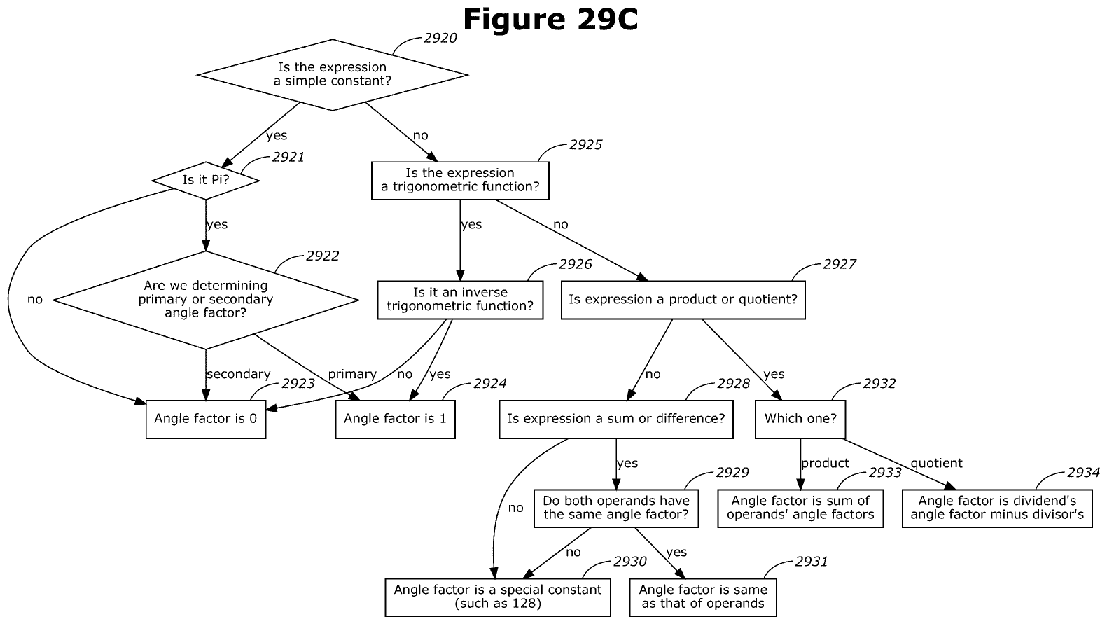

FIG. 16 is a flowchart that illustrates a simple case of an adaptive decision that may affect interface settings, in an embodiment. Block 1601 says “Interface makes adaptive alterable decision that is a simple decision controlled by a setting” and proceeds to Block 1602, which asks, “Is user satisfied with outcome?” If the answer is yes, that means that the user will not alter the decision (Block 1603), so the interface will eventually recognize the outcome as beneficial (Block 1604), and the interface will not change the setting, which means that the next decision of that decision class will have the same initial outcome (Block 1605). If the answer is no, that means that the user will alter the decision (Block 1606), so the interface will recognize the outcome as non-beneficial (Block 1607), and the interface will change the setting so the next decision of that decision class will have a different initial outcome (Block 1608).

For example, in an embodiment, if the interface makes an alterable decision whether or not to automatically capitalize the word “tuesday” and this decision turns out to have a non-beneficial outcome, then the interface will adjust the relevant setting variable so that it will make the opposite decision the next time the user types the word “tuesday.” As another example, in a different embodiment, only after three alterable decisions in a row regarding whether or not to automatically capitalize the word “tuesday” have all had non-beneficial outcomes will the interface adjust a setting variable so that it will make the opposite decision the next time the user types the word “tuesday.” As another example, in an embodiment, if alterable decisions regarding whether or not to automatically capitalize the word “tuesday” are assigned high probabilities of alteration but then five such decisions in a row all have beneficial outcomes, then the interface will adjust a setting variable so that such decisions will continue to have the same outcome but will be assigned moderate probabilities of alteration.

In an embodiment, when the interface makes an adaptive decision, the interface will immediately treat the decision as having a beneficial outcome for purposes of decision adaptation, and will later reevaluate the outcome of the decision and redo adaptation if necessary. For example, in such an embodiment, if a user types “tuesday tuesday” and as a result the interface makes two consecutive adaptive decisions regarding whether or not to automatically capitalize “tuesday,” then at the moment when the interface makes the second decision, the interface may be acting under the assumption that its first decision was correct, because thus far the user appears to be satisfied with that first decision. In an alternative embodiment, the interface will not immediately take the outcome of an adaptive decision into account for purposes of decision adaptation, and will instead evaluate the outcome of an adaptive decision only later, at a point when it is impossible or relatively unlikely for the outcome to change, such as when an adaptive decision that was an alterable decision ceases to be alterable. For example, in such an embodiment, if a user types “tuesday tuesday” and the interface makes two consecutive adaptive decisions regarding whether or not to automatically capitalize “tuesday,” then at the moment when the interface makes the second decision, the interface will not necessarily be acting under the assumption that its first decision was correct: at that moment, the interface may not yet have evaluated the outcome of its first decision.

### Making Decisions Adaptive

In the present specification, a “non-adaptive decision function” is any decision function that does not in any way take into account past outcomes of decisions of that class. For example, on a TI-84, the example decision function described above takes into account the current value of a setting variable, but the TI-84 interface never takes the initiative to adjust that setting variable based on outcomes of decisions of that class, so that decision function is a non-adaptive decision class.

To convert a non-adaptive decision function into an adaptive decision function, an interface designer may perform the following three steps:

As the first step, for each possible outcome of the decision function, choose an existing setting that is maximally biased towards that outcome as the destination setting for that outcome, or add a new setting if necessary. In most cases this step will be trivial, because for most decision classes there will already be for each possible outcome exactly one setting that is maximally biased towards that outcome; for example, in the example decision function, the FRAC-APPROX setting is maximally biased towards answering in fraction form, and the DEC setting is maximally biased towards answering in decimal form. In the rare cases where a decision function has an outcome such that no setting is maximally biased towards that outcome, as part of the first step, add a new setting for the function such that the new setting will choose that outcome whenever any other setting would choose that outcome; such a setting will then be maximally biased towards that outcome, and can serve as the destination setting for that outcome. (Such a setting usually might as well be a simple setting that always chooses that outcome in every context, but does not necessarily need to be such a setting: it only needs to choose that outcome whenever some other setting would choose that outcome.)

As the second step, create a setting adaptation map for the decision class of the decision function, as described above. Try to avoid using empty vertices. If the decision function has one simple setting per possible outcome along with just one smart setting, or if the decision function has only two possible outcomes and every possible pair of settings of the decision function is comparable with respect to both of the possible outcomes, then it will be possible to create a setting adaptation map that does not have empty vertices, as is explained above.

As the third step, implement the following interface behavior: When the interface evaluates the outcome of a decision of this decision class, if the decision had a non-beneficial outcome, then the interface will determine the nearest beneficial setting and adjust the relevant setting variable or variables so that the nearest beneficial setting becomes selected. The “nearest beneficial setting” is defined as follows: if the unique simple path in the setting adaptation map from the setting vertex of the current setting to the destination vertex for the outcome that would have been beneficial is traced one vertex at a time, then the “nearest beneficial setting” is the setting that corresponds to the first setting vertex that is encountered while tracing this path that fits the requirement that the decision would have had a beneficial outcome if the setting corresponding to this vertex had been selected when the decision was made. If there is no such setting, then the “nearest beneficial setting” is the destination setting for the outcome that would have been beneficial.

In other words, to convert a decision into an adaptive decision, make it so that after such a decision has a non-beneficial outcome, the interface will change its settings the least amount possible such that the decision would have had a beneficial outcome if the change had been made prior to the decision.

An interface designer can use the preceding three-step procedure to convert any non-adaptive decision function to an adaptive decision function. In most cases, though, it will not actually be necessary to perform the entire procedure; most decision functions are so simple that an interface designer of ordinary skill in the art will understand how to implement essentially the same interface behavior that is described in the third step in a more direct fashion, without actually creating a setting adaptation map first. In the following three paragraphs, simpler procedures are described for converting three specific types of non-adaptive decision functions to adaptive decision functions. In each case, the three-step procedure described above will yield the same interface behavior as the simpler procedure described below; these simpler procedures thus serve to illustrate the results that would be achieved by applying the three-step procedure to specific types of non-adaptive decision functions.

When a non-adaptive decision function is a simple decision function that just has one simple setting for each possible outcome, to make the function adaptive, an interface designer may implement the following interface behavior: When the interface evaluates the outcome of a decision of this decision class, if the decision had a non-beneficial outcome, then the interface will select the setting that would have yielded a beneficial outcome.

When a non-adaptive decision function is a smart decision function that has one simple setting for each possible outcome and that also has a single smart setting, to make the function adaptive, an interface designer may implement the following interface behavior: When the interface evaluates the outcome of a decision of this decision class, if the decision had a non-beneficial outcome, if the smart setting would have yielded a beneficial outcome, then the interface will select the smart setting; otherwise, the interface will select the simple setting that would have yielded a beneficial outcome. This is the same interface behavior as is described in the third step of the procedure above, where the setting adaptation map is arranged so that the unique simple path from any simple setting vertex to any other simple setting vertex will travel through only the smart setting vertex.

When a non-adaptive decision function is a smart decision function that has only two possible outcomes and that does not have any settings that are non-comparable to each other, to make the function adaptive, an interface designer may arrange the function's settings in a linear sequence from the least biased towards a certain outcome to the most biased towards that outcome and then implement the following interface behavior: When the interface evaluates the outcome of a decision of this decision class, if the decision had a non-beneficial outcome, the interface will select the setting that would have yielded a beneficial outcome that is nearest in the sequence to the current setting.

If a non-adaptive decision function is a simple decision function that has only two possible outcomes, or if it is a smart decision function that has only two possible outcomes that has one simple setting for each of the two possible outcomes and that also has a single smart setting, then in either case two of the three preceding paragraphs will be applicable, and it does not matter which of the two paragraphs is applied: the same interface behavior will result either way. For example, the example decision function fits the criteria described in the second and third of the preceding three paragraphs. To apply the procedure described in the third paragraph, an interface designer may arrange the function's settings in the sequence DEC, then AUTO, then FRAC-APPROX, and then implement the interface behavior such that when the interface evaluates the outcome of a decision of this decision class, if the decision had a non-beneficial outcome, the interface will move the setting only one position in the sequence if that would have yielded a beneficial outcome, or two positions otherwise. In other words, if the smart setting AUTO was not selected and would have yielded a beneficial outcome, the interface will select AUTO; otherwise, the interface will select the simple setting that would have yielded a beneficial outcome. This is the exact same behavior that would result from applying the procedure described in the second paragraph.

Above, the interface behavior that would be achieved by applying the full three-step procedure is described via terminology that pertains to setting adaptation maps. A programmer of ordinary skill in the art will be able to create data structures that represent setting adaptation maps; as a starting point, source code for data structures that represent graphs, vertices, and so forth is readily available online. However, as can be seen from the above discussion of simpler procedures that achieve the same results as the full three-step procedure for certain specific types of decision functions, it is possible for a programmer to implement most adaptive decision functions by means of simpler algorithms that can use simpler data structures.

### Making Probabilities of Alteration Adaptive

In an embodiment, interface adaptation not only may affect the outcome of future decisions of an alterable decision class, but also may affect the probability of alteration that is assigned to future decisions of an alterable decision class.

As an aid to implement such behavior, for any adaptive alterable decision function that makes use of a setting adaptation map as described above, an interface designer may add a distance metric to the setting adaptation map. That is, the interface designer may assign to each edge (direct connection) in the setting adaptation map a numeric value that represents its length, which is an approximate measure of the magnitude of the difference between the two settings the edge connects, in the judgment of the interface designer. For example, if a setting adaptation map has only two setting vertices that correspond to simple settings that make opposite choices, the edge connecting those two vertices will be assigned a high length, but if a setting adaptation map has dozens of vertices arranged sequentially such that each vertex in many situations will yield the same outcome as both of its adjacent vertices, then an edge connecting any two vertices will be assigned a low length. Also, if for any outcome the maximally biased setting in the setting adaptation map is a setting that sometimes does not select that outcome, then the interface designer may add to the setting adaptation map a simple setting that would always select that outcome, and directly connect that simple setting to only the setting that was previously the maximally biased setting for that outcome, and assign an appropriate length to the edge connecting those two settings; if desired, the interface designer may prevent such an additional simple setting from ever being selected, so that it is not included in the setting adaptation map for purposes of automatically adjusting settings as described above, but is included in the setting adaptation map for purposes of determining probabilities of alteration as described below.

In an embodiment, when the interface makes an alterable decision of a decision class that has a setting adaptation map with a distance metric as described in the preceding paragraph, the probability of alteration that is assigned to an alternate option of the decision is inversely related to the total length of the simple path between the current setting and the setting vertex that will be the nearest beneficial setting if that option becomes selected, so that if the current setting is very close to a setting that would have yielded that outcome than its probability of alteration will be high, but if it is far from a setting that would have yielded that outcome than its probability of alteration will be low. For example, if each of the two edges in the example decision function's setting adaptation map are assigned a length of 1, and the user types input that includes a fraction, and the interface makes an alterable decision using the example decision function, and the interface chooses to display the answer as a fraction, then at this point the setting that is selected must be either FRAC-APPROX or AUTO: if it were DEC, the interface would have chosen to display the answer as a decimal. The probability of alteration of this decision depends on which setting is selected. If the setting that is selected is AUTO, then the distance to the only setting that would have yielded a different outcome is 1, but if the setting that is selected is FRAC-APPROX, then the distance to that setting is 2, so the probability of alteration of the decision will be higher if the setting that is selected is AUTO than if it is FRAC-APPROX. This is appropriate: if the user caused the simple setting to become selected such that an answer would be displayed as a fraction even when the input did not include a fraction, then it is that much less likely that the user will want some different outcome now that the input actually includes a fraction.

The behavior described above causes the interface to adjust not only future decision outcomes but also future probabilities of alteration after a decision has a non-beneficial outcome. It may also be advantageous to cause the interface to adjust future probabilities of alteration even when a decision has a beneficial outcome: if a decision repeatedly has a beneficial outcome, it may be advantageous for its probability of alteration to gradually decrease. Therefore, in an embodiment, for some or all adaptive decision classes, in addition to remembering what setting is currently selected for that decision class, the interface will also remember an optional distance penalty for each possible outcome of that class. After the interface makes a decision of such a class, when the interface determines the outcome that was beneficial or would have been beneficial, the interface will reset that outcome's optional distance penalty to zero, and will slightly increase the optional distance penalty of all other outcomes. Whenever the interface makes a decision of such a class, when the interface would determine the probability of alteration to assign to an alternate option by means of determining the total length of the simple path between the current setting and the setting vertex that will be the nearest beneficial setting if that alternate option becomes selected, the interface will also add the current value of the optional distance penalty for that particular outcome. In such an embodiment, for such a decision class, if the same outcome repeatedly turns out to be beneficial, then the optional distance penalty for all the other outcomes will gradually increase, and so the probability of alteration of the decisions of that class will gradually decrease.

Just as it is possible for a programmer to implement most adaptive decision functions by means of algorithms that use simpler data structures than a setting adaptation map, it is also possible in most cases for a programmer to implement the same behavior that is described in the preceding paragraphs by means of algorithms that use simpler data structures than a setting adaptation map. In particular, if an adaptive decision function has only two possible outcomes and has no non-comparable settings, then its setting adaptation map may consist of an arrangement of the function's settings in a linear sequence, so the algorithm for measuring the total length of the path from one setting to another can be quite simple.

### Making Simple Decisions Adaptive

In the simplest case, a decision function will have only two possible outcomes, and only two simple settings. For example, a decision whether or not to automatically capitalize a day of the week may be a simple decision between two possible outcomes that never takes context into account. A setting adaptation map may be constructed for such a decision that has only two simple setting vertices with one edge connecting them.

Therefore, in an embodiment, for some or all alterable decision classes that have two possible outcomes and that never take context into account, the interface will keep track of which outcome it currently prefers for each decision class and keep track of a single optional distance penalty that will always represent the optional distance penalty for whichever outcome it does not currently prefer. Such an optional distance penalty may be initialized to have a relatively high value if the interface designer is relatively confident that a typical user will have a strong preference for the outcome that the interface initially prefers. When the interface makes a decision of such a class, the default outcome will be the outcome the interface initially prefers, and the probability of alteration will depend only on the current value of the optional distance penalty. Whenever such a decision has a non-beneficial outcome, the interface will change which outcome it prefers and reset the optional distance penalty to 0, so that the next time it makes such a decision, the decision's probability of alteration will be very high; whenever such a decision has a beneficial outcome, the interface will slightly increase the optional distance penalty, so that the next time it makes such a decision, the decision's probability of alteration will be slightly less than before.

### Making Threshold Decisions Adaptive

As defined in Chapter 3, a threshold decision class is a decision class that has two possible outcomes, where the outcome of any particular decision depends on whether or not a decision score that is based on circumstances exceeds a certain threshold value.

In an embodiment, some or all threshold decision classes will be adaptive decision classes such that the threshold itself is not a constant value, but is instead a setting variable that can take on various values. Any possible threshold value is thus a distinct setting. If the possible threshold values are arranged in a linear sequence, then this constitutes a setting adaptation map. As a distance metric for such a setting adaptation map, the distance between any two possible threshold value simply equals the difference between the values.

For such an adaptive threshold decision class, if a decision of that class has a non-beneficial outcome and so the interface causes the nearest beneficial setting to become selected, this means that the interface changes the threshold just enough that the decision would have had a beneficial outcome if the change had occurred before the decision. For example, if before a decision a threshold value is 5.0, and the decision score for the decision is 7.3, and this decision has a non-beneficial outcome, then the interface will change the threshold value from 5.0 to 7.3 (or to infinitesimally more than 7.3 if necessary) because this is the closest threshold value that would have caused the decision to have a different outcome. In an embodiment that determines probabilities of alteration for adaptive decisions by means of a distance metric as described above, unless an optional distance penalty is present, the probability of alteration of such a threshold decision will simply be based on the difference between the decision score and the threshold value: the probability of alteration that is assigned to such a decision will be high if the decision score is almost the same as the threshold value, or low if the decision score is much lower or much higher than the threshold value. This turns out to be exactly the same principle for assigning probabilities of alteration to threshold decisions that was described in the initial explanation of threshold decisions. However, in an embodiment that includes optional distance penalties as described above, when an optional distance penalty is present, the interface may assign a lower probability of alteration to a threshold decision than it otherwise would.

### Chapter 21: Decision Function Customization

### Adding Smart Settings

Without interface adaptation functionality, it may not be very advantageous for a decision function to have more than one distinct smart setting: if two distinct smart settings would turn out to be particularly appropriate for two different types of users, then many users would not actually make the effort to understand the smart settings in order to select the appropriate one. However, in an embodiment with the interface adaptation functionality that is described above, if two distinct smart settings would turn out to be particularly appropriate for two different types of users, that for each particular type of user, interface adaptation could cause the smart setting to become selected that would be particularly appropriate for that user. Thus, interface adaptation functionality may make it more advantageous for a decision function to include additional distinct smart settings.

In many cases, it may be possible for an interface designer to guess in advance the circumstances in which certain users will desire each particular outcome for a particular decision function. Generally, if an interface designer has a plausible theory regarding the circumstances in which certain users will desire a particular outcome for a particular decision function, and if this theory can be reduced to a function that selects each particular outcome in exactly the circumstances where the interface designer believes certain users will desire that outcome, then it may be advantageous for the interface designer to implement that particular function as an additional smart setting-specific function for that particular decision function.

In particular, once an interface designer has made a decision function be an adaptive decision function by the means described above, it may be advantageous for the interface designer to convert any empty vertex in the decision's setting adaptation map into a setting vertex that is associated with an appropriate smart setting-specific function. It may also be advantageous for the interface designer to insert additional vertices into the setting adaptation map between other vertices, and to have the added vertices be associated with appropriate smart setting-specific functions. In the present paragraph, an “appropriate smart setting-specific function” is a setting-specific function that fits the necessary requirements so that the setting adaptation map continues to be a setting adaptation map as defined above.

For example, if the example decision function did not have the AUTO setting, its setting adaptation map would consist of two setting vertices directly connected to each other—namely, the DEC vertex and the FRAC-APPROX vertex. An interface designer might guess in advance that certain users will desire an answer to be displayed as a fraction when and only when the user's input included a fraction. A setting-specific function that chooses the fraction form when and only when the user's input includes a fraction can be implemented; that is what the AUTO setting-specific function is. The AUTO setting vertex can be inserted in the setting adaptation map between the DEC vertex and the FRAC-APPROX vertex. An interface designer also might guess that certain other users will desire an answer to be displayed as a fraction when the user's input included a fraction, unless the user's input also included a decimal point. A new setting-specific function that behaves accordingly can be inserted in the setting adaptation map between the AUTO vertex and the DEC vertex. Between the vertex of this new setting-specific function and the AUTO vertex, another vertex can be inserted corresponding to a setting-specific function that chooses the fraction form when the user's input included a fraction, unless the number of decimal points in the user's input was more than the number of fractions in the user's input. Each additional smart setting may increase the chance that interface adaptation will eventually cause a setting to become selected that accurately reflects the strength of a particular user's preference for a particular outcome.

### Converting to Threshold Decisions

When a decision has only two possible outcomes, and its setting adaptation map consists of an arrangement of the function's settings in a linear sequence, if the decision is not a threshold decision, then it can necessarily be replaced with a threshold decision that always yields exactly the same results as the original decision.

For example, as one way to do so, the function's settings may be numbered from left to right. If an interface designer has assigned edge lengths to the edges between the setting nodes on the setting adaptation map in order to add a distance metric to the setting adaptation map, then numbers may be assigned to the function's settings in such a way that the number assigned to each setting node (other than the leftmost) equals the number of the previous setting node plus the length of the connecting edge. Next, an algorithm may be implemented that yields decision scores that fit the following criteria: in any particular decision context such that the interface's decision between the two possible outcomes depends on which setting is selected, the decision score equals the average of the two numbers of the adjacent settings that would yield different outcomes; in any decision context such that the interface's decision is certain to have a particular outcome and does not depend on which setting is selected, if the setting that is most biased against that outcome is on the far left, then the decision score equals that setting's number minus a certain amount, such as 0.5; if it is on the far right, the decision score equals that setting's number plus a certain amount, such as 0.5. Finally, once the interface can calculate a decision score that is based on context this way, if the interface makes a threshold decision using this decision score and with a threshold value that is equal to the number of the setting that is currently selected, then this threshold decision will always yield exactly the same outcome that the original decision function would have yielded, and can thus serve as a replacement for the original decision function.

For example, the example decision function has only two possible outcomes, and its setting adaptation map may consist of the settings DEC, AUTO, and FRAC-APPROX arranged in a line in that order. Those settings may be numbered DEC 1, AUTO 2, and FRAC-APPROX 3. The interface may calculate a decision score in any particular circumstances as follows: If the user's input included a fraction, then the DEC 1 setting would yield a different outcome than the AUTO 2 setting, so the decision score is 1.5. If the user's input did not include a fraction, then the AUTO 2 setting would yield a different outcome than the FRAC-APPROX setting, so the decision score is 2.5. If a threshold decision function calculates a decision score in this way, and then compares the decision score to a threshold value that is equal to the number of the setting that is currently selected and chooses to display an answer as a decimal if and only if the decision score exceeds the threshold value, then this new threshold decision function will always yield exactly the same outcome that the example decision function would have yielded. For example, by this method, when the AUTO 2 setting is selected, this threshold decision function will choose to display an answer as a fraction if and only if the decision score is less than 2; the decision score will be less than 2 only when an answer can be displayed as a fraction and the user's input included a fraction, and these are the same circumstances that are described above such that the setting-specific function for the AUTO setting will display an answer as a fraction.

As another example, if a decision function is a simple decision function with just two settings corresponding to the two possible outcomes, then it can be replaced with a threshold decision function that always has a constant decision score. One of its two settings will then correspond to a threshold value that is below this decision score, and the other will correspond to a threshold value that is above this decision score. For example, in an embodiment, the interface's decision whether or not to automatically capitalize the word “Tuesday” is always based on a decision score of 1.0, and the outcome will vary depending on whether the threshold value is set to 0.0 or 2.0.

It is thus possible to convert certain decision functions to threshold decision functions without changing their behavior. One advantage of doing so is that a threshold decision necessarily has a distance metric and can thus be made to have adaptive probabilities of alteration that are calculated based on distance, as described above. For example, in an embodiment where the example decision function has been converted to a threshold decision as described above, if the setting DEC 1 is selected, then the interface will display an answer as a decimal regardless of whether or not the user's input included a fraction, but if the user's input included a fraction then the decision score will be 1.5, which is relatively close to the threshold value of 1, so the probability of alteration will be higher than if the user's input did not include a fraction, which makes intuitive sense: a user who has typed a problem involving fractions is probably more likely to want to switch to a fraction answer.

Another advantage of converting a decision to a threshold decision is that it then becomes relatively easy to modify the function so it takes into account additional contextual information: if an interface designer can think of any particular contextual factor that probably ought to increase a particular threshold decision function's tendency to favor one outcome over another, then the interface designer can modify the decision function so as to increase or decrease the decision score based on that contextual factor. For example, an interface designer may think about the example decision function that was converted to a threshold decision function as described in the preceding paragraphs, and may think that if a user's input includes a fraction, but the user's input also happens to include several decimal points, then maybe it is not as likely that the user will want the answer to be a fraction. The interface designer can then accordingly modify the decision function, such as by increasing the decision score by 0.1 for each decimal point in the user's input, up to a maximum increase of 0.5. When a function is a threshold decision function, it is relatively easy to perform such modifications. Of course, the disadvantage of such modifications is that they may cause a decision function to become too complex for a user to understand its behavior, which may occasionally lead to interface mistakes—but in some embodiments, the present invention may mitigate the disadvantages of interface mistakes, so it may be relatively easy to modify a threshold decision in a way that confers a net advantage for most users.

It may be advantageous to implement even the simplest interface decision as a threshold decision, for reasons that are discussed in the two preceding paragraphs; therefore, in an embodiment, most or all interface decisions are threshold decisions, unless otherwise specified. In particular, in an embodiment, any interface decision that is described herein in very simple terms as an alterable decision to choose one alternative over another is actually implemented as an adaptive threshold decision. If a particular alterable decision class does not take context into account, then its decision score will always equal a constant value, but its threshold may vary as interface adaptation occurs. For example, if the present specification were to say that “any interface decision to automatically convert a numeral after a variable into an exponent is an alterable decision,” this would mean that in an embodiment, such a decision is also an adaptive threshold decision; for example, its decision score may always equal 1.0, and the initial threshold value of that decision class may initially be 0.1 so that decisions of that class by default have a very low probability of alteration, but interface adaptation may change this threshold value so that such decisions have a different probability of alteration or even a different default outcome.

### Customizing Probabilities of Alteration

In an embodiment, generally, as is discussed farther above, when the interface makes a score-based decision that is an alterable decision, the probability of alteration that is assigned to an alternate option of that decision will be high when the score gap of that alternate option is relatively low, and will be low when the score gap of that alternate option is relatively high.

In an embodiment, the specific details of the way in which a probability of alteration is calculated based on a score gap may be different for various score-based decisions. This may be advantageous because various decisions may have completely different scoring scales, and also because some decisions should perhaps be always alterable with at least a certain minimum probability of alteration, while other decisions should perhaps be conditionally alterable. Also, for a threshold decision, the way in which a probability of alteration is calculated based on the score gap may be different depending on whether the decision score is above or below the threshold value.

In an embodiment, for certain score-based decision classes, probabilities of alteration will will take into account gradations of the score gap, so that, for example, small increases in the score gap will cause small decreases in the probability of alteration.

For example, in an embodiment, initial probabilities of alteration of alterable interface decisions typically range from a minimum of 0.0 (which is extremely low) to a maximum of 5.0 (which is very high). In an embodiment, the interface alterably decides whether or not to respond to two consecutive actuations of the same particular key as a special rapid double-click actuation, and the decision score for such a decision is the number of seconds that elapse between the two consecutive actuations. If the decision score is below the threshold value, then the probability of alteration equals 5.0 minus 10 times the score gap, to a minimum of 2.0, so that for example a score gap of 0.2 seconds yields a probability of alteration of 3.0; if the decision score is above the threshold value, then the probability of alteration equals 5.0 minus 5 times the score gap, to a minimum of 2.0. As another example, in an embodiment, the interface alterably decides whether or not to display an answer as a fraction based on a certain decision score that is based on circumstances, and the probability of alteration for such a decision simply equals 5.0 minus the score gap, except that if the score gap is greater than 5.0 then the decision is not alterable.

### Making Decisions Smarter

Generally, an interface designer should understand that incorporating various features that are described herein may decrease the need for interface simplicity. When a decision is an alterable decision, in some cases it may not be important for a user to understand how the interface determines the outcome of such a decision; it may be more important for the interface to be as smart as possible in selecting the outcome the user is most likely to desire, even if this leads to occasional interface mistakes. Even more so, when a decision is an alterable decision, it may not be especially important for a user to understand how the interface determines the probability of alteration to assign to such a decision, so even when it is somewhat important for a particular interface decision to be relatively simple, the determination of the probability of alteration for such a decision may be quite complex.

Generally, the challenge of making a particular decision function be relatively intelligent can be divided into three components: identifying criteria that should be taken into account by the decision function; determining how to take the criteria into account, and mitigating the problems caused by any non-beneficial outcomes of the decision function.

The present specification cannot delineate all the criteria that should be taken into account for all possible interface decisions. The present specification explains criteria that may be relevant for certain particular interface decision classes, but an interface designer may also wish to make other decision functions be relatively intelligent that are beyond the scope of the present specification. Generally, an interface designer can identify relevant criteria by simply creating example cases in which the interface designer believes it is reasonably clear that the interface should select a particular outcome and then asking himself what contextual information makes it clear that the interface should select that outcome. (It may also be advantageous to create example cases in which the interface designer believes it is not especially clear what outcome the interface should select, for reasons that are discussed in the following paragraph.) In some cases, the criteria that decision functions should take into account will be obvious to those of ordinary skill in the art; in other cases, the criteria that decision functions should take into account may require unusual insight.

Once an interface designer has identified criteria that should be taken into consideration by a decision function, an interface designer will need to determine how the decision function should take the criteria into account. In many cases, it may be appropriate for an interface designer to quantify the criteria that are involved. An interface designer may then create a spreadsheet listing the quantified values of the various inputs of the decision for various example cases, along with the preferred outcomes for the decision in those example cases. The interface designer may then attempt to determine some type of formula that produces suitable decision scores that will cause the interface to yield the preferred outcome for most of these example cases, and cause it to yield a high probability of alteration in most cases where it does not yield the preferred outcome or where the interface designer does not strongly prefer one particular outcome. In many cases, an interface designer may be able to arrive at a reasonably good formula with just a little bit of ad hoc effort. Interface designers should also keep in mind that at this stage the problem of optimizing the decision function is essentially a problem of abstract mathematical analysis, and so it is a generic enough problem that a vast amount of prior art expertise is applicable: those with ordinary skill in various fields such as artificial intelligence or statistical process control will be familiar with techniques that may prove helpful. (In fact, certain relevant techniques can be automated and incorporated into the interface software, so that the formula used by a decision function can adapt based on actual results for a particular user.)

No matter how well an interface designer does at identifying criteria that should be taken into account by a decision function and determining how to take the criteria into account, it is virtually inevitable that any decision function will occasionally yield undesired results—and the smarter the decision function is, the more likely it is that these undesired results will be unexpected and will thus be frustrating interface mistakes. It may thus be desirable for an interface designer to include interface features that facilitate recovery from such mistakes. Facilitating recovery from undesired outcomes may be desirable not only because it is inevitable that such outcomes will occasionally occur regardless of how smart a decision function is, but also because it may not always be desirable for an interface designer to spend a lot of time and effort trying to make a decision function as smart as possible. If it is very easy to recover from interface mistakes, then may not be essential for a smart decision function to always be right.

Of course, the alteration functionality that is described herein may serve as a generic means of facilitating recovery from interface mistakes, in some embodiments, and may be usefully applied to a wide variety of decision functions. It may sometimes be advantageous for an interface designer to create new mistake recovery features that are particularly useful for recovering from certain specific types of undesired outcomes, but generally, in an embodiment, in order to make sure that it is easy to recover from undesired outcomes, an interface designer need only make such outcomes alterable. The alteration functionality that is described herein may thus greatly reduce the effort an interface designer needs to make in order to facilitate recovery from interface mistakes. Also, by virtue of being generic and applicable to a wide variety of decision functions, the alteration functionality that is described herein may be easier for a user to learn than ad hoc mistake recovery features: a user who has used alteration functionality to fix one particular type of interface mistake may already understand how to use alteration functionality to fix other types of interface mistakes.

Thus, in an embodiment that has certain alteration functionality that is described herein, it may be easy for an interface designer to mitigate the problems caused by non-beneficial outcomes of a decision function, which means that it may not be essential for the interface designer to do especially well at identifying criteria that should be taken into account by the decision function and determining how to take the criteria into account: the interface designer can make a decision function be reasonably smart without the need to worry much about its imperfections.

For example, one of the inventors decided to create a smart interface decision function that decides whether or not to display an answer to a mathematical calculation as a fraction. After much thought, he decided that it is generally more desirable to display an answer as a fraction when the answer can be displayed as a fairly simple fraction, and when the problem the user typed includes fractions, and when the most recent previous answer was displayed as a fraction. It is generally less desirable to display an answer as a fraction when it would have many digits in its denominator, and when it is a very large number, and when the problem the user typed includes decimals, and when the most recent previous answer was not displayed as a fraction. After some additional thought, he decided that if an answer can be displayed as a fraction that is rather complicated then the interface should be somewhat biased against displaying the answer as a fraction, but the bias should not be as strong if the problem the user typed included a fraction that was equally complicated. He spent several hours fiddling with a spreadsheet to create a smart threshold decision function that takes all these criteria into account and yields outcomes that mostly appear to make sense. This decision function is described in Chapter 50. This decision function may not be perfect, but it may be significantly smarter than prior art, and it does not need to be perfect: in an embodiment, a non-beneficial outcome can typically be corrected with a single keystroke. Likewise, an interface designer can make other decision functions be relatively intelligent that are beyond the scope of the present specification, without the need to worry much about their imperfections.

### Increasing Decision Consistency

Generally, it may be advantageous for consecutive interface decisions of the same decision class to tend to yield the same results. If the interface makes a threshold decision as explained above such that the decision score is just barely below the threshold value, and then soon afterward the interface makes a threshold decision of the same decision class such that the decision score is just barely above the threshold value, then the fact that the two decision scores are very close to one another indicates that the circumstances of the two decisions were very similar as for the interface can tell, so the user may not expect the second decision to yield a different outcome than the first. For example, if the interface's decision whether to respond to two consecutive actuations of the same particular key as a special rapid double-click actuation is a threshold decision that is based on the amount of time that elapses between the two consecutive actuations, and the threshold value is 1.00 seconds, then if a user has recently actuated the key twice with 0.97 seconds between the actuations and so the interface treated that as a special rapid double-click actuation, then if the user now actuates the key twice with 1.01 seconds between the actuations, the user may not expect the second pair of actuations to yield a different outcome than the first.

Therefore, in an embodiment, certain threshold decisions may have an “outcome repetition bias.” For any particular threshold decision class, if that decision class has a certain “maximum outcome repetition bias,” then this means that immediately after a decision of that class, the “current outcome repetition bias” will be set to equal that maximum amount, and the interface will remember the decision score of that decision. Whenever the interface makes its next decision of that class, if the difference between the decision score of the new decision and the decision score of the previous decision is less than the current outcome repetition bias, but the decision score of the new decision is on the other side of the threshold value and so the interface would ordinarily select a different outcome than the previous time, then instead the interface will modify the decision score of the new decision just enough that it is on the same side of the threshold value as the decision score of the previous decision, so that the interface will decide to select the same outcome as before and this decision will have an extremely high probability of alteration. For example, if the decision class mentioned in the preceding paragraph has an outcome repetition bias of 0.10 seconds, then if a user actuates the key twice with 0.97 seconds between the actuations and soon thereafter actuates the key twice with 1.01 seconds between the actuations, the decision pertaining to the second pair of actuations will necessarily have the same outcome as the decision pertaining to the first pair. As another example, a threshold decision regarding whether to display an answer as a mixed fraction or as an improper fraction is described in Chapter 50, and this decision has a maximum outcome repetition bias of 3.0, so if the interface makes a decision of this class with a decision score of 1.5 and then immediately thereafter makes another decision of this class with a decision score of −0.5, these two decisions will necessarily have the same outcome.

In an embodiment, however, for certain such decision classes, a “context break” may occur that will cause the interface to reduce the current outcome repetition bias. In various embodiments, for various decision classes, the interface may use different criteria to determine when such a context break occurs. Generally, whenever the interface has some indication that a previous decision's outcome is no longer as likely to influence a user's expectations, such an indication may constitute a context break.

In particular, in an embodiment, if a certain amount of time passes during which no decision of a particular class occurs, this may constitute a context break. For example, in an embodiment, for a threshold decision class that has a maximum outcome repetition bias of 3.0, the current outcome repetition bias will be reduced by 0.1 each minute, so that a previous decision of that class will not affect the next decision of that class if 30 minutes elapse between the two decisions.

In an embodiment, whenever the interface makes a composite decision, for any component decision class that is not involved in the composite decision, this may constitute a context break. For example, in an embodiment, if the interface's decision regarding what form to display the answer to a calculation in is a composite decision, and the composite decision includes a component decision regarding whether to display an answer as a mixed fraction rather than an improper fraction, then whenever a user types a problem such that the answer cannot be displayed as a fraction at all, this will constitute a context break for purposes of that component decision class.

In an embodiment, when a user edits a different document, this may constitute a context break.

Other ways of determining in various embodiments what constitutes a context break for various decision classes will be evident to those of ordinary skill in the art.

### Customizing Adaptation Tendencies

In many cases, after an interface decision has a non-beneficial outcome, it will be advantageous for the interface to cause the nearest beneficial setting to become selected, and then leave that setting selected until the next time a decision of that class has a non-beneficial outcome. However, in some cases, for certain decision classes, an interface designer may know or believe that such adaptation behavior may not be optimal. Of course, even if such adaptation behavior leads to non-beneficial outcomes, in some embodiments, the interface mitigates the disadvantages of non-beneficial outcomes; nevertheless, it may be advantageous for an interface designer to cause certain decision classes to adapt to user behavior in slightly different ways.

In particular, it may be advantageous for a decision class to equally take into account all past outcomes of decisions of that class rather than adapting based on the most recent outcome. It may be advantageous for a decision class to resist adapting to the point where an outcome that is not usually desirable becomes the default outcome. It may be advantageous for a decision class where an outcome that is not usually desirable has become the default outcome to automatically revert to a more normal setting in certain circumstances. Such behaviors are described below.

The adaptation behaviors that are described above and the adaptation behaviors that are described below give an interface designer a variety of approaches that can be used to create adaptive decision classes that generally yield good results. However, other ways of customizing adaptation behavior may occasionally be especially advantageous for specific decision classes. For example, in Chapter 48, the present specification describes a decision class that decides between a radian input mode and a degree input mode; for that particular decision class, if a user includes in the same line of input some angles that are measured in radians and other angles that are measured in degrees, then the interface will not select a setting that is strongly biased towards either radians or degrees until the user moves on to the next line of input.

### Adaptation that Considers Past History

In an embodiment, for some decision classes, when the interface determines whether a particular decision of that class had a beneficial or non-beneficial outcome, rather than changing the threshold value based on the outcome of just that particular decision so as to ensure that the decision would have had a beneficial outcome if the change had occurred before the decision, the interface will instead recalculate the threshold value based on the history of the outcomes of all decisions of that class, or some more recent subset of the decisions of that class. Such behavior may be advantageous for a decision class where it is relatively unlikely that a user's preferences will change over time (in the judgment of the interface designer), and so other past outcomes may provide information that is just as relevant as the most recent outcome.

In particular, in an embodiment, for some threshold decision classes, when the interface determines whether a particular decision of that class had a beneficial or non-beneficial outcome, the interface will then set the threshold value of that decision class to be a value that would have caused non-beneficial outcomes to be divided between the two possible outcomes of the decision as equally as possible. For example, consider an embodiment where the interface decides whether or not to treat two consecutive actuations of the same particular key as a special rapid double-click actuation, and this is an adaptive threshold decision that is based on the amount of time that elapses between the two consecutive actuations. Suppose the interface has made seven decisions of this decision class. On four occasions, treating the consecutive actuations as a double-click actuation was beneficial or would have been beneficial; on those occasions, the amount of time that elapsed was 0.5 seconds, 0.3 seconds, 0.5 seconds, and 0.6 seconds. On three occasions, treating the consecutive actuations as two distinct actuations was beneficial or would have been beneficial; on those occasions, the amount of time that elapsed was 1.2 seconds, 0.7 seconds, and 2.0 seconds. As a result, the threshold amount of time for this decision class is now somewhere between 0.6 and 0.7 seconds. If a user now actuates the key twice consecutively with 1.3 seconds between the actuations, the interface will alterably treat this as two distinct actuations. If this decision turns out to have a non-beneficial outcome, then in an embodiment, the interface will not adjust the threshold amount of time past 1.3 seconds; instead, the interface will set the threshold amount of time to be somewhere between 0.7 seconds and 1.2 seconds, which is a threshold that would have caused this decision class to yield non-beneficial outcomes that would have been divided equally between the double-click actuation outcome and the distinct actuations outcome: on the one hand, the recent decision not to treat two consecutive actuations that were separated by 1.3 seconds as a double-click actuation would still have had a non-beneficial outcome, and on the other hand, the decision to treat the earlier two consecutive actuations that were separated by 0.7 seconds as a double-click actuation would also have had a non-beneficial outcome. In essence, in such an embodiment the interface may thus adjust a threshold value so that it is sort of an average desirable value based on all previous user behavior, rather than a minimally desirable value based on the most recent user behavior.

### Adaptation that Avoids Extremes

In an embodiment, some adaptive decision classes are “adaptation-resistant decision classes.” By various means, the interface may resist adapting in such a way as to cause certain settings of an adaptation-resistant decision class to become selected. That is, using the terminology of setting adaptation maps, when the interface determines that an adaptation-resistant decision had a non-beneficial outcome, in certain circumstances the interface may not necessarily cause the nearest beneficial setting to become selected. Such behavior may be advantageous for a decision class where certain settings are so unlikely to yield beneficial outcomes that in the judgment of the interface designer, it is relatively unlikely that such a setting would yield a beneficial outcome for the next decision even when the interface has just determined that the setting would have yielded a beneficial outcome for the most recent decision.

In particular, in an embodiment, within the setting adaptation map of an adaptation-resistant decision class, a setting node may have an “inherent adaptation resistance value,” or an edge within the map may have an inherent adaptation resistance value, or an edge may have such a value for purposes of traversing the edge in one direction but not for purposes of traversing the edge in the other direction. Every setting or edge that has an inherent adaptation resistance value will also have a “current adaptation resistance value” that is initially equal to its inherent adaptation resistance value. If a decision of that class has a non-beneficial outcome and so the interface determines the path to the nearest beneficial setting, if at some point following that path would cause the interface to traverse an edge or reach a setting node that has a current adaptation resistance value that is greater than zero, then that edge or setting will block the path: the interface will not select the nearest beneficial setting, but will instead select the node that is immediately before the edge or node that has a current adaptation resistance value that is greater than zero, and will decrease that current adaptation resistance value by one. The interface will also reset all current adaptation resistance values on that setting adaptation map other than the one it just decreased back to their inherent adaptation resistance values. Whenever a decision of that class has a beneficial outcome, the interface will reset all current adaptation resistance values on that setting adaptation map back to their inherent adaptation resistance values. In other words, in such an embodiment, the interface may resist adapting so as to cause a particular setting to become selected until its failure to adapt causes a non-beneficial outcome to occur a certain number of times in a row.

Of course, in most cases a programmer can implement the same behavior that is described in the preceding paragraph by means of algorithms that do not use setting adaptation maps. For example, in an embodiment, when the interface alterably decides to automatically capitalize the word after “Mr.”, the interface will simply keep count of how many consecutive times this yields a non-beneficial outcome, and will adapt so as to stop automatically capitalizing the word after “Mr.” only if its decisions to automatically capitalize the word after “Mr.” yield non-beneficial outcomes three times in a row.

In an embodiment, as another means of making an adaptive decision class be adaptation-resistant, for a class that has a setting adaptation map with a distance metric as described above, when a decision of that class has a non-beneficial outcome, the interface may restrict its adaptation so that rather than necessarily causing the nearest beneficial setting to become selected, it will proceed as far as possible along the path from the currently selected setting to the nearest beneficial setting subject to the restriction that it will thus traverse only a certain maximum adaptation distance before it stops. In an embodiment, in addition to keeping track of which particular setting is selected for a particular adaptive decision class, the interface may also keep track of how much progress has been made from that setting towards an adjacent setting along the connecting edge. For example, if a setting adaptation map has three settings arranged sequentially, and the length of each of the two connecting edges is 5, and the leftmost setting is currently selected and no progress has been made towards the center setting, then if the interface determines that a decision of that class had a non-beneficial outcome and the nearest beneficial setting is the rightmost setting, then if the maximum adaptation distance the interface will traverse along this setting adaptation map is 3, the interface will not arrive at the rightmost setting; it will not even reach the center setting. Instead, it will proceed so that it is ⅗ of the way from the leftmost setting to the center setting; then if the next decision of that class again has an outcome such that the nearest beneficial setting is the rightmost setting, the interface will select the center setting and proceed so that it is ⅕ of the way from the center setting to the rightmost setting.

Various other ways of making an adaptive decision class be adaptation-resistant will be evident to those of ordinary skill in the art. An interface designer can mix various approaches as desired in order to make a particular decision class adapt in a way that the interface designer believes will be advantageous. For example, in an embodiment, for some particular decision class that has one outcome that is usually desirable and another outcome that is rarely desirable (in the opinion of the interface designer), when a decision of that class has a non-beneficial outcome, if the outcome that is usually desirable is the one that would have been desirable, the interface will adapt normally, but if the outcome that is rarely desirable is the one that would have been desirable, then the interface will resist adaptation somewhat: it will proceed along the path towards the nearest beneficial setting, but it will traverse only a certain maximum distance before it stops, where the maximum distance is either a constant adaptation distance or half the distance to the nearest beneficial setting, whichever is greater.

### Adaptation that Reverts from Extremes

In an embodiment, for some adaptive decision classes, one or more settings are “extreme settings” such that if an extreme setting is selected when a context break occurs, then the interface will “revert” from the extreme setting, which means that it will either adjust its settings so as to cause the extreme setting to no longer be selected, or it will at least adjust its settings so as to move towards eventually causing the extreme setting to no longer be selected without yet actually doing so. Such behavior may be advantageous for a decision class where certain settings are relatively likely to be disadvantageous in the future, even if they are advantageous currently.

For example, in an embodiment, for each extreme setting a target setting will exist such that if the extreme setting is selected when a context break occurs, then the interface will select its corresponding target setting. Such a target setting may itself be an extreme setting that is less extreme, so that if another context break occurs, the interface will again select a different setting.

Alternatively, in an embodiment, for a decision class that has two possible outcomes and thus has a setting adaptation map that is an arrangement of the function's settings in a linear sequence from the least biased towards a certain outcome to the most biased towards that outcome, if the setting adaptation map has a distance metric as described above, then a certain edge on the setting adaptation map may constitute a boundary between non-extreme settings and extreme settings, and if the setting that is selected is on the extreme side of that boundary when a context break occurs, then the interface will travel a certain fraction of the distance back towards the non-extreme side of that boundary. For example, in an embodiment, if an extreme setting is selected when a context break occurs, then the interface will adjust the relevant setting variable by an amount equal to half the distance towards the nearest non-extreme setting, rounded up.

Other ways of configuring a particular decision class to revert from an extreme setting if it is selected when a context break occurs will be evident to those of ordinary skill in the art.

In various embodiments, for various decision classes, the interface may use different criteria to determine when a context break occurs. Generally, whenever the interface has some indication that the user's previously expressed preference for a particular extreme setting may no longer apply, such an indication may constitute a context break. In particular, if a certain amount of time passes during which no decision of a particular class occurs, this may constitute a context break. Whenever the interface makes a composite decision, for any component decision class that is not involved in the composite decision, this may constitute a context break. When a user edits a different document, this may constitute a context break. For example, in an embodiment, if the interface has adapted so that it will no longer automatically capitalize names of days of the week, this may be applicable only until the user exits the current document, so when the user edits a different document this may constitute a context break that will cause the interface to revert to automatically capitalizing names of days of the week. Other ways of determining what constitutes a context break for a particular decision class will be evident to those of ordinary skill in the art.

In an embodiment, for a decision class that has extreme settings as defined above, the interface's decision whether or not to revert from an extreme setting if it is selected when a context break occurs is itself an adaptive decision, of its own adaptive decision class. Such a decision will be referred to as an “adaptive reversion decision,” and the decision class that has extreme settings that it pertains to will be referred to as its “base decision class.” After an adaptive reversion decision occurs, the interface will remember the extreme setting that was selected before the context break occurred and will also remember what setting then became selected or would have become selected if it had decided to revert from the extreme setting, and as soon as the interface makes a decision of the base decision class that has a non-beneficial outcome, the interface will determine whether the other setting would have yielded a beneficial outcome, or whether it would at least have been closer to the nearest beneficial setting on the setting adaptation map, and if so, then the interface will determine that its adaptive reversion decision had a non-beneficial outcome. For example, in an embodiment, if the interface has adapted so that it will no longer automatically capitalize names of days of the week, and then the user closes the current document and edits a different document, and this constitutes a context break for that decision class, so the interface makes an adaptive reversion decision and decides to resume automatically capitalizing names of days of the week, then the interface will remember that if it had made the opposite choice when it made the adaptive reversion decision then it would not be automatically capitalizing names of days of the week; subsequently, if the next time the interface automatically capitalizes the name of a day of the week, this decision turns out to have a non-beneficial outcome, then the interface will not only adapt so that it will once again stop automatically capitalizing names of days the week, but will also determine that the adaptive reversion decision had a non-beneficial outcome and will adjust the setting of that adaptive reversion decision class also, so that the next time the user closes the current document and edits a different document, the interface will decide not to revert from the extreme setting despite the context break.

### Adaptation to Emphatic Preferences

In Chapter 9, the present specification describes an Emphatic Alteration key, an Emphatic Yes key, and an Emphatic No key that have the same effects as the non-emphatic versions of the keys, along with additional effects that are not described in Chapter 9. In an embodiment, actuating any such emphatic alteration-related key may affect interface adaptation differently than the non-emphatic version of the key. Such behavior is described in more detail in the following paragraphs.

In an embodiment, for any alterable decision that is an adaptive decision, if a user actuates an emphatic alteration-related key while that decision is the currently alterable decision, then the interface will remember that the user has expressed an emphatic preference pertaining to that decision, and then when the interface determines what outcome of the decision was beneficial or would have been beneficial and adjusts its settings accordingly, the procedure for adjusting the interface settings will take into account the fact that the user expressed an emphatic preference.

In particular, in an embodiment, for purposes of interface adaptation, when the interface determines what outcome of an adaptive decision was beneficial or would have been beneficial and adjusts its settings accordingly, if the user expressed an emphatic preference by actuating an emphatic alteration-related key, then the interface will perform the same adaptation procedure that it would perform if the user had not expressed an emphatic preference, but will do so a certain number of consecutive times, such as, in an embodiment, five consecutive times. For example, in an embodiment, if an adaptive decision has a certain default outcome, and a user explicitly indicates approval of this outcome by means of actuating the Emphatic Yes key, then the interface will adjust its settings just as much as if it had happened five consecutive times that the interface made that decision and the user explicitly indicated approval by means of actuating the non-emphatic Yes key. Thus, in such an embodiment, emphatic alteration-related keys will tend to accelerate the process of interface adaptation.

In an alternative embodiment, as an alternative approach to achieving a similar purpose, if a user rejects a particular option of an alterable interface decision by means of the Emphatic Alteration key or the Emphatic No key, then the interface will if possible ensure that the option the user thus rejected will not be the default option the next time the interface makes a decision of that decision class. For example, in an embodiment, if the interface by default alterably decides to automatically capitalize the word after “Mr.”, and if the interface ordinarily will not change that behavior until it yields a non-beneficial outcome three times in a row, then if the first time the interface alterably decides to automatically capitalize the word after “Mr.” the user alters this decision by means of the Emphatic Alteration key, then the interface will change its behavior immediately even though it has yielded a non-beneficial outcome only once. In an embodiment, after the interface makes an alterable decision that is an adaptive decision, if a user accepts the default outcome of that decision by means of the Emphatic Yes key, then the interface will if possible ensure that the next time the interface makes a decision of that decision class, it will have the same outcome, and the probability of alteration of the decision will be below the highlighting threshold. In an embodiment, after the interface makes an alterable decision that is an adaptive decision, if a user alters the decision and then accepts an alternate option by means of the Emphatic Yes key, then the interface will if possible ensure that the next time the interface makes a decision of that decision class, the option the user thus accepted will be the default option.

### Chapter 22: Interface Adaptation

### Universal Alterable Decision Adaptation

In an embodiment, some or all alterable interface decisions will be adaptive decisions. In an embodiment, a distinct adaptive decision class will exist for each distinct circumstance disclosed herein in which the interface makes an alterable decision. Therefore, throughout the present specification, whenever the default outcome of an alterable decision is stated or implied, it is to be understood that in an embodiment, interface adaptation may cause the default outcome of that type of decision to change. For example, if the present specification says, “In an embodiment, when a user types a numeral that is immediately after a variable, the interface will alterably decide to automatically convert the numeral into an exponent,” then it is to be understood that in an embodiment, if such a decision has a non-beneficial outcome, then the next time the user types a numeral that is immediately after a variable, the interface will instead alterably decide to not automatically convert the numeral into an exponent.

Above, the present specification explains how to convert non-adaptive decision functions to adaptive decision functions. In Part III, numerous distinct situations are described in which the interface will make various types of alterable decision. In most cases, the below explanations of alterable decisions will explain the relevant interface decision functions it enough detail to make it clear how to implement those functions as non-adaptive decision functions, without specifically explaining how to make those functions adaptive; however, taking such later portions of the present specification in conjunction with the above explanation of how to convert non-adaptive decision functions to adaptive decision functions, it will be clear how to implement such functions as adaptive decision functions.

In particular, in every case where the present specification describes a particular type of alterable decision that has two possible outcomes, it is to be understood that in an embodiment, that type of decision will be implemented as a distinct adaptive decision class as described above. As is described above, this means that in an embodiment, whenever a decision of such a decision class has a non-beneficial outcome, the interface will adjust its settings so that the next time it makes a decision of that class, it will select the other outcome, and the decision's probability of alteration will be very high; whenever such a decision has a beneficial outcome, the interface will adjust the settings so that the next time it makes a decision of that class, the decision's probability of alteration will be slightly less than before. So, for example, if the present specification says, “In an embodiment, when a user types a numeral that is immediately after a variable, the interface will alterably decide to automatically convert the numeral into an exponent,” then it is to be understood that in an embodiment, if that outcome of automatically converting the numeral into an exponent repeatedly and consistently turns out to be beneficial, then eventually the probability of alteration that is assigned to such decisions will become quite low.

### Alteration of Adaptation

As described above, adaptation functionality may cause the interface to change its own settings without notifying the user.

However, in an embodiment, when an adaptive decision has a non-beneficial outcome and the interface accordingly adjusts a setting in such a way that if the adjustment had occurred before the decision then the decision would have had a beneficial outcome, then the interface's decision to adjust that setting itself may be an alterable decision such that altering the decision will cause the adjusted setting to revert to its previous value. Such a decision will be referred to as an “alterable adaptation decision.”

Any alteration of an alterable adaptation decision will have consequences that are not readily visible, so in an embodiment, such an alteration will be treated as a subtle change as defined in Chapter 8, and so in certain circumstances, a block descriptor will appear for an alterable adaptation decision. In an embodiment, for purposes of such a block descriptor, the options of an alterable adaptation decision will be described as “Adapting” and “Not adapting.”

If the interface behaviors described in the preceding two paragraphs cause a block descriptor to appear that notifies the user when the interface is adapting, this may serve to call the user's attention to an unusually helpful interface behavior that the user otherwise might not consciously notice. Also, making the interface's decision to adjust a setting be an alterable decision may give a user more control over the interface's behavior, so that the user can more easily cause the interface to behave more like a prior art interface that does not automatically adjust its own settings, which may possibly be advantageous. On the other hand, there may be little need for an embodiment of the present invention to behave like a prior art interface: if adjusting a setting will cause the interface to make a wrong decision later, then it will be quite easy for the user to fix that mistake later by means of alteration functionality, so there may be little point in making it possible for the user to prevent that mistake rather than fixing it later. Furthermore, if there is not much need to actually alter alterable adaptation decisions, then any block descriptors that pertain to such decisions may be unnecessarily distracting. Therefore, it may be desirable that if adaptation decisions are made to be alterable, then they are configured in such a way that if a user consistently ignores the possibility of altering such decisions, then sooner or later block descriptors for such decisions will not be displayed.

In an embodiment, alterable adaptation decisions are themselves all members of a single adaptive decision class. In an embodiment, the default outcome of such decisions will initially be to perform adaptation, and the alternate outcome will initially have a high probability of alteration, but if a user repeatedly accepts the default outcomes of such decisions, eventually these decisions will have a sufficiently low probability of alteration that a block descriptor will by default not be displayed. In an embodiment, when the interface adjusts a setting for the alterable adaptation decision class itself, its decision to do so is not an alterable decision, and thus is not itself an alterable adaptation decision.

### Interface Decision Data Collection

In an embodiment, in certain circumstances the interface will retain usage data regarding an interface decision even after it has determined whether or not such a decision had a beneficial outcome and has adjusted its settings accordingly, so as to be able to potentially make use of information regarding multiple decisions of a particular decision class in order to adjust its settings in a more sophisticated way. For example, in an embodiment, the interface will remember the initial probability of alteration of each alterable decision and remember whether or not the decision had a beneficial outcome until the interface has subsequently made 1000 more alterable decisions, so that the interface will be able to analyze up to 1000 decisions in order to determine a highlighting threshold such that at least 95% of all decisions with a probability of alteration below this threshold had a beneficial outcome.

Furthermore, in an embodiment, in certain circumstances the interface will send anonymous usage data regarding alterable decisions to a developer, so that the developer may subsequently use aggregated data pertaining to multiple users in order to further improve the algorithms pertaining to alterable decisions. For example, in an embodiment, if a user explicitly opts to send anonymous usage data regarding alterable decisions, then once a month the interface will send to a particular email address an email that includes the current threshold value for each adaptive threshold decision class, so that the developer will receive such data from the computing devices of various users and may then aggregate and analyze the data in order to determine more appropriate initial threshold values for various adaptive threshold decision classes.

Below, various interface behaviors are described that may take advantage of data regarding past alterable decisions. In every case that is described below where the interface may take into account such data for an individual user and adjust its behavior for that user, it is to be understood that also, in an embodiment, the interface may send such data to a developer so that the developer can adjust the initial default behavior of the interface for all future users.

### Multi-Factor Adaptation

In an embodiment, as described above, if the interface makes a decision by means of taking into account multiple factors in calculating a decision score and then comparing the decision score to a threshold value, then after the interface determines whether or not the decision had a beneficial outcome, adaptation functionality may cause the interface to adjust the threshold value of the threshold decision.

In an embodiment, for certain threshold decision classes, the interface not only may adjust the threshold value of the decision class, but also may adjust the weights of various factors that are taken into account in calculating the decision score for decisions of that class.

For example, in an embodiment, for a certain threshold decision class, in order to be able to intelligently adapt the weights of multiple factors, the interface will remember all the relevant data regarding each decision of that class, including whether or not each decision had a beneficial outcome, until it has made at least 10 decisions of that class. Once the interface has made at least 10 decisions of that class, the interface will determine what threshold values would have caused as many of those 10 decisions as possible to have beneficial outcomes, and then for each factor that was involved in these decisions, one at a time, in some order, the interface will check that factor to determine whether a different weight for that factor would have been more beneficial and will adjust the weight of that factor if so; that is, for each factor, the interface will determine whether increasing or decreasing the weight of the factor would have caused more of those decisions to have beneficial outcomes, or would at least have caused some cases in which the decision had a non-beneficial outcome to have a higher probability of alteration; if so, the interface will accordingly adjust the weight of that factor. If the interface does adjust the weight of a factor that it checks, then it will use this new weight in determining whether or not to adjust the weight of any subsequent factor that it checks. For example, in an embodiment, if the interface sometimes makes an alterable decision whether or not to display a calculated value as a fraction, and by default such decisions are partly based on how many fractions were included in the expression that was evaluated and partly based on how many digits would be in the denominator if the answer were displayed as a fraction, then if a user repeatedly and consistently causes the calculated value to be displayed as a fraction if and only if it would have a single-digit denominator, then eventually the interface will adapt so that when it calculates a decision score for such a decision, the number of digits that would be in the denominator will have far more weight than the number of fractions that were included in the expression that was evaluated.

The preceding paragraph describes a relatively simple technique for adapting the weights of multiple factors. Those with skill in various fields such as artificial intelligence or statistical process control may be familiar with techniques that are more sophisticated. In many cases, though, even a relatively simple technique may yield beneficial results.

### Adaptation of Decision Variation

In an embodiment, in certain circumstances the automatic decision variation feature will vary a decision, which may cause a different option of the decision to become selected than would otherwise become selected, as is described in Chapter 17 in more detail.

In an embodiment, the automatic decision variation feature is adaptive. If a user deletes and retypes an alterable block so that the interface recognizes repetition of some particular alterable decision, then the interface's decision whether or not to select a different outcome of the decision will be considered to have a beneficial outcome if and only if the user does not subsequently alter the outcome of that decision by some means.

In the automatic decision variation feature as described in Chapter 17, when the interface varies a decision, the variation score of the monitored alterable decision determines the strength of the interface's tendency to cause a different option of the decision to become selected. In an embodiment, the interface may adapt the strength of such a tendency with respect to each individual decision class, so for example, in an embodiment where the interface alterably decides to automatically convert straight quotation marks to slanted quotation marks, and a user occasionally deletes and immediately retypes a quotation mark but never actually intends to effect any change by doing this, then eventually the interface will adapt so that particular type of alterable decision is essentially immune to the automatic decision variation feature. In particular, in order to achieve such behavior, in an embodiment, for each distinct type of alterable interface decision that is described herein, the interface will keep track of a decision variation bias that is initially 0. When the interface varies a decision, it will increase the variation score by an amount equal to the decision variation bias for that type of decision. After the interface varies a decision, if varying the decision causes a different option to become selected, but later the interface determines that the outcome that would have been beneficial is the option that would have become selected if the interface had not varied the decision, then the interface will slightly decrease the decision variation bias for that type of decision (even if this results in a negative value), so that in the future varying that type of decision will be slightly less likely to cause a different option to become selected. Conversely, after the interface varies a decision, if varying the decision does not cause a different option to become selected, but later the interface determines that the outcome that would have been beneficial is the outcome that would become selected if the variation score had been sufficiently high to cause the interface to select a different option, then the interface will slightly increase the decision variation bias for that type of decision, so that in the future varying that type of decision will be slightly more likely to cause a different option to become selected.

In an embodiment, the interface may also eventually adjust any particular value that controls the overall behavior of the decision variation feature if it determines that such an adjustment would have yielded more beneficial outcomes. For example, as described further in Chapter 17, the automatic decision variation feature will reduce variation scores whenever a user performs an action that has a deliberation score that is above a certain threshold, so that when a user deletes and retypes an alterable decision, if the user pauses very long while doing so, the interface will have less tendency to select a different outcome of the decision; but in an embodiment, if a user frequently pauses while deleting and retyping an alterable block, and yet the user repeatedly and consistently wishes the interface to yield a different outcome in response to the deletion and retyping of the alterable block despite the pause, then eventually the interface will raise the aforementioned threshold so that the automatic decision variation feature will subsequently be less sensitive to such pauses.

1-104. (canceled)

105. A computing device having an autocorrection interface, the device comprising:
a touchscreen display configured to display text input and receive touch input from a user;
at least one non-transitory computer readable medium having stored thereon executable instructions; and
at least one processor in communication with the at least one non-transitory computer readable medium and configured to execute the instructions to cause the computing device to:
identify autocorrection decisions as alterable decisions, wherein each alterable decision comprises a determination to modify user-typed text;
assign probabilities of alteration to said alterable decisions based on confidence levels of the autocorrection decisions;
for alterable decisions having probabilities of alteration exceeding a highlighting threshold, visually highlight the autocorrected text on the touchscreen display;
upon receiving touch input on highlighted autocorrected text, revert the autocorrection decision to restore the user-typed text to original input; and
adapt future autocorrection behavior based on patterns of user alteration of autocorrection decisions.

106. The computing device of claim 105, wherein the processor is further configured to determine the probability of alteration based on at least one factor selected from: similarity between original and autocorrected text, frequency of user reversal of similar autocorrections, deliberation time of user keystrokes, and contextual appropriateness of the autocorrection.

107. The computing device of claim 105, wherein the touch input comprises a single tap gesture on the highlighted autocorrected text.

108. The computing device of claim 105, wherein the processor is further configured to, upon consecutive touch inputs in a same autocorrected text, cycle through multiple alternative text options before reverting to the user-typed text.

109. The computing device of claim 105, wherein the visual highlighting comprises at least one of: background color highlighting, text underlining, text border highlighting, and animated visual effects.

110. The computing device of claim 105, wherein the processor is further configured to gradually decrease the probability of alteration of autocorrection decisions over time as the user continues typing without altering the decisions.

111. The computing device of claim 105, wherein the processor is further configured to assign higher probabilities of alteration to autocorrection decisions where the autocorrected text appears in close proximity to subsequently typed text that indicates that the original text was intended.

112. The computing device of claim 105, wherein the adaptation of future autocorrection behavior comprises adjusting confidence thresholds for similar autocorrection scenarios based on whether the user typically accepts or rejects such autocorrections.

113. The computing device of claim 105, wherein the processor is further configured to cease highlighting an autocorrection decision when the user performs a predetermined number of subsequent typing actions without altering the decision.

114. A method of universal text correction across multiple applications, the method comprising:
making autocorrection decisions that modify user input text across multiple applications executing on a computing device;
for each autocorrection decision, storing information about alternative text options including original user-typed text;
providing consistent visual indication of alterable autocorrected text across all applications on the computing device;
enabling single-gesture reversal of any autocorrection decision regardless of which application the text was entered in; and
maintaining alterable status of autocorrection decisions until the user performs an action that explicitly confirms acceptance of the autocorrected text.

115. The method of claim 114, wherein the single-gesture reversal comprises any of: tapping the autocorrected text, long-pressing the autocorrected text, and performing a swipe gesture on the autocorrected text.

116. The method of claim 114, wherein providing consistent visual indication comprises using the same highlighting appearance and behavior for autocorrected text regardless of whether the text appears in email applications, messaging applications, word processing applications, or web browser applications.

117. The method of claim 114, further comprising tracking user reversal patterns across all applications and using the patterns to adjust autocorrection aggressiveness on a per-application basis.

118. The method of claim 114, wherein maintaining alterable status comprises preserving the ability to revert autocorrections even after the user has continued typing additional text following the autocorrected text.

119. A system for expedited correction of automated text modifications, the system comprising:
an input device configured to receive user input;
a display configured to display information to the user; and
a processor configured to:
determine text modifications as alterable decisions by evaluating automated changes to user input;
indicate alterable text modifications via visual distinction within the display; and
activate alteration of text modifications by single user input applicable to multiple text modification types across diverse computing contexts and applications.

120. The system of claim 119, wherein the text modifications include autocorrections, automatic capitalizations, automatic punctuation insertions, and automatic formatting changes.

121. The system of claim 119, wherein the visual distinction comprises highlighting that varies in intensity based on a calculated likelihood that the user will want to alter the text modification.

122. The system of claim 119, wherein the single user input comprises touch input that is effective across touchscreen applications, keyboard-driven applications, and voice input applications.

123. The system of claim 119, wherein the processor is further configured to automatically alter a text modification decision when subsequent user input increases the calculated probability that the original text modification was incorrect above a predetermined automatic alteration threshold.

124. The system of claim 119, wherein diverse computing contexts include text input fields in operating system interfaces, web browsers, mobile applications, desktop applications, and cloud-based applications accessible through the computing device.
